(19) United States
(12) Patent Application Publication
(10) Pub. No.: US 2026/0005565 A1
(43) Pub. Date: Jan. 1, 2026

(54) ELECTRIC WORK MACHINE

(71) Applicant: MAKITA CORPORATION, Anjo-shi (JP)

(72) Inventors: Junya INUZUKA, Anjo-shi (JP); Takashi KOKETSU, Anjo-shi (JP)

(73) Assignee: MAKITA CORPORATION, Anjo-shi (JP)

(21) Appl. No.: 19/253,119

(22) Filed: Jun. 27, 2025

(30) Foreign Application Priority Data
Jul. 1, 2024 (JP) 2024-106364
Jun. 23, 2025 (JP) 2025-105578

(51) Int. Cl. H02K 1/28; B25F 5/02; H02K 1/276; H02K 7/116; H02K 7/14; H02K 9/06; H02K 21/16

(52) U.S. Cl. CPC H02K 1/28; B25F 5/02; H02K 1/276; H02K 7/116; H02K 7/145; H02K 9/06; H02K 21/16; H02K 2213/03

(57) ABSTRACT

One aspect of the present disclosure provides an electric work machine with which a housing and a brushless motor are provided. The brushless motor (i) is housed in the housing and (ii) includes a stator and a rotor. The rotor includes a rotor core, permanent magnets, and a resin fixing portion. The permanent magnets are (i) spaced apart from each other in a circumferential direction of the rotor core and (ii) arranged such that like poles thereof are aligned along the circumferential direction. The resin fixing portion is in contact with the rotor core and the permanent magnets, thereby to integrally fix the permanent magnets to the rotor core via the resin fixing portion.

### CROSS-REFERENCE TO RELATED APPLICATIONS

This application claims the benefits of Japanese Patent Application No. 2024-106364 filed on Jul. 1, 2024 with the Japan Patent Office and Japanese Patent Application No. 2025-105578 filed on Jun. 23, 2025 with the Japan Patent Office, and the entire disclosure of which are incorporated herein by reference.

### BACKGROUND

The present disclosure relates to an electric work machine including a brushless motor.

WO2008/104156 discloses an electronically commutated motor that is provided with a permanent magnet rotor. The rotor has grooves, and permanent magnets are arranged in the respective grooves.

### SUMMARY

When such a motor is installed in an electric work machine, it is desirable that two or more permanent magnets be securely fixed to a rotor in order to achieve high-speed rotation or high output of the motor.

In one aspect of the present disclosure, it is desirable that permanent magnets in a motor to be installed in an electric work machine can be securely fixed to a rotor, achieving high-speed rotation and/or high output of the motor.

In the present disclosure, the terms such as “first”, “second”, and the like merely intend to distinguish elements from one another, but do not intend to limit the order or number of the elements. Accordingly, a first element may be referred to as a “second element”, and similarly, a second element may be referred to as a “first element”. In addition, the first element may be provided without the second element and similarly, the second element may be provided without the first element.

One aspect of the present disclosure provides an electric work machine including a housing, a brushless motor, and a transmission. The brushless motor is (i) housed in the housing and (ii) includes a stator and a rotor. The transmission is configured to transmit rotation of the brushless motor to a tool accessory.

The stator includes coils. The rotor includes a rotor core, permanent magnets, and a resin fixing portion.

The rotor core (i) is configured to rotate about a rotational axis, (ii) has a first end face and a second end face that intersect an axial direction along the rotational axis, and (iii) includes through-spaces passing through the rotor core in the axial direction.

The permanent magnets (i) each have magnetic poles of a north pole and a south pole and (ii) are arranged in the rotor core such that the north pole and the south pole are aligned along a circumferential direction of the rotor core.

The permanent magnets are (i) spaced apart from each other in the circumferential direction, and (ii) arranged such that like poles face each other along the circumferential direction.

The resin fixing portion contains resin and is in contact with the rotor core and the permanent magnets, thereby to integrally fix the permanent magnets to the rotor core via the resin fixing portion.

The resin fixing portion includes (i) a first-end-face fixing part or a second-end-face fixing part and (ii) at least one through-fixing part. The first-end-face fixing part is arranged on the first end face of the rotor core and covers at least a portion of the first end face and at least a first portion of each of the permanent magnets. The second-end-face fixing part is arranged on the second end face of the rotor core and covers at least a portion of the second end face and at least a second portion of each of the permanent magnets. The at least one through-fixing part fills at least one of the through-spaces and is continuous with the first-end-face fixing part and/or with the second-end-face fixing part.

The brushless motor is configured to satisfy Equation (1) below.

$$\frac{R}{{( \frac{Vin}{Ne} )}^{2}} < 433000000 \cdot {Vol}^{- 1.621} \qquad ( 1 )$$

In Equation (1), R is a line-to-line resistance value (mΩ) of the brushless motor based on the coils,
Vin is a rated-voltage value (V) of the brushless motor,
Ne is a rotational speed (krpm) of the brushless motor when a specific effective back-EMF value, corresponding to a magnitude of a back-EMF generated in the coils, is equal to the rated-voltage value, and
Vol is a volume (mm³) of the stator.

In the electric work machine configured as described, the permanent magnets are integrally formed with the rotor core via the resin fixing portion, and the brushless motor satisfies Equation (1). Therefore, the permanent magnets can be securely fixed to the rotor core, achieving high-speed rotation and/or high output of the motor.

### BRIEF DESCRIPTION OF THE DRAWINGS

An example embodiment of the present disclosure will be described hereinafter with reference to the accompanying drawings, in which:

FIG. 1 is a perspective view of an electric work machine according to a first embodiment;

FIG. 2 is a first perspective view of a motor inside the electric work machine of the first embodiment;

FIG. 3 is a first exploded, perspective view, which corresponds to the first perspective view of the motor of the first embodiment;

FIG. 4 is a second perspective view of the motor of the first embodiment;

FIG. 5 is a second exploded, perspective view, which corresponds to the second perspective view of the motor of the first embodiment;

FIG. 6 is a cross-sectional view taking along line taken along line VI-VI of the motor in FIG. 2;

FIG. 7 is a first exploded, perspective view of a rotor of the first embodiment;

FIG. 8 is a second exploded, perspective view of the rotor of the first embodiment;

FIG. 9 is a plan view of a rotor core of the first embodiment;

FIG. 10 is a plan view of the rotor of the first embodiment;

FIG. 11 is a cross-sectional view taking along line XI-XI of the rotor of the first embodiment;

FIG. 12 is a cross-sectional view taking along line XII-XII of the rotor of the first embodiment;

FIG. 13 is a cross-sectional view taking along line XIII-XIII of the rotor of the first embodiment;

FIG. 14 is a cross-sectional view taking along line XIV-XIV of the rotor of the first embodiment;

FIG. 15 is a perspective view of the rotor of the first embodiment, in which a resin fixing portion is omitted;

FIG. 16 is a side view of the rotor of the first embodiment, in which the resin fixing portion is omitted;

FIG. 17 is an explanatory diagram for explaining a lamination process of the rotor core;

FIG. 18 is an explanatory diagram illustrating an electrical configuration of the electric work machine of the first embodiment;

FIG. 19 is an explanatory diagram pertaining to back-EMF;

FIG. 20 is an explanatory diagram for explaining characteristics of the motor of the first embodiment;

FIG. 21 is a plan view of a rotor of a second embodiment;

FIG. 22 is a side view of the rotor of the second embodiment, in which a resin fixing portion is omitted;

FIG. 23 is a sectional view of a rotor of a third embodiment, in which a resin fixing portion is omitted;

FIG. 24 is a plan view of a rotor of a fourth embodiment, in which a resin fixing portion is omitted;

FIG. 25 is a sectional view of the rotor of the fourth embodiment, in which the resin fixing portion is omitted;

FIG. 26 is a plan view of a rotor of a fifth embodiment;

FIG. 27 is a cross-sectional view taking along line XXVII-XXVII of the rotor of the fifth embodiment;

FIG. 28 is a cross-sectional view taking along line XXVIII-XXVIII of the rotor of the fifth embodiment;

FIG. 29 is a cross-sectional view taking along line XXIX-XXIX of the rotor of the fifth embodiment;

FIG. 30 is a sectional view of a rotor of a sixth embodiment;

FIG. 31 is a sectional view of a rotor of a seventh embodiment;

FIG. 32 is a front view and a sectional view of a resin fixing portion of the seventh embodiment;

FIG. 33 is a first perspective view of a rotor assembly of an eighth embodiment;

FIG. 34 is a second perspective view of the rotor assembly of the eighth embodiment;

FIG. 35 is a second perspective view of the rotor assembly, in which a fan is omitted;

FIG. 36 is a plan view of the rotor assembly of the eighth embodiment;

FIG. 37 is a side view of the rotor assembly of the eighth embodiment;

FIG. 38 is a sectional view of the rotor assembly of the eighth embodiment;

FIG. 39 is an exploded, perspective view of the rotor assembly of the eighth embodiment;

FIG. 40 is an exploded, perspective view of the rotor of the eighth embodiment;

FIG. 41 is a first perspective view of the rotor of the eighth embodiment;

FIG. 42 is a second perspective view of the rotor of the eighth embodiment;

FIG. 43 is a perspective view of a resin fixing portion of the eighth embodiment;

FIG. 44 is a plan view of the rotor core where magnets are arranged, according to the eighth embodiment;

FIG. 45 is a perspective view of a rotor core of the eighth embodiment;

FIG. 46 is a plan view of the rotor core of the eighth embodiment;

FIG. 47 is a cross-sectional view taking along line XLVII-XLVII of the rotor assembly of the eighth embodiment;

FIG. 48 is a cross-sectional view taking along line XLVIII-XLVIII of the rotor assembly of the eighth embodiment;

FIG. 49 is a cross-sectional view taking along line XLIX-XLIX of the rotor assembly of the eighth embodiment;

FIG. 50 is a cross-sectional view taking along line L-L of the rotor assembly of the eighth embodiment;

FIG. 51 is a sectional view illustrating a state in which the rotor and a rotor shaft are arranged in a molding device, according to the eighth embodiment;

FIG. 52 is a first perspective view of a rotor assembly of a ninth embodiment;

FIG. 53 is a second perspective view of the rotor assembly of the ninth embodiment;

FIG. 54 is a plan view of the rotor assembly of the ninth embodiment;

FIG. 55 is a perspective view of a rotor assembly of a tenth embodiment;

FIG. 56 is a plan view of the rotor assembly of the tenth embodiment;

FIG. 57 is a side view of the rotor assembly of the tenth embodiment;

FIG. 58 is a side-sectional view of the rotor assembly of the tenth embodiment;

FIG. 59 is a perspective view of a first example of a rotor shaft of an eleventh embodiment;

FIG. 60 is a perspective view of a second example of the rotor shaft of the eleventh embodiment;

FIG. 61 is a perspective view of a third example of the rotor shaft of the eleventh embodiment;

FIG. 62 is an explanatory diagram illustrating a first combination of an inner diameter of the rotor core and an outer diameter of the rotor shaft; and

FIG. 63 is an explanatory diagram illustrating a second combination of the inner diameter of the rotor core and the outer diameter of the rotor shaft.

### DETAILED DESCRIPTION OF EXEMPLARY EMBODIMENTS

### 1. Overview of Embodiment

Embodiments according to the present disclosure may provide an electric work machine that includes at least one of Features below.
Feature 1: a housing.
Feature 2: a brushless motor.
Feature 3: the brushless motor is housed in the housing.
Feature 4: the brushless motor includes a stator and a rotor.
Feature 5: a transmission (or a power transmitting portion) configured to transmit rotation of the brushless motor to a tool accessory. The transmission may be configured such that the tool accessory (or a driven tool) is attached to the transmission or that the tool accessory is attachable to the transmission in a detachable manner.
Feature 6: the stator includes coils.
Feature 7: the rotor includes a rotor core.
Feature 8: the rotor core is configured to rotate about a rotational axis.
Feature 9: the rotor core has a first end face and a second end face that intersect an axial direction along the rotational axis. The second end face may correspond to a surface opposite to the first end face. That is, the first end face and the second end face may have a relationship of two opposite sides, for example, front and rear.
Feature 10: the rotor core includes through-spaces passing through the rotor core in the axial direction.
Feature 11: the rotor includes permanent magnets.
Feature 12: the rotor includes a resin fixing portion (or a fixing resin portion, or a resin portion, or a resin, or a polymer fixing portion, or a fixing polymer portion).
Feature 13: the permanent magnets each have magnetic poles of a north pole and a south pole.
Feature 14: the permanent magnets each are arranged such that the north pole and the south pole are aligned along a circumferential direction of the rotor core.
Feature 15: the permanent magnets are arranged at least partially inside the rotor core. The permanent magnets may be arranged at least partially on the rotor core. The permanent magnets may be embedded at least partially in the rotor core.
Feature 16: the permanent magnets are spaced apart from each other along the circumferential direction of the rotor core.
Feature 17: the permanent magnets are arranged such that like poles thereof face (or oppose) each other along the circumferential direction.
Feature 18: the resin fixing portion contains resin (or a polymer). The resin fixing portion may contain a material other than resin. The resin fixing portion may contain only a resin material.
Feature 19: the resin fixing portion is in contact with the rotor core and the permanent magnets, thereby to integrally fix the permanent magnets to the rotor core via the resin fixing portion.
Feature 20: the resin fixing portion includes a first-end-face fixing part or a second-end-face fixing part.
Feature 21: the resin fixing portion includes at least one through-fixing part.
Feature 22: the first-end-face fixing part is arranged on the first end face of the rotor core.
Feature 23: the first-end-face fixing part covers at least a portion of the first end face and at least a first portion of each of the permanent magnets.
Feature 24: the second-end-face fixing part is arranged on the second end face of the rotor core.
Feature 25: the second-end-face fixing part covers at least a portion of the second end face and at least a portion of a second portion of each of the permanent magnets.
Feature 26: the at least one through-fixing part fills at least one of the through-spaces.
Feature 27: the at least one through-fixing part is continuous with the first-end-face fixing part and/or with the second-end-face fixing part.
Feature 28: the brushless motor is configured to satisfy Equation (1) below.

$$\frac{R}{{( \frac{Vin}{Ne} )}^{2}} < 433000000 \cdot {Vol}^{- 1.621} \qquad ( 1 )$$

In Equation (1), R is a line-to-line resistance value (mΩ) of the brushless motor based on the coils,
Vin is a rated-voltage value (V) of the brushless motor,
Ne is a rotational speed (krpm) of the brushless motor at a time in which a specific effective back-EMF value (or an effective induced voltage value), corresponding to a magnitude of a back-EMF (or an induced voltage) generated in the coils, is equal to the rated-voltage value, and
Vol is a volume (mm³) of the stator.

In the electric work machine including Features 1 to 28, the permanent magnets are integrally fixed to the rotor core by the resin fixing portion, and the brushless motor satisfies Equation (1). Therefore, the permanent magnets can be securely fixed to the rotor core, achieving high-speed rotation and/or high output of the motor. More specifically, it is possible to increase power density of the motor while inhibiting the motor from increasing in size.

The coils may be configured to receive electric power (for example, three-phase power). The coils may be configured to receive the electric power to generate magnetic fields. The magnetic fields may vary in the rotational direction of the rotor. The rotor may be configured to rotate when the electric power is supplied to the coils (more specifically, when changes in the magnetic fields as described are generated).

The rotor core includes a magnetic material. The rotor core may include a soft magnetic material. The rotor core may include electromagnetic steel. The rotor core may include two or more core sheets laminated along the rotational axis of the rotor. Each of the core sheets may be, for example, electromagnetic steel (or electromagnetic steel sheet).

The above-described permanent magnets may be provided in even numbers. The permanent magnets may each be arranged such that the north pole and the south pole are aligned along the circumferential direction of the rotor core.

The rotor may include a rotor shaft. The rotor shaft may be fixed to the rotor core. A rotational axis, which will be described below, may correspond to a rotational axis of the rotor shaft. The circumferential direction of the rotor core may be, in other words, the circumferential direction of the rotor, the circumferential direction of the rotor shaft, the rotational direction of the rotor, and/or the rotational direction of the rotor shaft.

Integrating the rotor core and the permanent magnets via molding with the resin fixing portion may include at least a portion of the rotor core and at least a portion of each of the permanent magnets being in direct contact with the resin fixing portion.

Integrally molding the rotor core and the permanent magnets may include adhesively bonding the rotor core and the permanent magnets via the resin fixing portion. In other words, the resin fixing portion may function as an adhesive to adhesively bond to the permanent magnets to the rotor core.

The resin fixing portion may be fixed (or joined) to the permanent magnets and the rotor core by adhesion, stickiness, mechanical joining, chemical bonding, and/or pressure. The brushless motor may be manufactured, for example, such that adhesion and/or pressure of the resin fixing portion to the permanent magnets and the rotor core is generated during a manufacturing process. For example, the brushless motor may be manufactured such that the resin fixing portion is mechanically and/or chemically joined to the permanent magnets and the rotor core during the manufacturing process. For example, the brushless motor may be manufactured such that pressure from the resin fixing portion is continuously applied to the permanent magnets and the rotor core during the manufacturing process.

The permanent magnets may be integrated via molding with the rotor core by the resin fixing portion. Specifically, the permanent magnets, the rotor core, and the resin fixing portion may be integrally formed by, for example, injection molding (more specifically, for example, insert molding). Such integral molding enables the resin fixing portion to be fixed to the rotor core and to the permanent magnets, thereby to integrally fix the permanent magnets to the rotor core.

The first-end-face fixing part may either fully or partially cover the first end face of the rotor core. The first-end-face fixing part may either fully or partially cover a first face of each of the permanent magnets.

The second-end-face fixing part may either fully or partially cover the second end face of the rotor core. The second-end-face fixing part may either fully or partially cover a second face of each of the permanent magnets.

The rotational speed of the brushless motor corresponds to a rotational speed of the rotor.

The coils may be three coils. The three coils may be delta-wired or star-wired to each other. The brushless motor may include three electric power terminals (or three electric terminals). The three coils may be connected to the three electric power terminals. The three electric power terminals may be configured to receive three-phase power. The electric work machine may include a power generation circuit (or drive circuit or controller) configured to generate the three-phase power.

The effective back-EMF value may be, for example, the effective value of the back EMF generated in any coil of the coils or may be an average value of the absolute values of the back EMF. Alternatively, the effective back EMF may be, for example, the average value of the back EMF generated within an electrical-angle range determined in advance for any of the coils. The electrical-angle range determined in advance may be a range for a specific angle (e.g., 60 degrees) centered on the electrical angle at which the back EMF is the maximum value. For example, in which the back EMF at 90 electrical degrees is taken as the maximum value, the electrical-angle range may be, for example, 60 to 120 degrees.

R in the above-mentioned Equation (1) may be an inter-terminal resistance value between any two of the three electric power terminals. In addition, in such an embodiment, the effective back-EMF value, which defines Ne in the above-mentioned Equation (1), may be the above-mentioned effective value or the above-mentioned average value of the back EMF generated between any two of the three electric power terminals, or may be the average value of the back EMF between any two of the electric power terminals generated within the above-mentioned electrical-angle range.

Vol in the above-mentioned Equation (1) may be defined in any manner. For example, the product of first, second, and third dimensions of the stator may be defined as the volume of the stator. The first dimension is a length in the axial direction, the second dimension is a length in a direction orthogonal to the axial direction, and the third dimension is a length in a direction orthogonal to the first and second dimensions. The stator may include a stator core having a cylindrical shape. In this case, Vol may be the volume of the stator core. Specifically, Vol may be the product of an area of the core-end circle and a core length. The core-end circle is a circle whose diameter is the outer diameter of the stator core. The core length is a length of the stator core in the axial direction.

In addition to or instead of at least any one of Features 1 to 28, some embodiments of the present disclosure may include at least any one of the following.
Feature 29: the resin fixing portion includes a first-end-face fixing part and a second-end-face fixing part.
Feature 30: the at least one through-fixing part is continuous with a first-end-face fixing part and with a second-end-face fixing part.

In the electric work machine including at least Features 1 to 30, the permanent magnets can be more securely fixed to the rotor core.

In addition to or instead of at least any one of Features 1 to 30, some embodiments of the present disclosure may include at least any one of the following.
Feature 31: the rotor core includes magnet insertion holes.
Feature 32: the magnet insertion holes are spaced apart from each other along the circumferential direction.
Feature 33: each of the permanent magnets are inserted into a corresponding one of the magnet insertion holes.
Feature 34: each of the magnet insertion holes includes an intermediate through-space, which is one of the through-spaces. Each of the magnet insertion holes may include an inner surface (or inner wall). The intermediate through-space may be situated between the inner surface and a corresponding one of the permanent magnets.
Feature 35: the at least one through-fixing part includes intermediate-fixing parts. The intermediate-fixing parts each fill the corresponding intermediate through-space.

In the electric work machine including at least Features 1 to 28 and 31 to 35, the permanent magnets can be securely and efficiently fixed to the rotor core. Each of the magnet insertion holes may partially or fully pass therethrough in an axial direction. The axial direction is along the rotational axis of the rotor.

In addition to or instead of at least any one of Features 1 to 35, some embodiments of the present disclosure may include at least any one of the following.
Feature 36: the rotor core includes openings.
Feature 37: the openings are spaced apart from each other along the circumferential direction on an outer surface (or outer-circumference or outer wall) of the rotor core.
Feature 38: each of the openings is continuous with a corresponding one of the magnet insertion holes.
Feature 39: each of the magnet insertion holes is exposed through the rotor core outwardly in a radial direction of the rotor core. Each of the magnet insertion holes may be open via a corresponding one of the openings outwardly in the radial direction of the rotor core.
Feature 40: each of the openings is one of the through-spaces.

Providing Feature 39 enables at least one of the magnet insertion holes and/or at least one of the permanent magnets to be visibly recognized when the rotor core is viewed from an outside in the radial direction of the rotor core. Feature 39 may be achieved together with Feature 38 (that is, on the basis that Feature 38 is provided).

For example, it is assumed that the openings are not provided, and a portion of the rotor core is also present in a region corresponding to the openings (hereinafter, an openings-corresponding-region). In this case, a portion of a magnetic flux from the permanent magnets may be short-circuited through the openings-corresponding-region, and thus there is a possibility that the portion of the magnetic flux cannot be effectively utilized for the output of the motor.

In contrast, providing the openings causes the openings-corresponding-region to increase magnetic resistance in the openings-corresponding-region, and short-circuiting of the magnetic flux through the openings-corresponding-region is reduced.

Thus, in the electric work machine including at least Features 1 to 28 and 31 to 40, the magnetic resistance based on the rotor core can be reduced, and thus the magnetic flux from the permanent magnets can be more effectively utilized for the output of the motor. Therefore, the possibility of achieving high-speed rotation and output of the motor is increased.

In addition to or instead of at least any one of Features 1 to 40, some embodiments of the present disclosure may include at least any one of the following.
Feature 41: the at least one through-fixing part includes outer-circumference fixing parts that each cover a corresponding one of the openings.

In the electric work machine including at least Features 1 to 28, 31 to 41, the outer-circumference fixing parts can function as a restricting component that restricts the permanent magnets from moving to the outside in the radial direction. Thus, the permanent magnets enable the rotor core to be securely fixed. Therefore, the possibility of achieving high-speed rotation and output of the motor is increased.

In addition to or instead of at least any one of Features 1 to 41, some embodiments of the present disclosure may include at least any one of the following.
Feature 42: the rotor core includes restrictors (or restricting portions).
Feature 43: the restrictors each form a corresponding one of the openings.
Feature 44: the restrictors each face a corresponding one of the permanent magnets along the radial direction.
Feature 45: the restrictors are each configured to restrict the corresponding one of the permanent magnets from moving in the radial direction.

The “corresponding one of the permanent magnets” refers to the permanent magnet that is inserted into the corresponding magnet insertion hole, which is continuous therewith the corresponding opening.

In the electric work machine including at least Features 1 to 28 and 31 to 45, the permanent magnets are restricted from moving radially outward by the restrictors. That is, even if the permanent magnets tend to be moved radially outward due to centrifugal force, for example, each of the permanent magnets is in contact with the corresponding restrictor directly or indirectly (for example, via the resin fixing portion), thereby restricting or inhibiting the magnets from moving radially outward (and thus, from being detached or removed from the rotor). This enables the permanent magnets to be more securely fixed to the rotor core. Therefore, the possibility of achieving high-speed rotation and output of the motor is increased.

In addition to or instead of at least any one of Features 1 to 45, some embodiments of the present disclosure may include at least any one of the following.
Feature 46: the permanent magnets each include the first face. The first face intersects the axial direction and faces a same direction as the first end face.
Feature 47: the permanent magnets include the second face. The second face intersects the axial direction and faces a same direction as the second end face. The second face may correspond to a surface opposite to the first face. That is, the first face and the second face may have a relationship of two opposite sides, for example, front and rear.

In addition to or instead of at least any one of Features 1 to 47, some embodiments of the present disclosure may include at least any one of the following.
Feature 48: the first-end-face fixing part includes at least one through hole.
Feature 49: the at least one through hole passes through the first-end-face fixing part in the axial direction, thereby to cause a portion of the permanent magnets and/or a portion of the rotor core to be exposed to an outside of the rotor.

In the electric work machine including at least Features 1 to 28, 48 to 49, a first-end-face fixing part can be easily formed. In addition, the permanent magnets and/or the rotor core can be cooled more effectively.

In addition to or instead of at least any one of Features 1 to 49, some embodiments of the present disclosure may include at least any one of the following.
Feature 50: at least a portion of the first face of each of the permanent magnets and at least a portion of the first end face of the rotor core are coplanar.

In the electric work machine including at least Features 1 to 28, 50, the first faces of the permanent magnets are coplanar. This enables more accurate detection of rotation when a sensor (for example, Hall IC) for detecting a rotational position of the rotor is arranged so as to face the first faces of the permanent magnets. The second-end-face fixing part may be in contact with the at least a portion of the second end face of the rotor core and at least a portion of a second face of each of the permanent magnets.

In addition to or instead of at least any one of Features 1 to 50, some embodiments of the present disclosure may include at least any one of the following.
Feature 51: the second face of each of the permanent magnets is located inside or outside of the rotor core relative to the second end face of the rotor core.

When the permanent magnets partially protrude beyond the second end face of the rotor core, compared with permanent magnets that do not partially protrude beyond the second end face, a leakage flux ratio can be reduced. The leakage flux ratio is defined as a proportion of the magnetic flux short-circuited within the rotor core to the total magnetic flux generated from the permanent magnets. When the permanent magnets are located inward of the rotor core from the second end face of the rotor core, the permanent magnets can be more securely fixed.

In addition to or instead of at least any one of Features 1 to 51, some embodiments of the present disclosure may include at least any one of the following.
Feature 52: the rotor core includes a core center hole. The core center hole may pass through the rotor core in the axial direction. The rotational axis may pass through the core center hole.
Feature 53: a rotor shaft passing through the core center hole and configured to rotate together with the rotor core.
Feature 54: the resin fixing portion is in contact with the rotor core, the permanent magnets, and the rotor shaft, thereby to integrally fix the permanent magnets and the rotor shaft to the rotor core via the resin fixing portion.

In the electric work machine including at least Features 1 to 28 and 52 to 54, the rotor shaft can be securely fixed to the rotor core.

In addition to or instead of at least any one of Features 1 to 54, some embodiments of the present disclosure may include at least any one of the following.
Feature 55: the through-spaces include a center through-space. The center through-space is a space in which the rotor shaft is not present in the core center hole. The center through-space may be present between a surface of the rotor shaft and the rotor core (or an inner surface of the core center hole).
Feature 56: the at least one through-fixing part includes a center-fixing part that fills the center through-space.

In the electric work machine including at least Features 1 to 28 and 52 to 56, the rotor shaft can be securely fixed to the rotor core.

In addition to or instead of at least any one of Features 1 to 56, some embodiments of the present disclosure may include at least any one of the following.
Feature 57: the core center hole has the inner surface.
Feature 58: the inner surface includes a recess corresponding to the center through-space.
Feature 59: the recess extends in the axial direction along the rotational axis of the rotor.
Feature 60: at least a portion of the center-fixing part fills the recess.

In the electric work machine including at least Features 1 to 28 and 52 to 60, the rotor shaft can be securely fixed by the rotor core.

In addition to or instead of at least any one of Features 1 to 60, some embodiments of the present disclosure may include at least any one of the following.
Feature 61: the surface of the rotor shaft has a core-facing surface.
Feature 62: the core-facing surface faces the inner surface of the core center hole.

Feature 63: the core-facing surface has a textured surface.

In the electric work machine including at least Features 1 to 28 and 52 to 54, 61 to 63, the resin can flow into a textured surface of the rotor shaft. Therefore, the rotor shaft can be more securely fixed to the rotor core.

In addition to or instead of at least any one of Features 1 to 63, some embodiments of the present disclosure may include at least any one of the following.
Feature 64: the textured surface includes a knurled shape.

In the electric work machine including at least Features 1 to 28, 52 to 54, and 61 to 64, the textured surface can be easily and efficiently provided to the rotor shaft.

In addition to or instead of at least any one of Features 1 to 64, some embodiments of the present disclosure may include at least any one of the following.
Feature 65: the permanent magnets each have a radial length along the radial direction of the rotor core and a circumferential length along the circumferential direction. The radial length is longer than the circumferential length. In other words, the permanent magnets each extend in the radial direction of the rotor core.

The permanent magnets each may (i) have a board (or sheet) shape and (ii) extend along the axial direction and the radial direction.

In the electric work machine including at least Features 1 to 28 and 65, magnetic resistance in a magnetic circuit composed of the permanent magnets can be reduced, and thus high-speed rotation or high output of the motor can be achieved.

In addition to or instead of at least any one of Features 1 to 65, some embodiments of the present disclosure may include at least any one of the following.
Feature 66: the permanent magnets each have at least a first part and a second part that are divided in the radial direction of the rotor core. In other words, the permanent magnets each have at least a first permanent magnet and at least a second permanent magnet that are arranged to be adjacent along the radial direction.
Feature 67: the permanent magnets each have at least a first part and a second part that are divided along the rotational axis of the rotor. In other words, each of the permanent magnets has at least a first permanent magnet and a second permanent magnet that are arranged to be adjacent along the axial direction.

In Feature 66 and Feature 67, the first part (or the first permanent magnet) may be in contact with or may be in no contact with the second part (or the second permanent magnet).

In the electric work machine including Features 1 to 28 and 66 and the electric work machine including at least Features 1 to 28 and 67, eddy currents generated in each of the permanent magnets can be reduced, thereby inhibiting heat generation in each of the permanent magnets, and thus demagnetization caused by such heat generation can be inhibited.

In addition to or instead of at least any one of Features 1 to 67, some embodiments of the present disclosure may include at least any one of the following.
Feature 68: the permanent magnets each include a first magnet segment (or a first partial magnet) and a second magnet segment (or a second partial magnet).
Feature 69: the first magnet segment and the second magnet segment are spaced apart from each other along the circumferential direction.
Feature 70: the first magnet segment and the second magnet segment are arranged such that opposite poles face each other along the circumferential direction.

In the electric work machine including at least Features 1 to 28 and 68 to 70, the magnetic flux generated from each of the permanent magnets can be increased. More specifically, the first magnet segment and/or the second magnet segment can be arranged (extend) along a direction inclined from the radial direction. This enables a surface area of permanent magnets (in detail, a surface area of the magnetic poles) to be increased, and thus the brushless motor can be made smaller accordingly.

In addition to or instead of at least any one of Features 1 to 70, some embodiments of the present disclosure may include at least any one of the following.
Feature 71: a resin fixing portion contains a thermosetting resin.

In the electric work machine including at least Features 1 to 28 and 71, heat required for fixing the permanent magnets to the rotor core by the resin fixing portion can be reduced, thereby inhibiting demagnetization of the permanent magnets due to heat.

Supplementary information on technical effects using thermosetting resin will be described. When the permanent magnets are arranged along the circumferential direction such that their like poles face each other, the radial length of each permanent magnet may be longer. In this case, it is difficult to magnetize the permanent magnets after assembling the permanent magnets into the rotor core, and it is necessary (or it is preferable) to assemble magnetized permanent magnets into the rotor core. After the magnetized permanent magnets are assembled into the rotor core, the rotor core and the permanent magnets are integrated via molding by resin, which may cause the permanent magnets to be exposed to heat. If the heat at this time is too high, the permanent magnets may be irreversibly demagnetized. In contrast, as in Feature 71, integral molding using the thermosetting resin enables the temperature of the permanent magnets to be inhibited from rising during the integral molding. Therefore, demagnetization of the permanent magnets can be reduced or inhibited.

Examples of thermosetting resin include unsaturated polyester, phenolic resin, urea resin, melamine resin, and epoxy resin.

In addition to or instead of at least any one of Features 1 to 71, some embodiments of the present disclosure may include at least any one of the following.
Feature 72: the resin fixing portion contains a thermoplastic resin.
Feature 73: the thermoplastic resin has a melting point of 200° C. or less.

In the electric work machine including at least Features 1 to 28, 72, and 73, the rotor core and the permanent magnets can be integrated via molding using thermoplastic resin while the temperature rise of the permanent magnets is inhibited. Integral molding using resin can be performed, for example, by an injection molding method.

Examples of the thermoplastic resin having a melting point of 200° C. or less include PA11 resin and PA12 resin. PA11 is an abbreviation for “Polyamide 11” and is also referred to as “nylon 11”. PA12 is an abbreviation for “Polyamide 12” and is also referred to as “nylon 12”.

The temperature of the brushless motor may rise during operation of the electric work machine. Thus, the melting point of the thermoplastic resin may exceed 100° C.

In addition to or instead of at least any one of Features 1 to 73, some embodiments of the present disclosure may include at least any one of the following.
Feature 74: a grip configured to be gripped by a user of the electric work machine.
Feature 75: a battery receptacle configured to allow a battery pack to be mounted thereon in a detachable manner. The battery pack includes a battery.

Providing at least Features 1 to 28, 74, and 75 enables a battery-driven electric work machine that is small in size but that achieves high-speed rotation and/or high output.

Examples of the electric work machine include various apparatuses configured to be used at job sites, such as building construction, manufacturing, gardening, civil engineering, and other work sites, specifically: powered equipment for masonry work, metalworking, or woodworking; any electric gardening equipment; powered equipment for preparing the environment of job sites; a fan vest; a fan jacket; a battery-operated wheel barrow; an electrically power assisted bicycle; an inflator; or the like.

Examples of the powered equipment include an electric chain saw, an electric hand-held saw, an electric blower, an electric hammer, an electric hammer drill, an electric drill, an electric driver, an electric wrench, an electric impact driver, an electric impact wrench, an electric grinder, an electric circular saw, an electric reciprocating saw, an electric jigsaw, an electric cutter, an electric planer, an electric nail gun (including a tacker), an electric hedge trimmer, an electric lawn mower, an electric lawn trimmer, an electric brush cutter, an electric cleaner, an electric sprayer, an electric spreader, an electric dust collector, an electric trowel, an electric vibrating machine, an electric rammer, an electric compactor, an electric pump, an electric pile driver, an electric concrete saw, an electric screed, an electric cut-off saw, and the like.

Examples of the electric work machines may be in the form of a battery-powered appliance configured to be driven by a battery. Specifically, examples of the electric work machine may include a built-in battery, or may be configured to include a battery pack mounted thereon in a detachable manner. The battery pack houses the battery.

In one embodiment, the above-mentioned Features 1 to 75 may be combined in any combinations.

In one embodiment, any of the above-mentioned Features 1 to 75 may be excluded.

### 2. Specific Example Embodiments

Some specific example embodiments will be explained below.

### 2-1. First Embodiment

A first embodiment provides an electric work machine 1. The electric work machine 1 is in the form of an electric impact driver. However, the electric impact driver is simply one example of the electric work machine 1, and the present disclosure may be applied to electric work machines of any form.

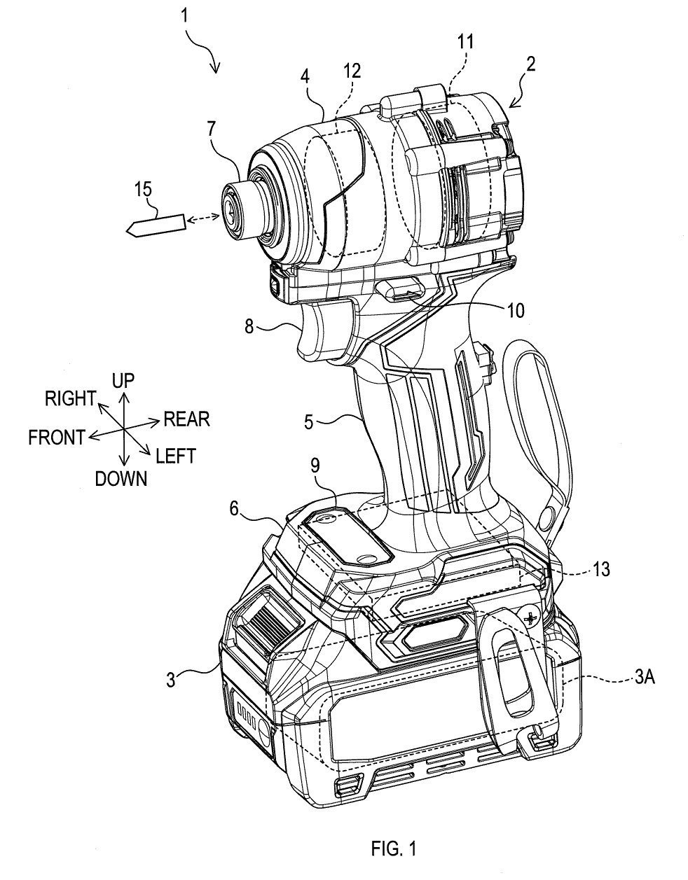

In the following description or the accompanying drawings, as shown in FIG. 1 and the like, “upper”, “lower”, “front”, “rear”, “left”, and “right” directions are defined for the sake of convenience in explanation. However, these directions are employed merely for facilitating an understanding of the structure of the electric work machine 1 and are not intended to limit the orientation of the electric work machine 1. The electric work machine 1 may be oriented in any direction.

### 2-1-1. Overall Configuration of Electric Work Machine

As shown in FIG. 1, the electric work machine 1 includes a work machine body 2. The work machine body 2 includes a housing 4. The housing 4 houses a brushless motor (hereinafter referred to as “motor”) 11 in the interior thereof.

The housing 4 houses a first transmission 12. The first transmission 12 is arranged in front of the motor 11 and is mechanically coupled to the motor 11.

The electric work machine 1 includes a second transmission 7 at a front end of the housing 4. The second transmission 7 is mechanically coupled to the first transmission 12. The second transmission 7 may also be referred to as a chuck sleeve.

To the second transmission 7, a tool accessory 15 is detachably attached. In the first embodiment, the tool accessory 15 is, for example, various types of tool bits. Examples of the type of tool bits include a driver bit, a socket bit, and a drill bit.

The first transmission 12 transmits rotation of the motor 11 to the second transmission 7. When the motor 11 rotates, the second transmission 7 rotates with the tool accessory 15 attached thereto. The first transmission 12 includes an impact mechanism (not shown). When a magnitude of a load applied from the second transmission 7 to the impact mechanism exceeds a specific level, the impact mechanism intermittently applies an impact force in a rotational direction to the second transmission 7. The load is applied in a direction opposite to the rotational direction of the second transmission 7. This impact mechanism achieves characteristic functions as the impact driver.

The work machine body 2 includes a grip 5 extending from the housing 4. The grip 5 is held by a user of the electric work machine 1.

The work machine body 2 includes a trigger 8. The trigger 8 is provided at an upper end of the grip 5. The trigger 8 is manually operated (e.g., pulled) by the user from an initial position. When the trigger 8 is in the initial position, the motor 11 does not rotate. In response to the trigger 8 being moved from the initial position, the motor 11 rotates.

The work machine body 2 includes a battery receptacle 6 at a lower end of the grip 5. On the battery receptacle 6, a battery pack 3 is mounted in a detachable manner. FIG. 1 shows a state in which the battery pack 3 is mounted on the battery receptacle 6. The battery pack 3 includes a battery 3A.

The work machine body 2 includes an operation panel 9 on a top surface of the battery receptacle 6. The operation panel 9 is manipulatable by the user. The user can specify (or select, or set) an operation mode of the motor 11 via the operation panel 9.

The work machine body 2 houses a controller 13, which is situated below the grip 5 and in an upper portion of the battery receptacle 6. When the battery pack 3 is mounted on the battery receptacle 6, the battery 3A is electrically connected to the controller 13. The controller 13 receives battery power from the battery 3A and operates based on the battery power. When the trigger 8 is manually operated, the controller 13 converts the battery power into motor drive electric power to supply the motor drive electric power to the motor 11. The motor 11 rotates while receiving the motor drive electric power. The motor drive electric power is in the form of three-phase power. The controller 13 controls the motor drive electric power in accordance with the amount of movement of the trigger 8 and the operation mode that is set, thereby controlling the rotation of the motor 11.

### 2-1-2. Overall Configuration of Motor

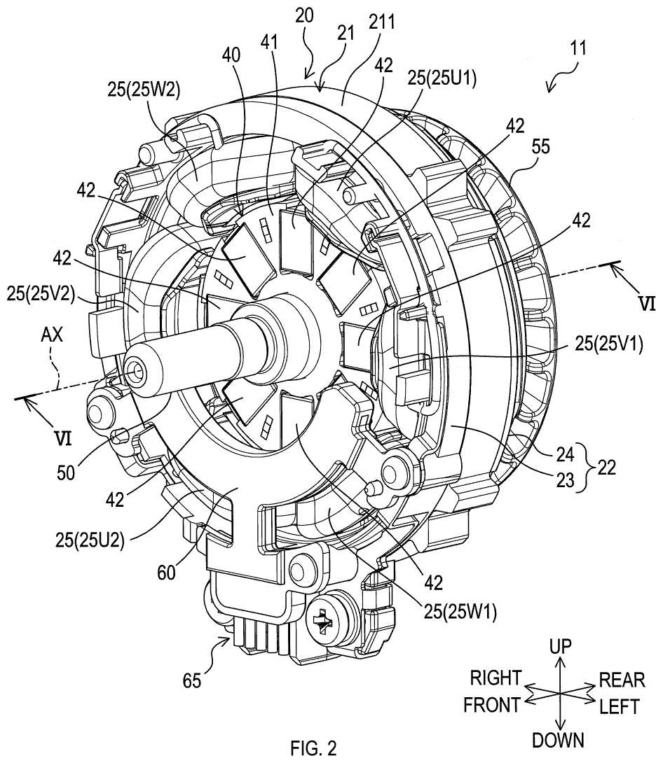

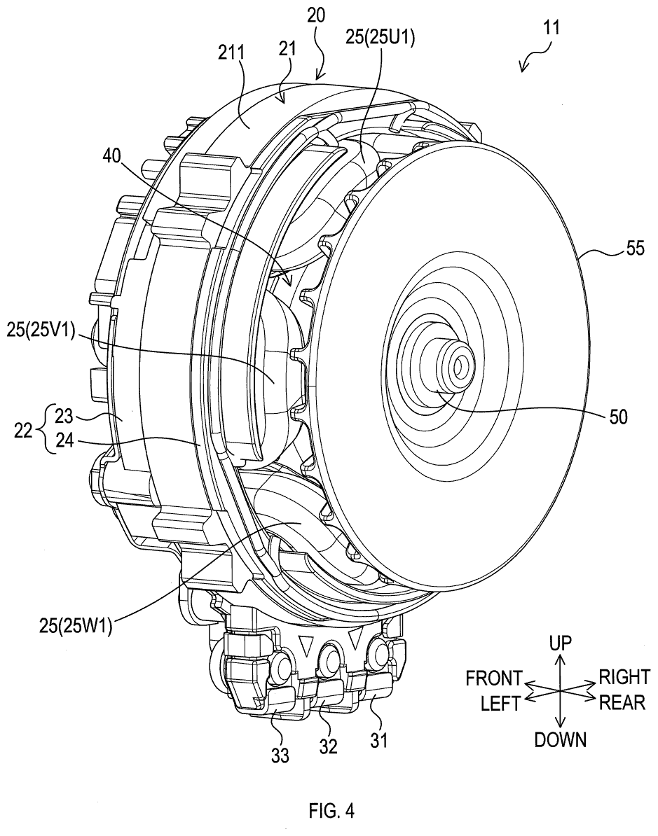

As shown in FIG. 2 to FIG. 6, the motor 11 includes a stator 20 and a rotor 40. In the first embodiment, the motor 11 is in the form of an inner rotor motor. In addition, the motor 11 of the first embodiment is in the form of a three-phase brushless motor with eight magnetic poles and six slots. The stator 20 has a substantially annular shape as a whole. The rotor 40 is rotatably arranged on the inner periphery side of the stator 20.

Here, the terms “axial direction”, “radial direction” and “circumferential direction” are defined as follows. The axial direction is a direction parallel to a rotational axis AX of the motor 11 and is oriented forward. The radial direction is a direction extending perpendicularly from the rotational axis AX. The circumferential direction is a direction revolving around the rotational axis AX, for example, in a clockwise direction.

2-1-2a. Stator

The stator 20 includes a stator core 21. The stator core 21 is formed of electromagnetic steel. The stator core 21 includes two or more electromagnetic steel sheets that are laminated together in the axial direction.

The stator core 21 includes a back core 211. The back core 211 has a tubular shape. A center axis of the back core 211 coincides with the rotational axis AX.

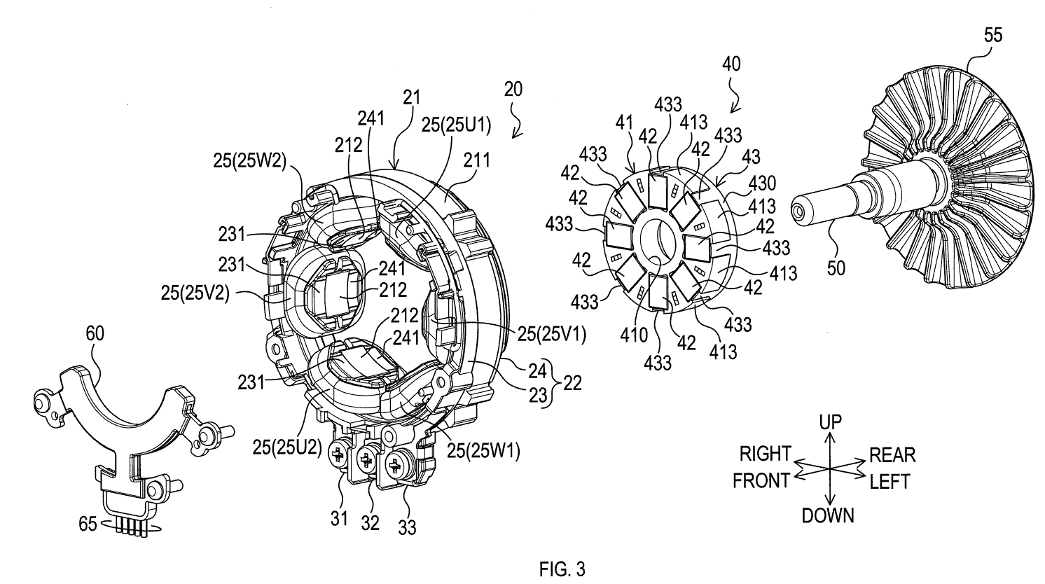

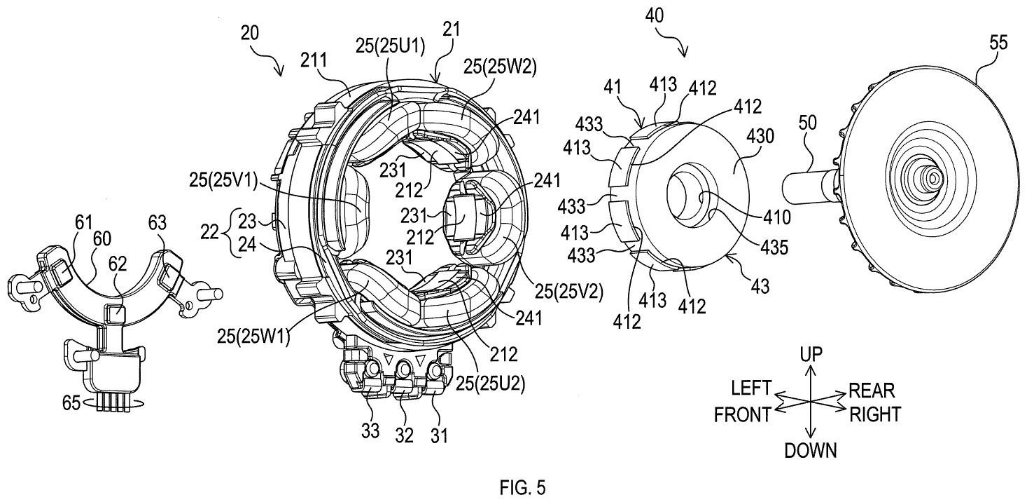

As shown in FIG. 3 and FIG. 5, the stator core 21 includes two or more core teeth 212. The core teeth 212 protrude from an inner surface (or inner wall) of the back core 211 in a direction opposite to the radial direction (i.e., toward the rotational axis AX). The core teeth 212 are arranged at equal intervals along the circumferential direction. The core teeth 212 are integrally formed with the back core 211. In the first embodiment, the core teeth 212 include six core teeth 212.

As shown in FIG. 2 to FIG. 6, the stator 20 includes an insulator 22. Simply as one example, the insulator 22 of the first embodiment includes, more specifically, a first insulator 23 and a second insulator 24. The first and second insulators 23, 24 each have a substantially annular shape or a substantially tubular shape. The first and second insulators 23, 24 each are an electrically insulating member, and are made of, for example, synthetic resin (or a polymer).

The first insulator 23 is fixed to the stator core 21 on a front side of the stator core 21 and covers an outer surface of the stator core 21 on the front side. The second insulator 24 is fixed to the stator core 21 on a rear side of the stator core 21 and covers an outer surface of the stator core 21 on the rear side. The first and second insulators 23, 24 may be integrated via molding with the stator core 21.

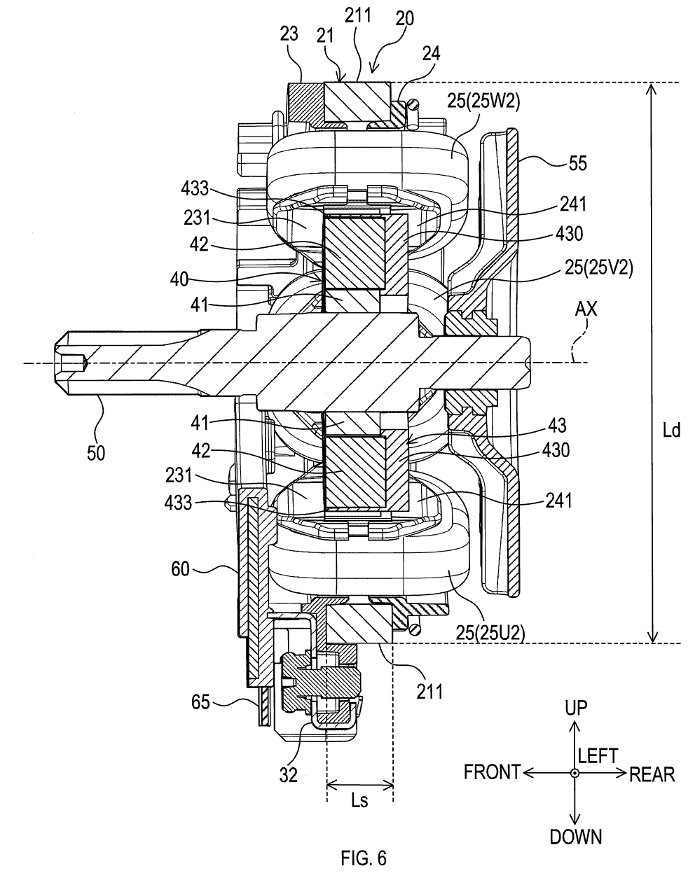

As shown in FIG. 3, FIG. 5, and FIG. 6, the first insulator 23 includes two or more first teeth 231. The first insulator 23 includes a first annular member having an annular (or tubular) shape. The first teeth 231 protrude from an inner surface (or inner wall) of the first annular member along the direction opposite to the radial direction (i.e., toward the rotational axis AX). In the first embodiment, the first teeth 231 include the six first teeth 231. Each of the first teeth 231 covers a frontward surface of a corresponding one of the core teeth 212.

The second insulator 24 includes two or more second teeth 241. The second insulator 24 includes a second annular member having an annular (or tubular) shape. The second teeth 241 protrude from an inner surface (or inner wall) of the second annular member along the direction opposite to the radial direction (i.e., toward the rotational axis AX). In the first embodiment, the second teeth 241 include six second teeth 241. Each of the second teeth 241 covers a rearward surface of a corresponding one of the core teeth 212.

The stator 20 of the first embodiment includes six stator teeth. Each of the six stator teeth is formed by a corresponding core tooth 212 of the core teeth 212, one of the first teeth 231 corresponding to the core tooth 212, and one of the second teeth 241 corresponding to the core tooth 212.

As shown in FIG. 2 to FIG. 6, the stator 20 includes two or more coils 25. In the first embodiment, the coils 25 include six coils 25. The six coils 25 are wound around the respective six stator teeth. The motor drive electric power is supplied to the six coils 25. The six coils 25 are electrically connected to each other in a specific wiring configuration.

In the first embodiment, the six coils 25 include a first-phase coil group, a second-phase coil group, and a third-phase coil group. The first-phase coil group includes a pair of first-phase coils 25U1, 25U2 connected in series with each other. The second-phase coil group includes a pair of second-phase coils 25V1, 25V2 connected in series with each other. The third-phase coil group includes a pair of third-phase coils 25W1, 25W2 connected in series with each other. The first-phase coil group, the second-phase coil group, and the third-phase coil group are connected to each other in a delta configuration.

The first-phase coil group, the second-phase coil group, and the third-phase coil group may be connected to each other in a wiring configuration different from the delta configuration (i.e., in star configuration). Also, the six coils 25 may be connected to each other in a mode different from the above-described mode. For example, the six coils 25 may be divided into a first connection group and a second connection group. The first connection group may include the first-phase coil 25U1, the second-phase coil 25V1, and the third-phase coil 25W1 that are connected to each other in the delta configuration (or star configuration). The second connection group may include the first-phase coil 25U2, the second-phase coil 25V2, and the third-phase coil 25W2 that are connected to each other in the delta configuration (or star configuration). The first connection group and the second connection group may be connected in parallel to each other.

2-1-2b. Rotor

As shown in FIG. 2, FIG. 3, FIG. 5, and FIG. 6, the rotor 40 includes a rotor core 41 and two or more permanent magnets 42.

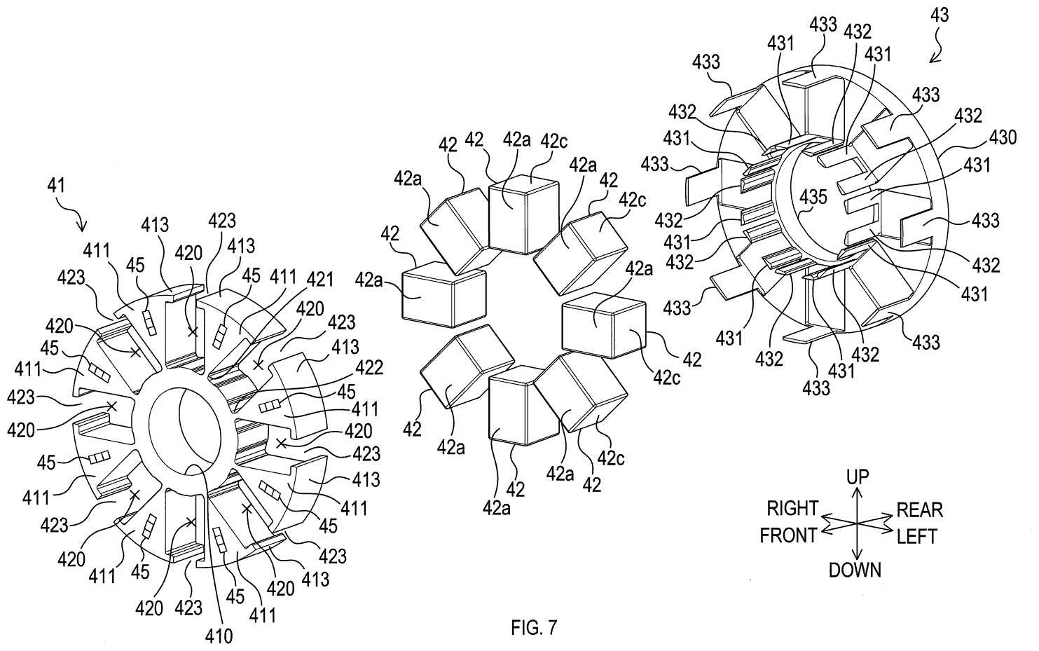

As shown in FIG. 3 and FIG. 5, the rotor core 41 includes a center hole 410, which passes through in the axial direction. A rotor shaft 50 is inserted through the center hole 410 and fixed to the rotor core 41. The rotor core 41 has an outer-circumferential surface 413. The outer-circumferential surface 413 is formed as if it were notched (or has cutouts) at equal intervals along the circumferential direction. The notched locations correspond to two or more openings 423 and two or more magnet insertion holes 420 (see FIG. 7), which will be described below.

The permanent magnets 42 are arranged at least partially inside the rotor core 41. In the following description, when simply referring to the “permanent magnet 42”, it means each one or any one of the permanent magnets 42. Similarly, in the following description, when simply referring to the “opening 423”, it means each one or any one of the openings 423, and when simply referring to “magnet insertion hole 420”, it means each one or any one of the magnet insertion holes 420.

In the first embodiment, the permanent magnet 42 is in the form of a sintered magnet. The permanent magnets 42 are arranged at equal intervals along the circumferential direction of the rotor core 41. The permanent magnets 42 are arranged in the respective notched locations in the outer-circumferential surface 413 of the rotor core 41.

As shown in FIG. 3, FIG. 5, and FIG. 6, the rotor 40 includes a resin fixing portion 43. The “resin fixing portion” may be also simply referred to as “resin”, or a “resin material” or a “resin portion”. The resin fixing portion 43 integrally fixes the permanent magnets 42 to the rotor core 41. In the first embodiment, the rotor core 41 and the permanent magnets 42 are integrated via molding with the resin fixing portion 43.

The resin fixing portion 43 includes an end-face fixing part 430. The end-face fixing part 430 covers the rotor core 41 and the permanent magnets 42 from their rear sides. As shown in FIG. 5 and FIG. 6, in the first embodiment, the end-face fixing part 430 covers the permanent magnets 42 from the rear side. In other words, a protruding part of the permanent magnet 42 beyond a rear end face of the rotor core 41 (a second end face 412, which will be described below) is at least partially (in the first embodiment, completely) covered with the end-face fixing part 430.

In addition, as shown in FIG. 5, the end-face fixing part 430 covers most of the second end face 412 of the rotor core 41.

In contrast, as shown in FIG. 3, a front end face (a first end face 411, which will be described below) of the rotor core 41 and a front face of each of the permanent magnets 42 are not covered with the resin fixing portion 43 and exposed to the front.

As shown in FIG. 5, the end-face fixing part 430 includes a center hole 435. The center hole 435 has a center axis that coincides with the rotational axis AX. Simply as one example, a diameter of the center hole 435 of the end-face fixing part 430 is larger than a diameter of the center hole 410 of the rotor core 41.

As shown in FIG. 3, FIG. 5, and FIG. 6, the resin fixing portion 43 includes two or more outer-circumference fixing parts 433. Although the reference numerals are omitted in FIG. 2 to FIG. 6, the resin fixing portion 43 includes two or more first intermediate-fixing parts 431 (see FIG. 7). Although the reference numerals are omitted in FIG. 2 to FIG. 6, the resin fixing portion 43 includes second intermediate-fixing parts 432 (see FIG. 7). The outer-circumference fixing parts 433 respectively cover the above-described notched locations (i.e., the openings 423) in the outer circumferential surface 413 of the rotor core 41.

As shown in FIG. 2 to FIG. 6, the motor 11 includes the rotor shaft 50. The rotor shaft 50 is fixed to the rotor core 41 (and thus, to the rotor 40) while being inserted through the center hole 410 of the rotor core 41. The rotor shaft 50 may, for example, be press-fitted into the rotor core 41, thereby being fixed to the rotor core 41. The center axis of the rotor shaft 50 coincides with the rotational axis AX. Accordingly, the rotor 40 and the rotor shaft 50 rotate about the rotational axis AX.

2-1-2c. Sensor Board

As shown in FIG. 2, FIG. 3, FIG. 5, and FIG. 6, the motor 11 includes a sensor board 60. As shown in FIG. 5, the sensor board 60 includes three magnetic sensors 61, 62, 63. Each of the three magnetic sensors 61, 62, 63 outputs a position signal corresponding to a rotation position of the rotor 40.

As shown in FIG. 2, FIG. 3, FIG. 5, and FIG. 6, the motor 11 includes a lead group 65 electrically connected to the sensor board 60. The lead group 65 in the present embodiment includes five lead wires. The lead group 65 is electrically connected to the controller 13.

The controller 13 supplies power-supply power to the three magnetic sensors 61, 62, 63 via the lead group 65. The three magnetic sensors 61, 62, 63 operate when supplied with the power-supply power. The position signal that has been output from each of the three magnetic sensors 61, 62, 63 is input to the controller 13 via the lead group 65. The controller 13 detects the rotation position (i.e., electrical angle) of the rotor 40 based on the three position signals that have been input. The controller 13 generates the motor drive electric power in accordance with the detected rotation position.

2-1-2d. Electric Power Terminal

As shown in FIG. 3 to FIG. 6, the motor 11 includes three electric power terminals 31, 32, 33. The three electric power terminals 31, 32, 33 are electrically connected to the six coils 25. The three electric power terminals 31, 32, 33 are electrically connected to the controller 13 and receive the motor drive electric power from the controller 13. The motor drive electric power is supplied to the stator 20 (in more detail, to the six coils 25) via the three electric power terminals 31, 32, 33.

2-1-2e. Fan

As shown in FIG. 2 to FIG. 6, the motor 11 includes a fan 55. The fan 55 is fixed to a rear end part of the rotor shaft 50. The fan 55 rotates together with the rotor 40 and thereby generates airflow. The airflow cools the motor 11.

### 2-1-3. Detailed Configuration of Rotor

The configuration of the rotor 40 will be described in more detail with reference to FIG. 7 to FIG. 17.

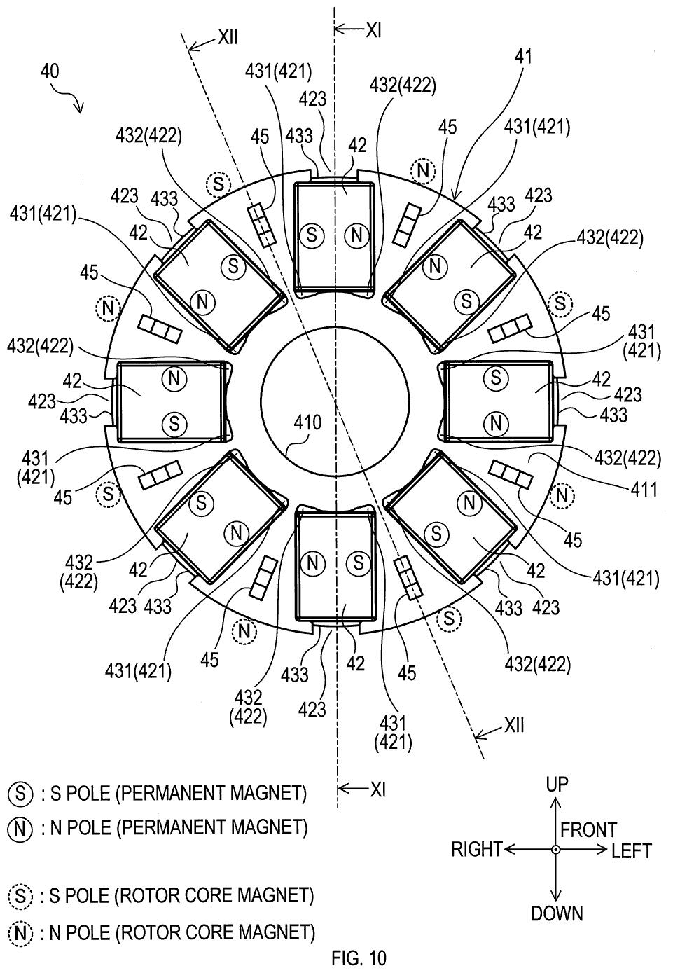

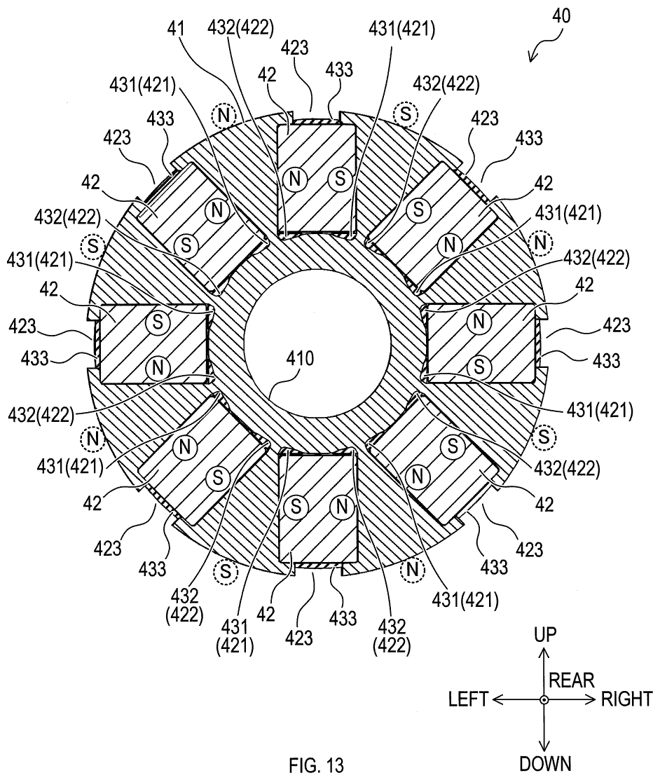

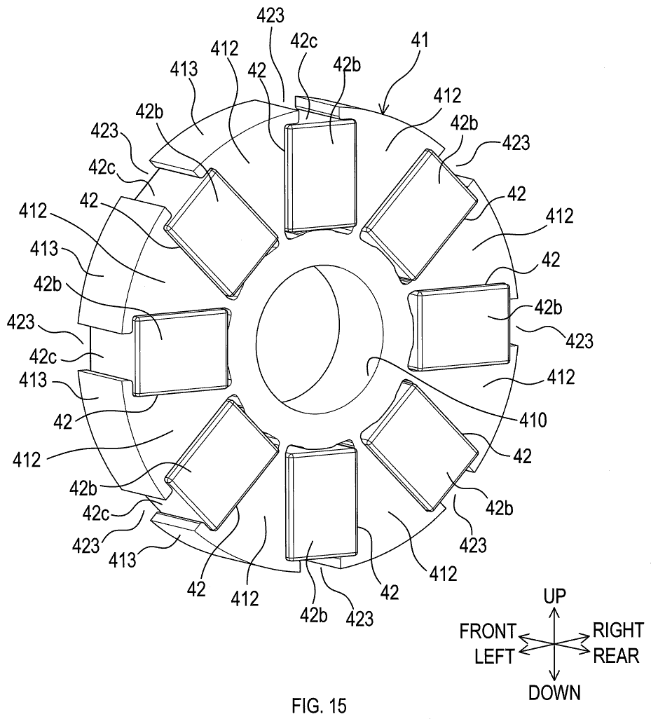

As described above, the rotor 40 includes the rotor core 41, the permanent magnets 42, and the resin fixing portion 43. The rotor 40 in the present embodiment includes eight magnetic poles along its outer circumference, as shown in FIG. 10, FIG. 13, and FIG. 15. In order to provide the rotor 40 with the eight magnetic poles, the permanent magnets 42 in the present embodiment are eight permanent magnets 42.

The resin fixing portion 43 contains (or is composed of) resin (or polymer). The resin is cured and/or solidified. The resin fixing portion 43 may contain a material other than resin. In the present embodiment, the resin fixing portion 43 is entirely made of resin. The resin fixing portion 43 in the present embodiment contains a thermosetting resin. In the present embodiment, the resin fixing portion 43 is entirely or at least substantially made of thermosetting resin. The resin fixing portion 43 may contain a thermoplastic resin having a melting point equal to or less than 200° C. Examples of the thermoplastic resin include PA11 resin and PA12 resin. The melting point of the thermoplastic resin may exceed 100° C.

The permanent magnets 42 each have a substantially rectangular parallelepiped shape. The permanent magnet 42 is shaped to extend along the radial direction. In other words, in the present embodiment, the permanent magnets 42 are arranged in the form of spoke (in other words, radially).

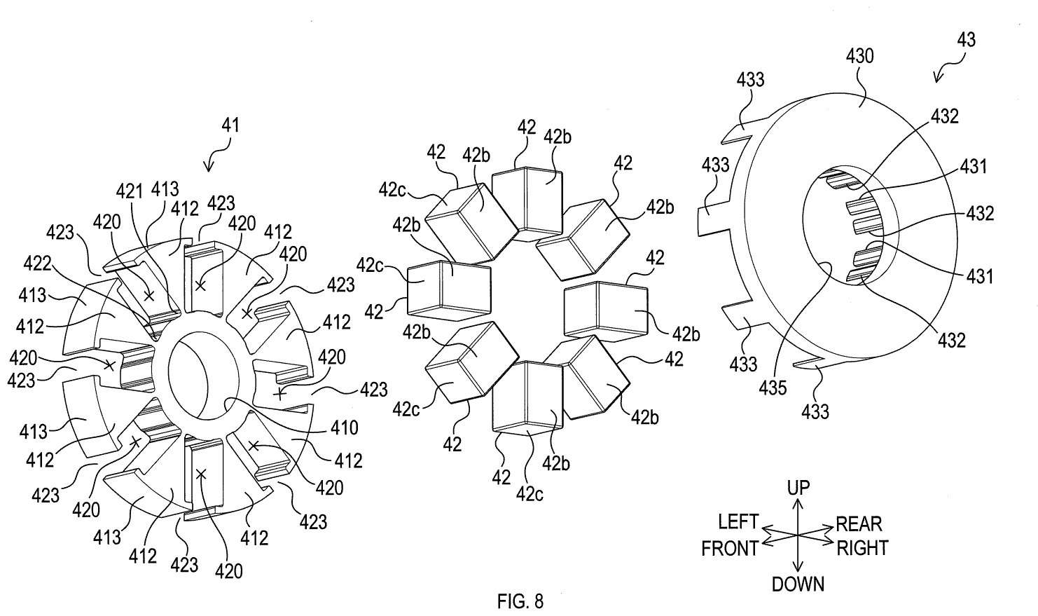

As shown in FIG. 7, FIG. 8, and FIG. 15, each of the permanent magnets 42 has a first face 42a, a second face 42b, and a third face 42c. The first face 42a and the second face 42b intersect (in the first embodiment, are orthogonal to) the axial direction. The first face 42a faces forward, the second face 42b faces rearward, and the third face 42c faces in the radial direction.

As shown in FIG. 10 and FIG. 13, the permanent magnets 42 are arranged so that like poles face each other along the circumferential direction. In FIG. 10 and FIG. 13, the letter “S” enclosed in a circle indicates a south pole region, and the letter “N” enclosed in a circle indicates a north pole region.

Thus, the outer-circumferential surface 413 of the rotor core 41 has the north poles and the south poles alternately along the circumferential direction. For example, the outer-circumferential surface 413 between two permanent magnets 42 with their north poles facing each other is magnetized as the north pole. In FIG. 10 and FIG. 13, the letter “S” enclosed by broken line indicates a south pole, and the letter “N” enclosed by broken line indicates a north pole. The rotor 40 of the first embodiment has four north poles and four south poles. In other words, the rotor 40 has the eight magnetic poles.

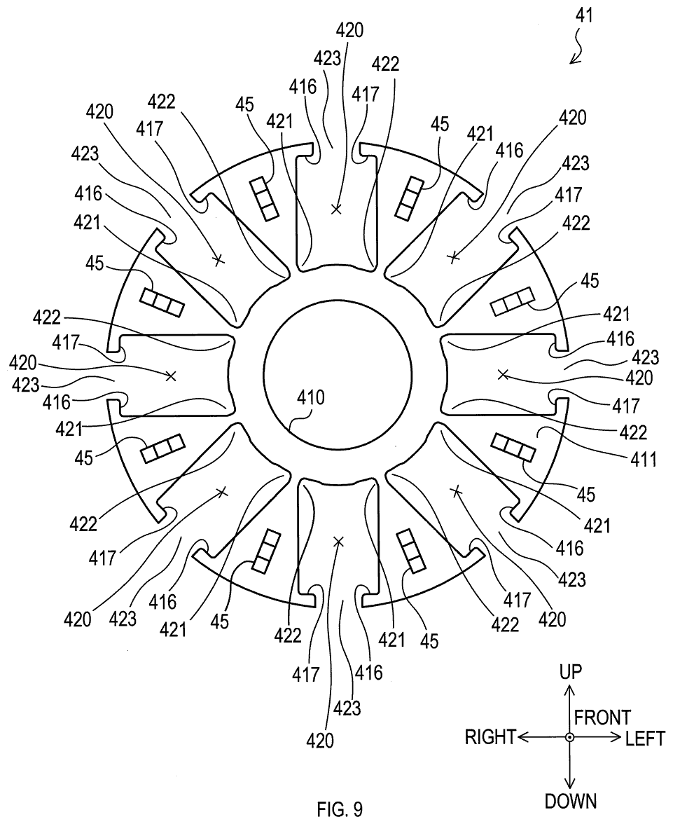

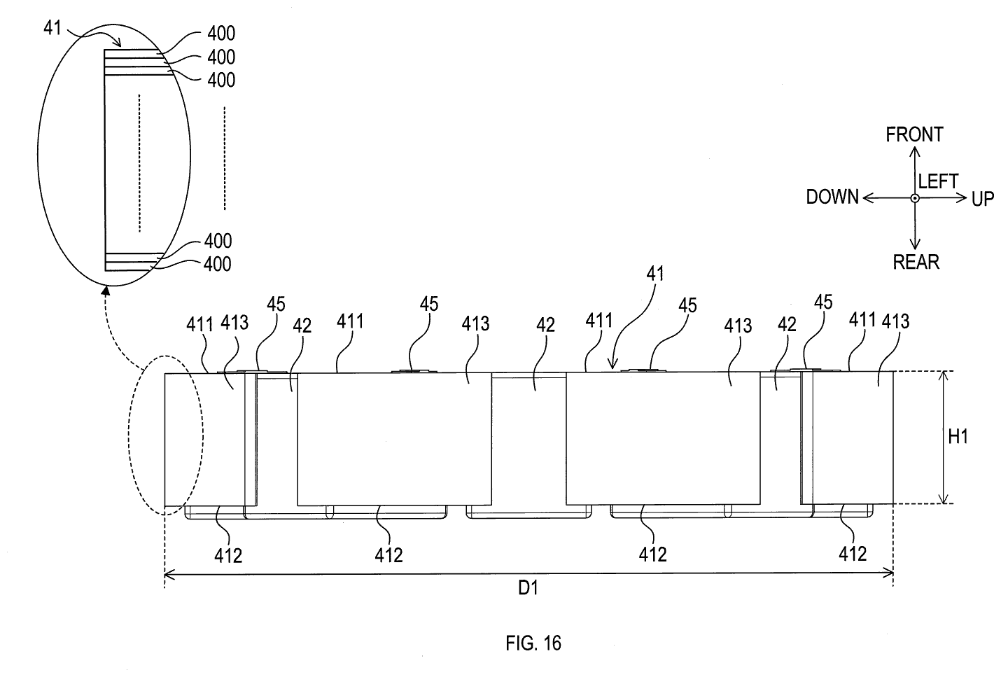

As shown in FIG. 7 to FIG. 15, the rotor core 41 includes the center hole 410. As shown in FIG. 7, FIG. 8, FIG. 15, and FIG. 16, the rotor core 41 has the first end face 411, the second end face 412, and the outer-circumferential surface 413. Although the reference numerals are omitted in FIG. 9 and FIG. 10, the first end face 411 is illustrated. The first end face 411 corresponds to a front end face of the two end faces of the rotor core 41 that intersect (in the first embodiment, are orthogonal to) the axial direction. Of the two end faces of the rotor core 41, the second end face 412 corresponds to a rear end face.

As shown in FIG. 7 to FIG. 9, the rotor core 41 has the magnet insertion holes 420. The magnet insertion holes 420 are spaced apart from each other along the circumferential direction (in the first embodiment, at equal intervals). The magnet insertion holes 420 in the present embodiment are composed of eight magnet insertion holes 420. The permanent magnets 42 are inserted into the respective magnet insertion holes 420.

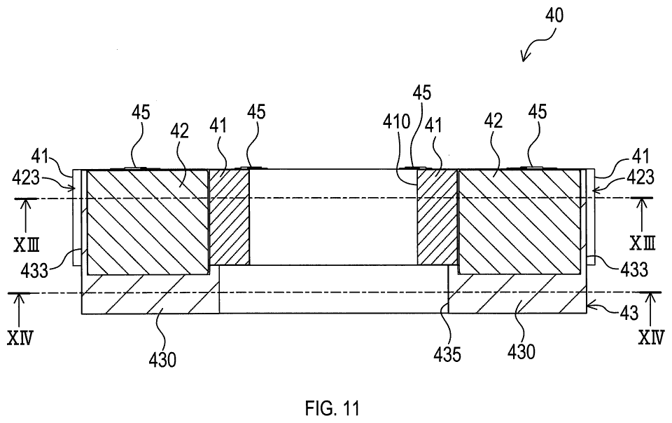

FIG. 10 to FIG. 16, and FIG. 2 to FIG. 6 described above show a state in which the permanent magnets 42 are inserted into the respective magnet insertion holes 420. In the first embodiment, at least a portion (in the first embodiment, the entirety) of the first face 42a of the permanent magnet 42 and at least a portion of (in the first embodiment, the entirety of) the first end face 411 of the rotor core 41 are coplanar. In contrast, as shown in FIG. 11, FIG. 15, and FIG. 16, the second face 42b of the permanent magnet 42 protrudes rearward of the second end face 412 of the rotor core 41.

The rotor core 41 includes the openings 423. The openings 423 are spaced apart from each other on the outer circumference of the rotor core 41 along the circumferential direction. In other words, as described above, the outer-circumferential surface 413 of the rotor core 41 is formed as if it were notched (or has cutouts) at specific intervals along the circumferential direction, and the notched portion (or cutouts) correspond to the openings 423.

The openings 423 are each continuous with a corresponding one of the magnet insertion holes 420. Each of the magnet insertion holes 420 is open in the radial direction via a corresponding one of the openings 423.

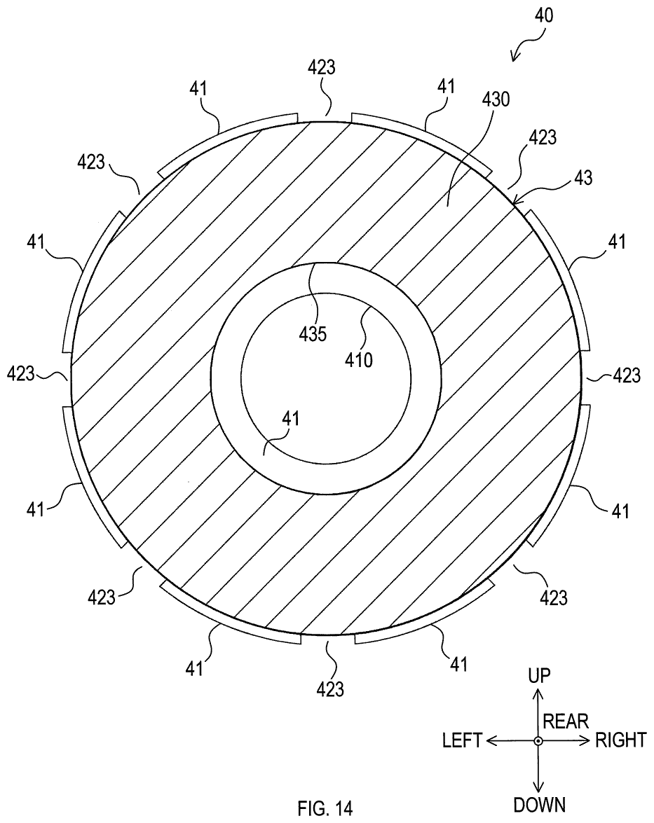

If the openings 423 were not closed up (hypothetically speaking), the permanent magnets 42 inserted into the magnet insertion holes 420 would be exposed in the radial direction via the openings 423. However, in the first embodiment, as described with reference to FIG. 3 and FIG. 5 and as shown in FIG. 10, FIG. 11, FIG. 13, and FIG. 14, the openings 423 are closed up by the resin fixing portion 43 (specifically, by the outer-circumference fixing parts 433).

The magnet insertion holes 420 include at least one intermediate through-space. During a process of molding the resin fixing portion 43, the at least one intermediate through-space is filled with molten resin. Thus, the at least one intermediate through-space may be also referred to as “at least one cavity” or “at least one intermediate cavity”. In the first embodiment, each of the magnet insertion holes 420 includes a first intermediate through-space 421 and a second intermediate through-space 422. The first intermediate through-space 421 and the second intermediate through-space 422 may be also referred to as “first intermediate cavity 421” and “second intermediate cavity 422”. Each of the first intermediate through-space 421 and the second intermediate through-space 422 is a space that axially extends between an inner surface (or inner wall) of the magnet insertion hole 420 and the permanent magnet 42 inserted into the magnet insertion hole 420.

Also, each of the openings 423 also functions as a cavity. In other words, during the process of molding the resin fixing portion 43, the openings 423 are also filled with resin, whereby the openings 423 are closed up as described above.

In each of the magnet insertion holes 420, at least the first intermediate through-space 421, the second intermediate through-space 422, and the opening 423 are filled with liquid resin and are cured (or hardened), and the resin is adhered to and bonded to the inner surface of the magnet insertion hole 420 and the permanent magnet 42. Accordingly, each of the permanent magnets 42 is bonded to the inner surface of the corresponding magnet insertion hole 420 through resin. In addition, side surfaces of each of the permanent magnets 42 facing the inner surface of the corresponding magnet insertion hole 420 are nearly completely in contact with the inner surface of the magnet insertion hole 420 and receive pressure from the inner surface. Consequently, even if no resin fixing portion 43 is provided, each of the permanent magnets 42 is fixed into the corresponding magnet insertion hole 420 by pressure received from the magnet insertion hole 420 and/or a friction due to contact with the inner surface of the magnet insertion hole 420. Accordingly, each of the permanent magnets 42 is more firmly fixed into, and integrally with, the corresponding magnet insertion hole 420 by the resin fixing portion 43, and thus is more firmly fixed to and integrate with the rotor core 41.

As is particularly illustrated in FIG. 9 together with reference numerals, the rotor core 41 includes two or more first restrictors 416 and two or more second restrictors 417. Each of the first restrictors 416 is paired with a corresponding one of the second restrictors 417. Each pair of a first restrictor (or first restricting portions) 416 and a second restrictor (or second restricting portions) 417 forms one opening 423.

In particular, as is clear from FIG. 9 and FIG. 10, the pair constituted by one of the first restrictors 416 and one of the second restrictors 417 radially faces the permanent magnet 42 that is inserted into a corresponding one of the magnet insertion holes 420. Thus, the permanent magnet 42 is restricted from moving radially from the magnet insertion hole 420 (and thus from being removed from the rotor core 41).

As is partially enlarged in FIG. 16, the rotor core 41 includes two or more core sheets 400. The core sheets 400 are axially laminated to each other. Each core sheet 400 has a sheet shape. Each of the core sheets 400 includes a soft magnetic material. Each core sheet 400 of the first embodiment is an electromagnetic steel sheet including electromagnetic steel (or made of electromagnetic steel).

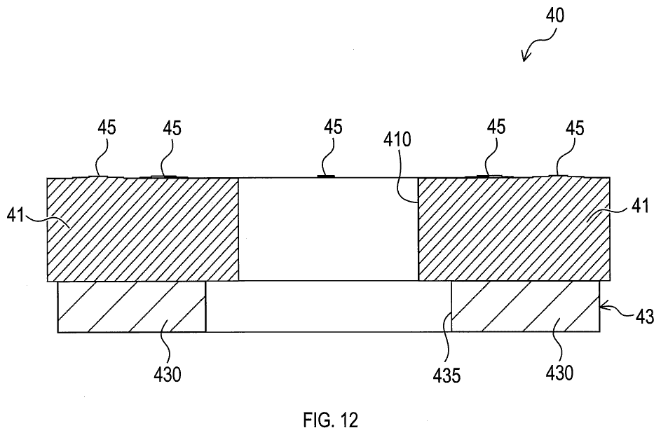

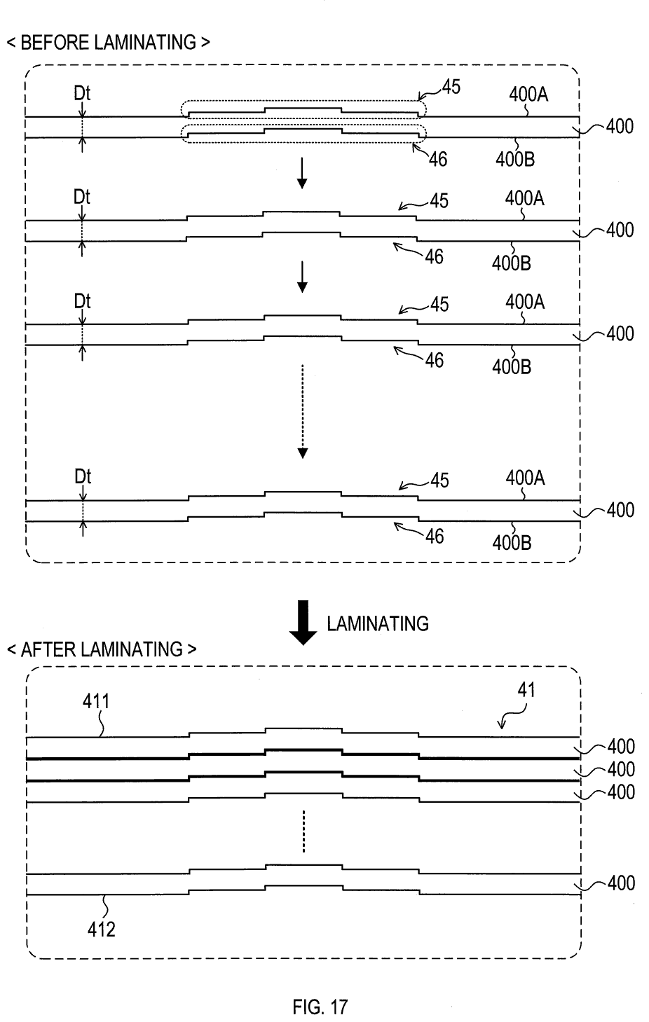

As shown in FIG. 17, each of the core sheets 400 has a first face 400A and a second face 400B. The first face 400A includes a protrusion 45. The second face 400B includes a recess 46. The protrusion 45 is also shown in FIG. 7, FIG. 9 to FIG. 12, and FIG. 16. In FIG. 8, FIG. 12, and FIG. 15, illustration of the recesses 46 are omitted.

The recesses 46 are provided on the respective second faces 400B at locations at which the recesses 46 axially overlap with the protrusions 45. The core sheets 400 each have thickness Dt. Dt is the length (depth) of each of the core sheets 400 in the axial direction. In one example, thickness Dt is greater than 0 mm and is 0.35 mm or less.

In a process of laminating the sheets 400, the protrusion 45 in one of the two core sheets 400 facing each other is fitted into the recess 46 in the other of the two core sheets 400. Accordingly, as shown in FIG. 17, the sheets 400 are axially laminated in close contact with each other, thereby forming the rotor core 41 (i.e., lamination).

When the protrusions 45 are fitted into the respective recesses 46, the pressure (and/or friction force) that mutually acts between the protrusions 45 and the recesses 46 inhibits the protrusions 45 from being removed (or makes it difficult to be removed) from the recesses 46.

In the first embodiment, when the protrusions 45 are fitted into the respective recesses 46, the protrusions 45 and/or the recesses 46 are mechanically deformed (elastically deformed or plastically deformed) due to the pressure at the time of fitting. This mechanical deformation causes the protrusions 45 to be press-fitted into (or clinched to, or swaged into) the recesses 46.

As shown in FIG. 7, FIG. 8, and FIG. 10 to FIG. 14, the resin fixing portion 43 includes the end-face fixing part 430, the first intermediate-fixing parts 431, the second intermediate-fixing parts 432, and the outer-circumference fixing parts 433. The first intermediate-fixing parts 431 are formed by curing (i.e., hardening) the resin filled in the first intermediate through-spaces 421. The second intermediate-fixing parts 432 are formed by curing the resin filled in the second intermediate through-spaces 422. The outer-circumference fixing parts 433 are formed by curing the resin filled in the openings 423.

The rotor 40 may be integrally formed in any manner. The rotor 40 may be formed by, for example, insert molding. Specifically, the rotor 40 may be integrally formed by, for example, the methods described below. That is, first, the rotor core 41 and the permanent magnets 42 are arranged in a mold. At this time, the permanent magnets 42 are inserted into the respective magnet insertion holes 420 in the rotor core 41. At this time, the above-described cavities are located in each of the magnet insertion holes 420.

Next, liquid (optionally molten) resin is injected into the mold. Accordingly, a space (including the above-described cavities) to be filled with resin in the mold is filled with resin.

The filled resin is then cured (or cooled or hardened), and a molded workpiece is removed from the mold.

In such a manner, the rotor 40 is obtained in which the rotor core 41 and the permanent magnets 42 are integrated to each other by the resin fixing portion 43.

As a result of such integral molding, the end-face fixing part 430, the first intermediate-fixing parts 431, the second intermediate-fixing parts 432, and the outer-circumference fixing parts 433 are integrally formed as the resin fixing portion 43. In other words, the permanent magnets 42 are integrally fixed to the rotor core 41 via the resin fixing portion 43.

Components (the first intermediate-fixing parts 431, the second intermediate-fixing parts 432, the outer-circumference fixing parts 433, and the end-face fixing part 430) included in the resin fixing portion 43 are integrally formed by an integral-molding manufacturing method. In other words, the first intermediate-fixing parts 431 are formed by curing (hardening) the resin filled in the respective first intermediate through-spaces 421. The second intermediate-fixing parts 432 are formed by curing the resin filled in the respective second intermediate through-spaces 422. The outer-circumference fixing parts 433 are formed by curing the resin filled in the openings 423.

As shown in FIG. 16, the rotor core 41 has a radial-direction dimension D1 and an axial dimension H1. The radial-direction dimension D1 and the axial dimension H1 will be referred to again in a second embodiment described below.

### 2-1-4. Electrical Configuration of Electric Work Machine

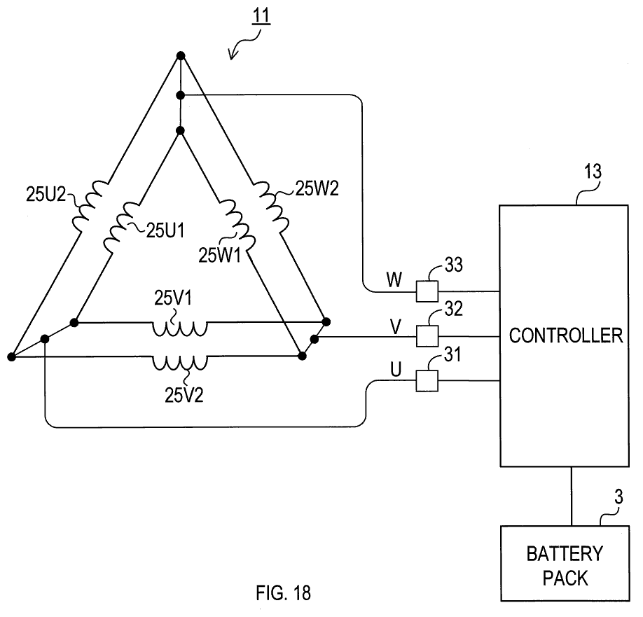

A summary of the electrical configuration of the electric work machine 1 is explained principally referring FIG. 18 and on the basis of FIG. 1 to FIG. 6.

The controller 13 receives the battery power from the battery pack 3. The controller 13 includes, for example, a control circuit, a power-supply circuit, and a drive circuit, which are not shown.

The drive circuit receives the battery power. The drive circuit is formed as, for example, a three-phase, full-bridge circuit. That is, the drive circuit includes six semiconductor switching elements (e.g., power FETs). Each of the six semiconductor switching elements is individually controlled by control instructions from the control circuit. The drive circuit converts the battery power into the above-described motor drive electric power (i.e., three-phase electric power (currents)) in accordance with the control instructions from the control circuit and supplies to the motor 11. Thus, the motor drive electric power is input to the first to third electric power terminals 31 to 33 of the motor 11, and the motor 11 is driven.

The control circuit includes a microcomputer, e.g., one or more microprocessors, memory/storage, input-output devices, and so on. The control circuit is configured to execute various programs. Various functions of the electric work machine 1 are executed by the control circuit executing the various programs. The functions executed by the control circuit include functions for controlling the drive circuit.

The three position signals from the sensor board 60 are input to the control circuit. The control circuit detects the rotation position (i.e., the electrical angle) of the rotor 40 based on these three position signals. The control circuit generates the control instructions on the basis of the rotation positions detected and other drive information and outputs the control instructions to the drive circuit. Thus, appropriate motor drive electric power is (drive currents are) supplied to the motor 11 in accordance with the rotation position of the rotor 40 and other information, such as drive information. The drive information includes, for example, the amount of manipulation (pulling) of the trigger 8.

The control circuit according to the present embodiment is configured so that the motor 11 is caused to rotate at an electric frequency of 1,333 Hz or more. The electric frequency is an integrated value resulting from integrating the number of revolutions of the rotor 40 per unit time and the pole-pairs count. In the present embodiment, specifically, it is the integrated value resulting from integrating the number of revolutions of the rotor 40 per second and the pole-pairs count. The pole-pairs count is ½ of the pole count.

In the present embodiment, the pole-pairs count is four because the pole count of the motor 11 is eight. Consequently, in the present embodiment, causing the motor 11 to rotate at an electric frequency of 1,333 Hz or more means the same as causing the motor 11 to rotate at a rotational speed of 20,000 rpm or more.

In the present embodiment, for example, the rated electric frequency of the motor 11 may be set to 1,333 Hz or more. Alternatively, the electric frequency when the motor 11 is rotated at the maximum rotational speed when the electric work machine 1 is being used may be 1,333 Hz or more. In other words, the rated rotational speed of the motor 11 may be set to 20,000 rpm or more, or the maximum rotational speed when using the electric work machine 1 may be 20,000 rpm or more. The control circuit may be configured, for example, to control the motor 11 (and directly, the drive circuit) such that, in response to manipulation of the trigger 8, the motor 11 always, or while the amount of manipulation of the trigger 8 is a specific amount or more rotates at the electric frequency of 1,333 Hz or more.

The control circuit may cause the motor 11 to rotate at an electric frequency less than 1,333 Hz. The maximum rotational speed of the motor 11 may be less than 20,000 rpm.

The six coils 25 of the motor 11 can be divided in the first-phase coil group, the second-phase coil group, and the third-phase coil group. As shown in FIG. 18 (and in FIG. 3 and FIG. 5), the first-phase coil group includes the pair of first-phase coils 25U1, 25U2, which are mutually connected in parallel. The second-phase coil group includes the pair of second-phase coils 25V1, 25V2, which are mutually connected in parallel. The third-phase coil group includes the pair of third-phase coils 25W1, 25W2, which are mutually connected in parallel. Furthermore, the first-phase coil group, the second-phase coil group, and the third-phase coil group are delta-connected to each other.

From a different viewpoint, the motor 11 can be said to include two delta-connection groups. The first delta-connection group includes the first-phase coil 25U1, the second-phase coil 25V1, and the third-phase coil 25W1, which are delta-connected to each other. The second delta-connection group includes the first-phase coil 25U2, the second-phase coil 25V2, and the third-phase coil 25W2, which are delta-connected to each other. The first and second delta-connection groups are mutually connected in parallel.

Furthermore, a first end of each of the first-phase coils 25U1, 25U2 and a second end of each of the second-phase coils 25V1, 25V2 are connected to the first electric power terminal 31. A first end of each of the second-phase coils 25V1, 25V2 and a second end of each of the third-phase coils 25W1, 25W2 are connected to the second electric power terminal 32. A first end of each of the third-phase coils 25W1, 25W2 and a second end of each of the first-phase coils 25U1, 25U2 are connected to the third electric power terminal 33.

It is noted that the coils 25 (six coils in the present embodiment) in the motor 11 may be wired in any manner. For example, the pair of first-phase coils 25U1, 25U2 in the first-phase coil group may be mutually connected in series. The same applies to the second-phase coil group and the third-phase coil group.

In addition, the first-phase coil 25U1, the second-phase coil 25V1, and the third-phase coil 25W1 may be, for example, star-connected. The same applies to the other coils, i.e., the first-phase coil 25U2, the second-phase coil 25V2, and the third-phase coil 25W2.

### 2-1-5. Characteristics of the Motor

In addition to the various features described above, the motor 11 according to the first embodiment further has the features described below.

Specifically, the motor 11 according to the first embodiment is configured so as to satisfy Equation (1) below.

$$\frac{R}{{( \frac{Vin}{Ne} )}^{2}} < 433000000 \cdot {Vol}^{- 1.621} \qquad ( 1 )$$

In the Equation (1), R is the line-to-line (or wire-to-wire) resistance value (mΩ) of the motor 11. The line-to-line resistance value is the magnitude of the line-to-line resistance of the motor 11. The line-to-line resistance may also be called the motor resistance. The line-to-line resistance is, more specifically, the resistance between two of the electric power terminals from among the first to third electric power terminals 31 to 33. In the present embodiment, the line-to-line resistance value between the first electric power terminal 31 and the second electric power terminal 32, the line-to-line resistance value between the second electric power terminal 32 and the third electric power terminal 33, and the line-to-line resistance value between the third electric power terminal 33 and the first electric power terminal 31 are all equal. R may be a line-to-line resistance value that is determined in advance during the design stage.

In the Equation (1), Vin is the rated-voltage value (V) of the motor 11. In the present embodiment, the rated-voltage value of the motor 11 is equal to the rated-voltage value of the battery 3A. Though merely one example, the rated-voltage value of the battery 3A according to the present embodiment is 36 V. Accordingly, in the present embodiment, Vin is 36 V.

In the Equation (1), Ne is the rotational speed (krpm) of the motor 11 when the effective back-EMF value E (V) of the motor 11 is equal to the rated-voltage value of the motor 11. The effective back EMF will be described in detail below.

In the Equation (1), Vol is the volume (mm³) of the stator 20. More specifically, Vol in the present embodiment is the volume of the stator core 21. The volume of the stator core 21 according to the present embodiment is an integrated value resulting from integrating the surface area of the core-end circle (mm²) over the core length (mm). The core-end circle is a circle in which outer diameter Ld (see FIG. 6) of the stator core 21 is taken as the diameter. The core length is length Ls (see FIG. 6) along the axial direction of the stator core 21. It is noted that, as shown in FIG. 2 and FIG. 3, projection parts are discretely formed on the outer surface of the back core 211 in the circumferential direction; however, as is clear from FIG. 6, outer diameter Ld is the outer diameter of the back core 211 with those projection parts removed.

The effective back-EMF value E (V) will now be explained in greater detail. First, back EMF will be explained. The “EMF” stands for electromotive force. The back-EMF may be also referred to as “induced voltage”. It is known, generally, that back EMF is generated in a stator-side coil when a rotor having permanent magnets rotates.

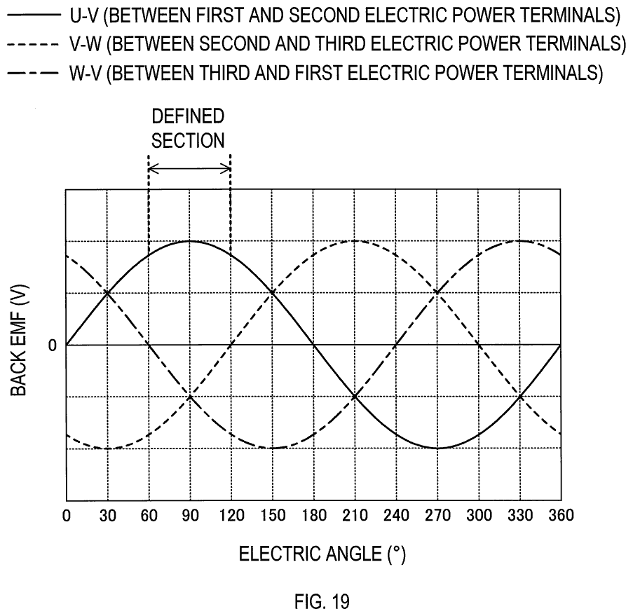

Similarly, in the motor 11 according to the present embodiment, back EMF is generated (occurs, arises) in each of the six coils 25 when the rotor 40 rotates; in turn, as shown in the example in FIG. 19, back EMF is generated (occurs, arises) between each pair of two of the terminals from among the first to third electric power terminals 31 to 33.

Here, as shown in the example in FIG. 19, a specific electrical-angle range, which includes the electrical angle (90 degrees between U and V) at which back EMF becomes the largest, is defined as a defined section (interval). In the first embodiment, the width of electrical angle of the defined section (interval) is 60 degrees. However, the width of the electrical angle may be different from 60 degrees. The electrical-angle range may be appropriately selected, e.g., from the range of 40 degrees or more to 90 degrees or less. In the first embodiment, an average value of the back-EMF within the defined section is used as the effective back-EMF value.

As shown in Equations (2) and (3) below, the left side of the above-mentioned Equation (1) is defined as “first characteristic value fa”, and the right side of the above-mentioned Equation (1) is defined as “second characteristic value fb”.

$$fa = \frac{R}{{( \frac{Vin}{Ne} )}^{2}} \qquad ( 2 )$$

$$fb = 433000000 \cdot {Vol}^{- 1.621} \qquad ( 3 )$$

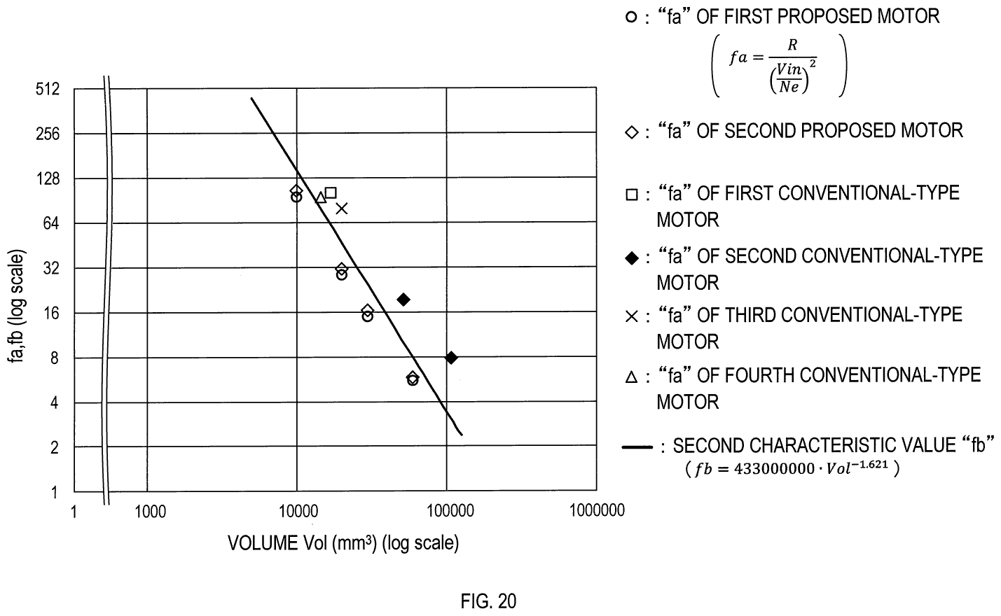

FIG. 20 shows an example of first characteristic values fa and second characteristic values fb for each of thirteen motors. The thirteen motors are: four first proposed motors; four second proposed motors; a first conventional-type motor; two second conventional-type motors; a third conventional-type motor; and a fourth conventional-type motor. The parameters for each motor are shown in Table 1 below.

TABLE 1

| | | | Ld | Ls | Ne | E | Ke | R | Vol |
|---|---|---|---|---|---|---|---|---|---|
| | POLE | SLOT | (mm) | (mm) | (krpm) | (V) | (V/krpm) | (mΩ) | (mm³) |
| 1st P.M. | 8 | 6 | 50 | 5 | 25.0 | 36 | 1.44 | 196.1 | 9817 |
| | 8 | 6 | 50 | 10 | 25.0 | 36 | 1.44 | 59.8 | 19635 |
| | 8 | 6 | 50 | 15 | 25.0 | 36 | 1.44 | 31.1 | 29452 |
| | 8 | 6 | 50 | 30 | 25.0 | 36 | 1.44 | 11.5 | 58905 |
| 2nd P.M. | 8 | 6 | 50 | 5 | 25.0 | 36 | 1.44 | 219.2 | 9817 |
| | 8 | 6 | 50 | 10 | 25.0 | 36 | 1.44 | 63.9 | 19635 |
| | 8 | 6 | 50 | 15 | 25.0 | 36 | 1.44 | 33.6 | 29452 |
| | 8 | 6 | 50 | 30 | 25.0 | 36 | 1.44 | 12.0 | 58905 |
| 1st C.M. | 4 | 6 | 44 | 11 | 31.2 | 36 | 1.15 | 133.9 | 16726 |
| 2nd C.M. | 4 | 6 | 52 | 24 | 25.0 | 36 | 1.44 | 39.8 | 50969 |
| | 4 | 6 | 52 | 50 | 21.1 | 36 | 1.71 | 22.8 | 106186 |
| 3rd C.M. | 4 | 6 | 50 | 10 | 30.8 | 18 | 0.58 | 27.2 | 19635 |
| 4th C.M. | 4 | 6 | 51 | 7 | 25.9 | 18 | 0.70 | 44.9 | 14300 |

In Table 1, “1st P.M.” refers to the “first proposed motor”, “2nd P.M.” refers to the “second proposed motor,” “1st C.M.” refers to the “first conventional-type motor,” “2nd C.M.” refers to the “second conventional-type motor,” “3rd C.M.” denotes the “third conventional-type motor,” and “4th C.M.” denotes the “fourth conventional-type motor.” “Ke” is a back-EMF constant. The back-EMF constant Ke is obtained by dividing E by Na. E is the aforementioned effective back-EMF value, and Na (krpm) is the rotational speed at which the effective back-EMF value E occurs.

The first and second proposed motors both correspond to the motor 11 of the present first embodiment. Although the following are just examples, the first and second proposed motors both have at least the below-mentioned Features (a) to (c):
(a) the motor includes eight magnetic poles and six core teeth (i.e., the six slots and the six coils 25);
(b) thickness Dt of each of the core sheets 400 is 0.35 mm or less; and
(c) the motor is configured to be able to rotate at an electric frequency of 1,333 Hz or more.

It is noted that a point of difference between the first and second proposed motors is the widths of the permanent magnets. That is, the width of the permanent magnets 42 of the second proposed motor is smaller than the width of the permanent magnets 42 of the first proposed motor. Here, the “width” of the permanent magnets 42 is the length along the direction perpendicular to both the axial direction and the radial direction of the rotor 40.

In contrast, the first to fourth conventional-type motors do not have at least the Feature (a) among the above-mentioned Features (a) to (c). Specifically, the first to fourth conventional-types motors are all 4-pole 6-slot motors. Regarding (b) above, the thickness Dt of each of the first proposed motors is 0.25 mm. The thickness Dt of each of the other nine motors is 0.35 mm. The rated-voltage value of each of the third conventional-type motor and the fourth conventional-type motor is 18 V, and the rated voltage value of each of the other eleven motors is 36 V.

It is noted that the length and/or winding count of the coils vary with volume Vol. Consequently, the wire-to-wire resistance value R can likewise vary with volume Vol. In addition, the magnetic characteristics (for example, the magnetic reluctance) of the stator and the rotor likewise vary with volume Vol. Consequently, the above-mentioned rotational speed Ne can likewise vary with volume Vol. Consequently, the first characteristic values fa of the differently designed motors likewise vary with volume Vol.

The first characteristic value fa is an indicator of the power density of each motor. The larger the line-to-line resistance value R, the lower the output of the motor. Therefore, the smaller the first characteristic value fa, the higher the output density. The second characteristic value fb is an indicator (or threshold) for evaluating the first characteristic value fa. For a motor with a given volume Vol, when the first characteristic value fa is smaller than the second characteristic value fb, the power density of the motor is high. When the first characteristic value fa is larger than the second characteristic value fb, the power density of the motor is low.

As is clear from FIG. 20, the first characteristic values fa of the first proposed motors and the first characteristic values fa of the second proposed motors are smaller (less) than the corresponding second characteristic values fb thereof. That is, both the first and second proposed motors satisfy the above-mentioned Equation (1). Consequently, a desired power density can be achieved by a motor 11 that satisfies the above-mentioned Equation (1) without requiring an enlargement of the motor 11.

In contrast, the first characteristic values fa of the first to the fourth conventional-type motors are larger (greater) than the corresponding second characteristic values fb thereof. In other words, both the first to the fourth conventional-type motors do not satisfy the above Equation (1). Consequently, in embodiments in which volumes Vol are assumed to be the same, each of the first to the fourth conventional-type motors has a lower power density than that of the first and second proposed motors.

### 2-1-6. Technical Effects of First Embodiment

The first embodiment has the following technical effects.

The rotor core 41 and the permanent magnets 42 are integrated via molding with the resin fixing portion 43. Also, the motor 11 satisfies the above Equation (1). This configuration allows the permanent magnets 42 to be securely fixed to the rotor core 41, enabling high-speed rotation and/or increased output of the motor 11.

Each permanent magnet 42 is inserted into a corresponding one of the magnet insertion holes 420 in the rotor core 41. In the corresponding magnet insertion hole 420, one or more cavities are secured. This configuration enables each of the permanent magnets 42 to be stably and easily fixed in the corresponding magnet insertion hole 420 using resin.

The outer-circumferential surface 413 of the rotor core 41 has the openings 423. Each opening 423 inhibits magnetic flux generated by the corresponding permanent magnet 42 from being short-circuited. Thus, the magnetic flux from the permanent magnets 42 can be effectively used by output of the motor 11.

The openings 423 are covered by the resin fixing portion 43 (specifically, by the outer-circumference fixing parts 433). Since the outer-circumference fixing parts 433 are made of resin, the securing strength for the permanent magnets 42 is increased, while the outer-circumference fixing parts 433 have no (or almost no) influence on a magnetic circuit.

In addition, most of a second end face 412 side of the rotor core 41 is covered by the resin fixing portion 43 (specifically, by the end-face fixing part 430). This configuration enables the rotor core 41 and the permanent magnets 42 to be more stably integrated.

As described with reference to FIG. 17, the core sheets 400 include the respective protrusions 45 and the respective recesses 46. In the lamination process of the sheets 400, the protrusion 45 in one of the two core sheets 400 facing each other is fitted in the recess 46 in the other of the two core sheets 400 facing each other. This fitting causes the protrusion 45 to be press-fitted into the recess 46. This configuration enables the sheets 400 to be stably and accurately laminated in the lamination process. As a result, the rotor core 41 with a higher quality can be provided.

### 2-2. Second Embodiment

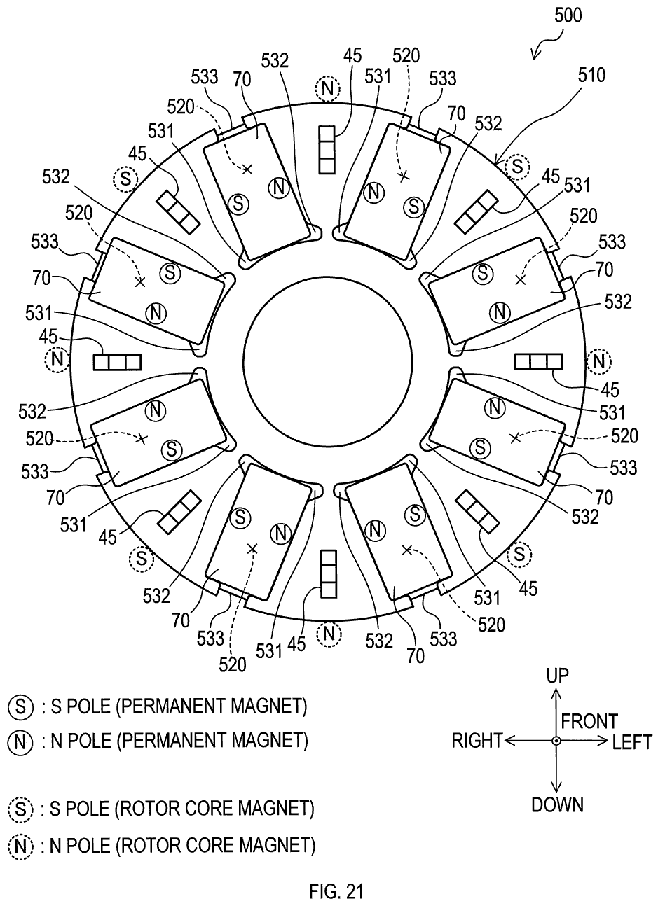

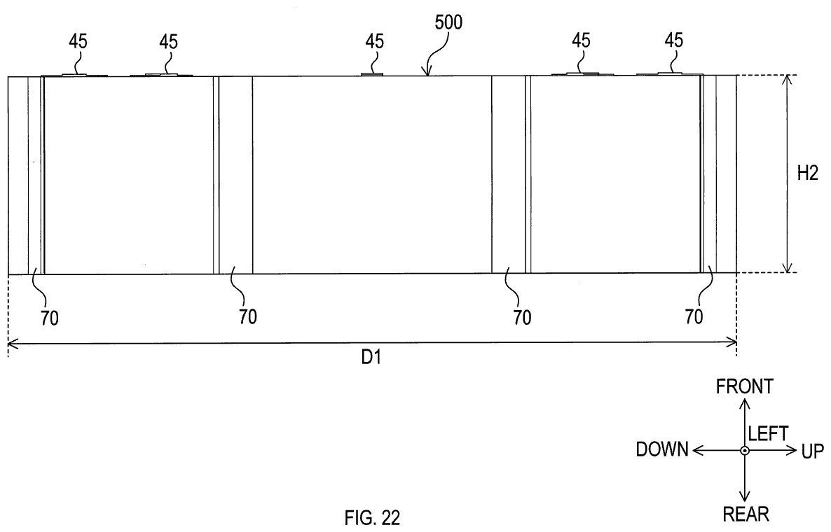

The second embodiment provides another example of a rotor with a different configuration. As shown in FIG. 21 and FIG. 22, a basic configuration of a rotor 500 of the second embodiment is the same as that of the rotor 40 of the first embodiment.

Specifically, the rotor 500 includes a rotor core 510 and two or more permanent magnets 70. Similarly to the first embodiment, the permanent magnets 70 are arranged so that like poles face each other along its circumferential direction. Similarly to first embodiment, the rotor 500 includes, for example, eight magnetic poles. Thus, the rotor core 510 includes eight permanent magnets 70.

Similarly to the first embodiment, the rotor core 510 includes two or more magnet insertion holes 520. Each of the permanent magnets 70 is inserted into a corresponding one of the magnet insertion holes 520. Similarly to the first embodiment, the rotor core 510 and the permanent magnets 70 are integrated via molding with a resin fixing portion. Similarly to the resin fixing portion 43 of the first embodiment, the resin fixing portion includes two or more first intermediate-fixing parts 531, two or more second intermediate-fixing parts 532, and two or more outer-circumference fixing parts 533, and an end-face fixing part (not shown) are integrally molded.

The rotor 500 configured as described above is different from the rotor 40 of the first embodiment, mainly in a dimension of the rotor core 510 and a width of each of the permanent magnets 70. Here, “width” is a length in a direction (i) parallel to an axially orthogonal plane and (ii) perpendicular to the radial direction of the rotor 500. The axially orthogonal plane is a virtual plane orthogonal to the axis direction.

As shown in FIG. 22, the rotor core 510 has the radial-direction dimension D1, as in the rotor core 41 of the first embodiment. Unlike the rotor core 41, the rotor core 510 has an axial dimension H2. The axial dimension H2 is greater than the axial dimension H1 of the first embodiment.

In contrast, a width of each of the permanent magnets 70 that are arranged in the rotor core 510 is smaller than the width of the permanent magnet 42 of the first embodiment.

In other words, when the radial-direction dimension of the rotor core is constant, the width of the permanent magnet becomes smaller as the axial dimension of the rotor core increases. The resin fixing portion is omitted in FIG. 22 for the sake of simplicity of the explanation.

When the axial dimension of the rotor core is increased, a magnetic force of the permanent magnets also increases, and this may cause the stator to resonate and generate noise. Thus, when the axial dimension of the rotor core is increased, the width of each of the permanent magnets is appropriately reduced accordingly. This configuration can inhibit noise caused by stator resonance while maintaining a desired rotational speed and/or a desired motor output.

### 2-3. Third Embodiment

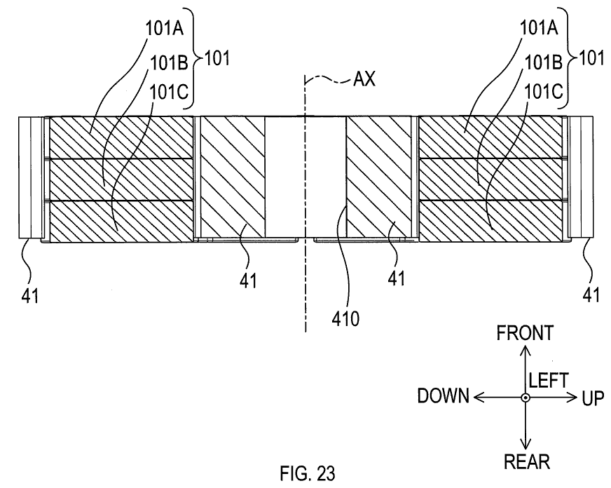

A third embodiment provides another mode of the permanent magnets. As shown in FIG. 23, two or more permanent magnets 101 of the third embodiment are inserted in the rotor core 41. However, compared with the permanent magnets 42 of the first embodiment, each of the permanent magnets 101 is divided along the axial direction. Thus, each of the permanent magnets 101 may be also referred to as a “permanent magnet set 101”, a “set of permanent magnets 101”, or the like. The permanent magnets 101 may each be divided in any number of portions along the axial direction.

In the third embodiment, the permanent magnets 101 are each divided, simply as one example, into three portions along the axial direction. That is, each of the permanent magnets 101 includes a first part (or a first magnet segment) 101A, a second part (or a second magnet segment) 101B, and a third part (or a third magnet segment) 101C. The first part 101A, the second part 101B, and the third part 101C are arranged alongside in this order along the axial direction.

In FIG. 23, an illustration of the resin fixing portion is omitted for the sake of simplicity of explanation. In practice, a rotor of the third embodiment also includes the resin fixing portion that is substantially similar to the resin fixing portion 43 of the first embodiment. The rotor core 41 and the permanent magnets 101 are integrated via molding with that resin fixing portion.

In other words, the rotor of the third embodiment corresponds to a configuration in which the permanent magnets 42 of the rotor 40 of the first embodiment shown in FIG. 10 is replaced with the permanent magnets 101 of the third embodiment.

### 2-4. Fourth Embodiment

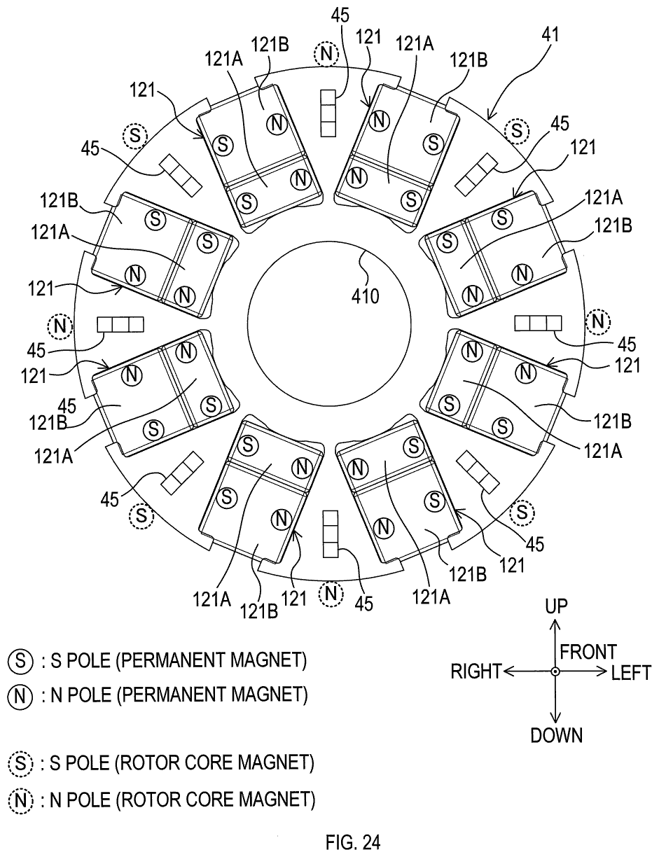

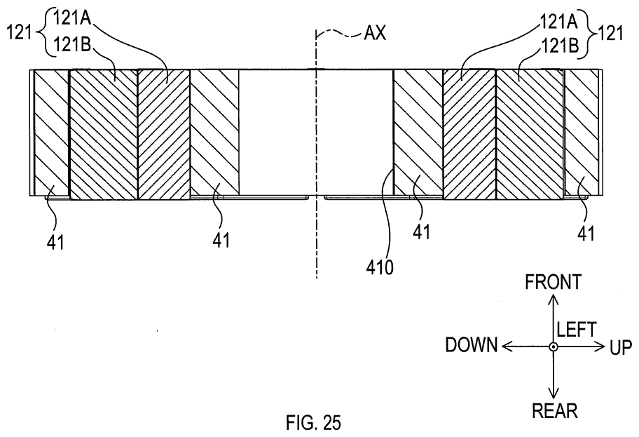

A fourth embodiment provides another example of a permanent magnet with a different configuration. As shown in FIG. 24 and FIG. 25, two or more permanent magnets 121 of the fourth embodiment are inserted in the rotor core 41, similarly to the first embodiment. However, each of the permanent magnets 121 of the fourth embodiment is divided along the radial direction. Thus, the permanent magnet 121 may be also referred to as a “permanent magnet set 121”, a “set of permanent magnets 121”, or the like. The permanent magnet 121 may be partitioned into any number of portions along the radial direction.

In the fourth embodiment, the permanent magnets 121 are each partitioned, simply as one example, into two portions along the radial direction. Specifically, the permanent magnets 121 each include a first part (or a first magnet segment) 121A and a second part (or a second magnet segment) 121B. The first part 121A and the second part 121B are arranged to be adjacent to each other in this order along the radial direction.

In FIG. 24 and FIG. 25, an illustration of a resin fixing portion is omitted for the sake of simplicity of explanation. In practice, a rotor of the fourth embodiment also includes a resin fixing portion that is substantially similar to the resin fixing portion 43 of the first embodiment. The rotor core 41 and the permanent magnets 121 are integrated via molding with that resin fixing portion.

In other words, the rotor of the fourth embodiment corresponds to a configuration in which the permanent magnets 42 of the rotor 40 of the first embodiment shown in FIG. 10 are replaced with the permanent magnets 121 of the fourth embodiment.

The first part 121A may have the same length as the second part 121B. However, the first part 121A in the present embodiment has a shorter length than the second part 121B. Here, “length” refers to a length in the radial direction.

The length of the first part 121A is shorter than that of the second part 121B, which contributes to inhibiting temperature rise of the permanent magnet 121 as a whole. Specifically, the first part 121A is arranged closer to the rotational axis AX in the radial direction than the second part 121B is. This configuration makes it more difficult to cool (i.e., release heat) the first part 121A than the second part 121B.

To cope with this, the first part 121A has a shorter length than that of the second part 121B, which can make an eddy current loss of the first part 121A smaller than an eddy current loss of the second part 121B. This configuration can make the heat generation amount of the first part 121A smaller than the heat generation amount of the second part 121B.

Each of the permanent magnets 121 may be partitioned into three or more portions in the radial direction. In this case, the length of each of the three or more portions may be longer as the portion is farther away from the rotational axis AX.

### 2-5. Fifth Embodiment

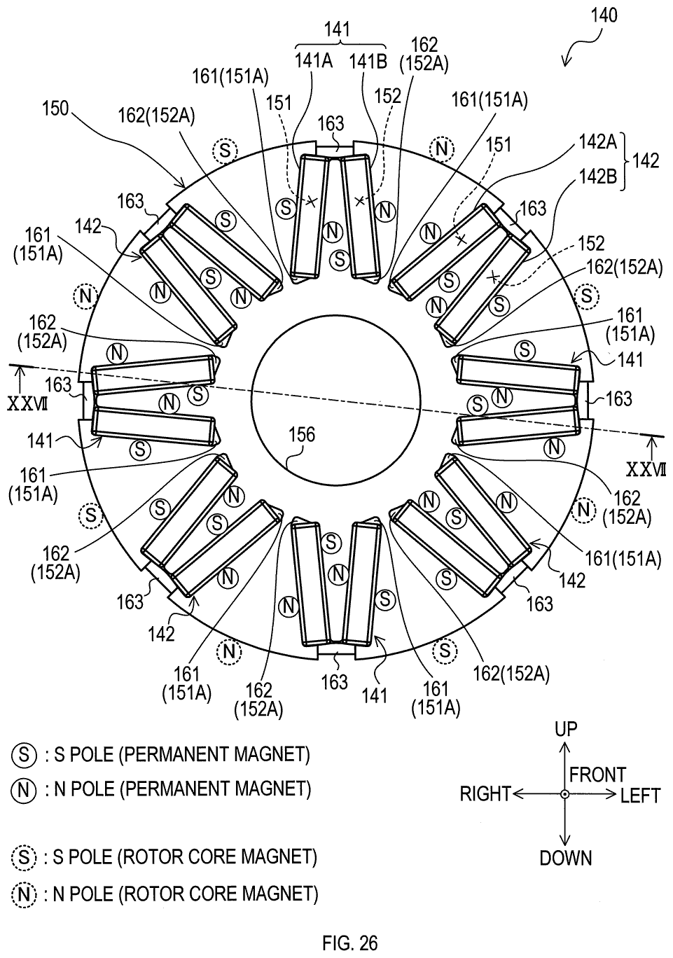

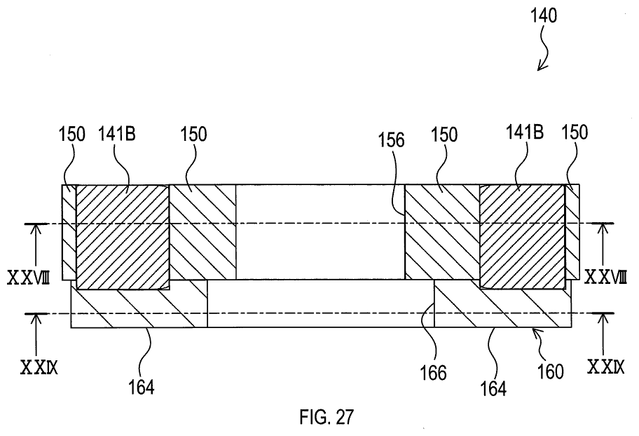

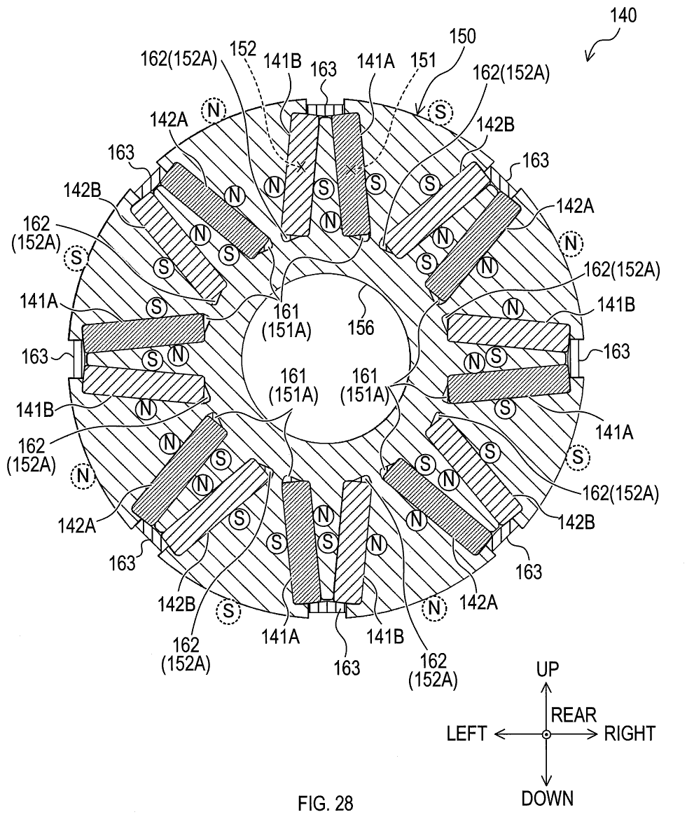

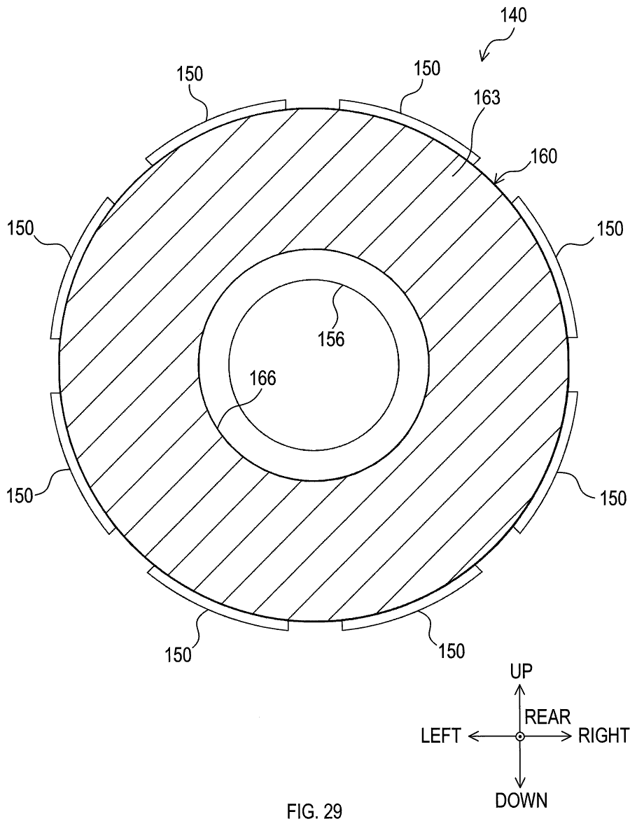

A rotor 140 in a fifth embodiment will be described with reference to FIG. 26 to FIG. 29. The rotor 140 includes a rotor core 150, two or more sets of permanent magnets, and a resin fixing portion 160 (see FIG. 27).

The rotor core 150 includes a center hole 156 passing therethrough in the axial direction. The resin fixing portion 160 includes two or more first intermediate-fixing parts 161, two or more second intermediate-fixing parts 162, two or more outer-circumference fixing parts 163, and an end-face fixing part 164.

Similarly to the first embodiment, the rotor 140 of the fifth embodiment also includes eight magnetic poles. Thus, the rotor 140 includes, for example, eight sets of permanent magnets (or eight permanent magnet sets). The eight sets of permanent magnets are composed of four first sets 141 and four second sets 142.

Each of the first sets 141 includes a first magnet segment 141A and a second magnet segment 141B. Each of the second sets 142 includes a first magnet segment 142A and a second magnet segment 142B.

In the first set 141, the first magnet segment 141A and the second magnet segment 141B are (i) spaced apart from each other along the circumferential direction and (ii) arranged such that the opposite poles face each other along the circumferential direction. The same applies to the first magnet segment 142A and the second magnet segment 142B in the second set 142.

The four first sets 141 and the four second sets 142 are alternately arranged along the circumferential direction. In addition, the four first sets 141 and the four second sets 142 are arranged so that like poles thereof face each other along the circumferential direction. Accordingly, the north pole and the south pole are alternately generated on an outer circumference of the rotor core 150 along the circumferential direction, similarly to the first embodiment.

The rotor core 150 includes eight sets of magnet insertion holes for arranging two or more sets of permanent magnets. Each set of the eight sets of magnet insertion holes includes a first hole 151 and a second hole 152. The first magnet segment 141A and the first magnet segment 142A are each inserted into the corresponding first hole 151. The second magnet segment 141B and the second magnet segment 142B are inserted into the corresponding second hole 152.

The first magnet segment 141A and the second magnet segment 141B, which form the first set 141, are arranged so that their cross-sectional shape perpendicular to the axial direction is a substantially V-shape. In other words, the first magnet segment 141A extends at an angle slightly inclined with respect to the radial direction, and the second magnet segment 141B also extends at an angle slightly inclined with respect to the radial direction. The same applies to the first magnet segment 142A and the second magnet segment 142B, which form the second set 142.

Between an inner surface (or inner wall) of the first hole 151 and the first magnet segment 141A (or the first magnet segment 142A), a first intermediate through-space (or a first cavity) 151A is formed. The first intermediate through-space 151A is filled with the first intermediate-fixing part 161. Between an inner surface (or inner wall) of the second hole 152 and the second magnet segment 141B (or the second magnet segment 142B), a second intermediate through-space (or a second cavity) 152A is formed. The second intermediate through-space 152A is filled with the second intermediate-fixing part 162.

Each opening of the rotor core 150 is covered by the outer-circumference fixing part 163. As shown in FIG. 27, the end-face fixing part 164 covers the rotor core 150 and the permanent magnets from the rear. The end-face fixing part 164 includes a center hole 166.

Similarly to the resin fixing portion 43 of the first embodiment, the resin fixing portion 160 is integrally formed when the permanent magnets are integrated via molding with the rotor core 150 using resin. In other words, similarly to the first embodiment, the permanent magnets are fixed to and supported by the rotor core 150 via at least the resin fixing portion 160.

### 2-6. Sixth Embodiment

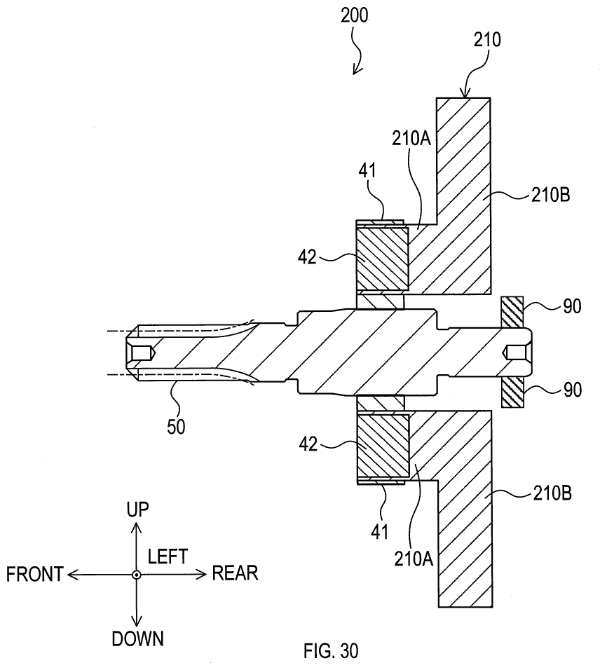

As shown in FIG. 30, a rotor 200 of the sixth embodiment differs mainly in a configuration of a resin fixing portion 210, as compared with the rotor 40 of the first embodiment. In the first embodiment, the fan 55 is provided separately from the resin fixing portion 43. In contrast, in the sixth embodiment, the corresponding fan is integrated into the resin fixing portion 210.

Specifically, the resin fixing portion 210 includes a fixing part 210A and a fan part 210B. The fixing part 210A and the fan part 210B are integrally molded using resin.

The fixing part 210A substantially corresponds to the resin fixing portion 43 of the first embodiment. The fan part 210B has a shape similar to the fan 55 of the first embodiment and functions as a fan. Reference numeral 90 denotes a bearing. A first end of the rotor shaft 50 is rotatably supported by the bearing 90. The same applies to the first embodiment, though not have been mentioned.

### 2-7. Seventh Embodiment

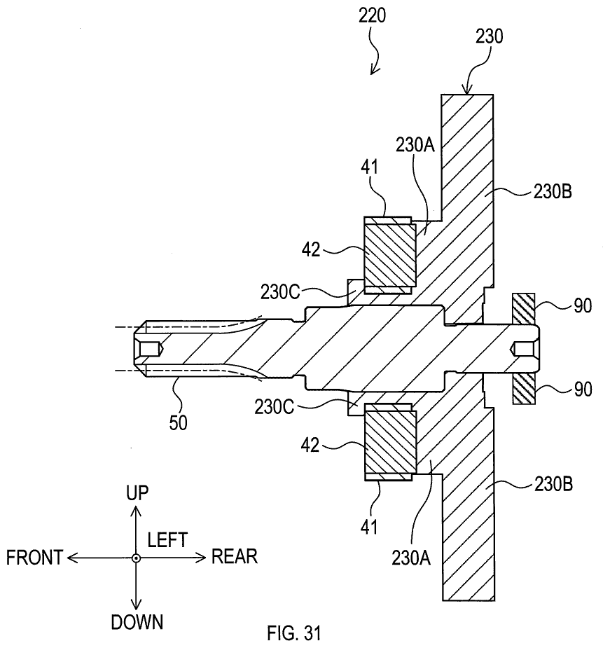

A seventh embodiment provides another example of a rotor with a different configuration. In the rotor of the seventh embodiment, the resin fixing portion and the fan are integrated and fixed (i.e., a variation example of the rotor 200 of the sixth embodiment). As shown in FIG. 31, a rotor 220 of the seventh embodiment differs mainly in a configuration of a resin fixing portion 230, as compared with the rotor 40 of the first embodiment. Specifically, in the seventh embodiment, a corresponding fan is integrated into the resin fixing portion 230. Further, the rotor shaft 50 is inserted into and fixed to the resin fixing portion 230.

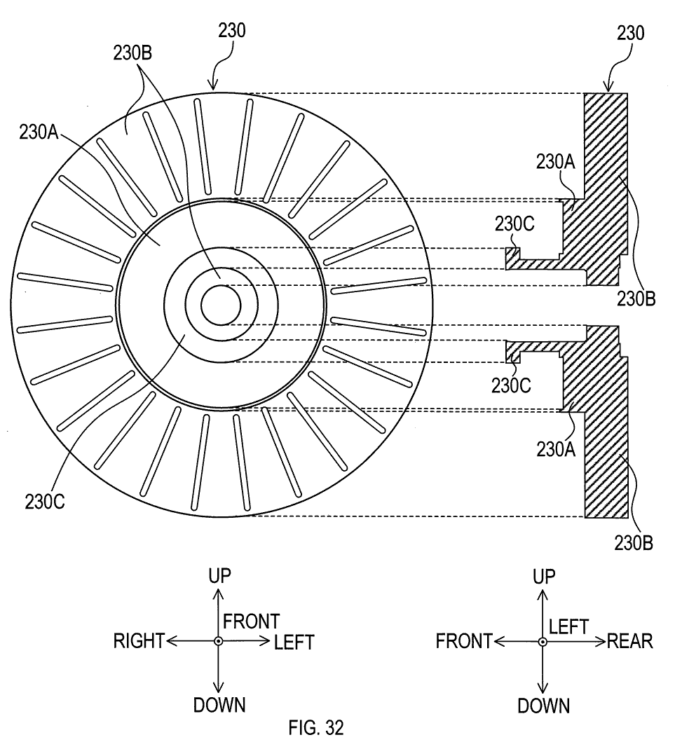

As shown in FIG. 31 and FIG. 32, the resin fixing portion 230 includes a fixing part 230A, a fan part 230B, and a shaft fixing part 230C. The fixing part 230A, the fan part 230B, and the shaft fixing part 230C are integrally molded using resin.

The fixing part 230A substantially corresponds to the resin fixing portion 43 of the first embodiment. The fan part 230B has a shape similar to the fan 55 of the first embodiment and functions as a fan. The shaft fixing part 230C has a tubular shape. The rotor shaft 50 is inserted into and fixed to an inner surface (or inner wall) of the shaft fixing part 230C. The rotor core 41 is inserted over and fixed to an outer surface of the shaft fixing part 230C.

### 2-8. Eighth Embodiment

### 2-8-1. Outline of Rotor Assembly

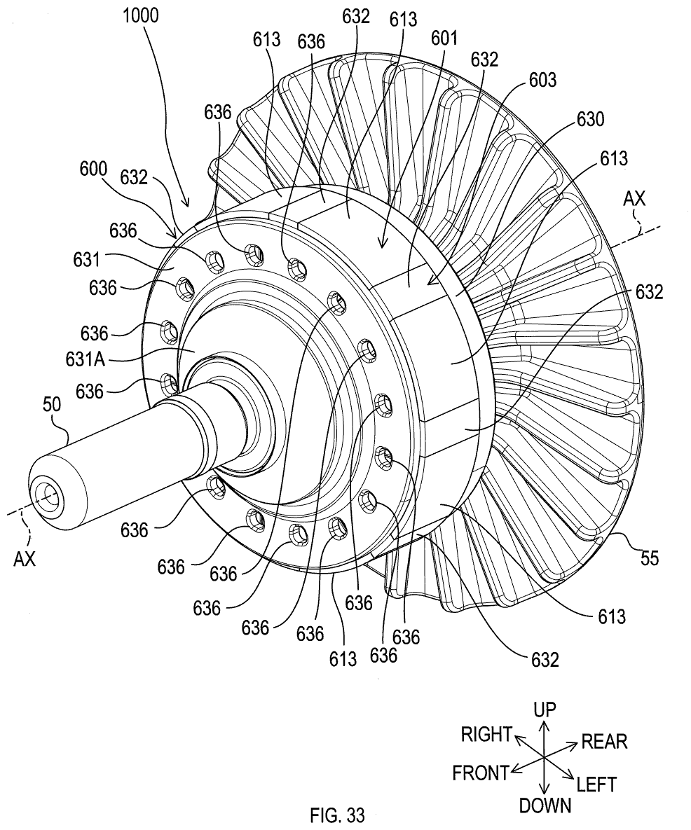

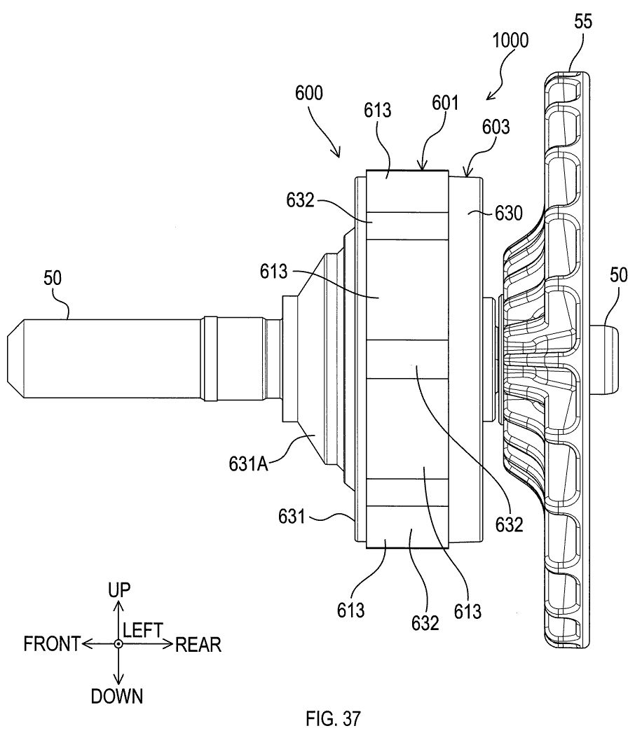

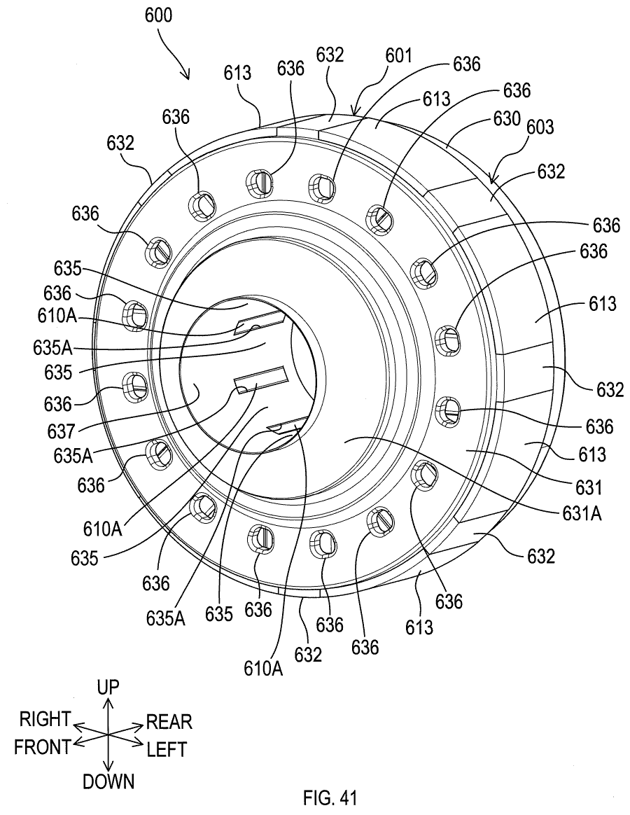

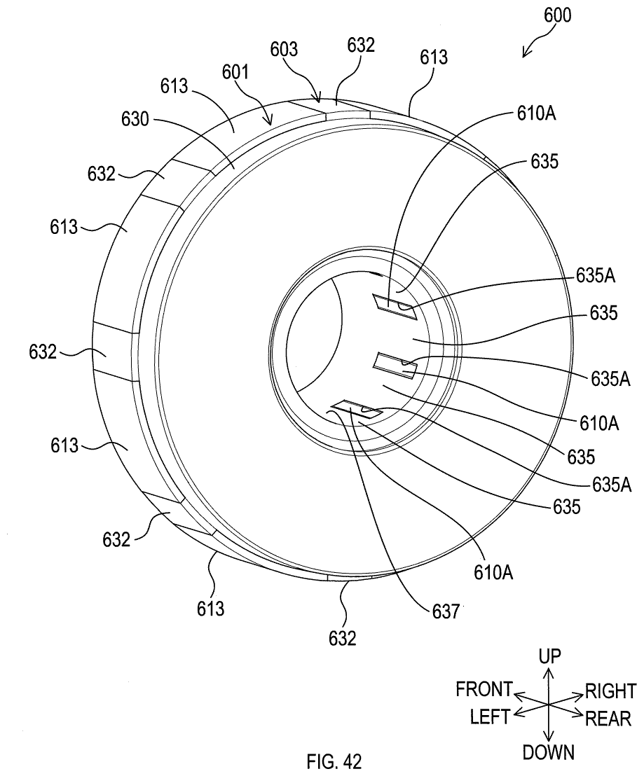

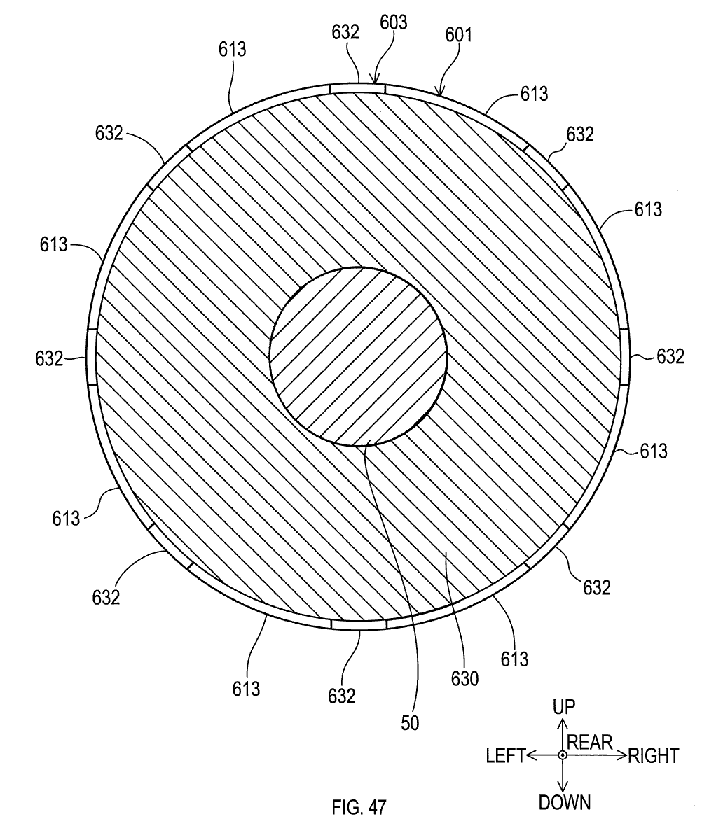

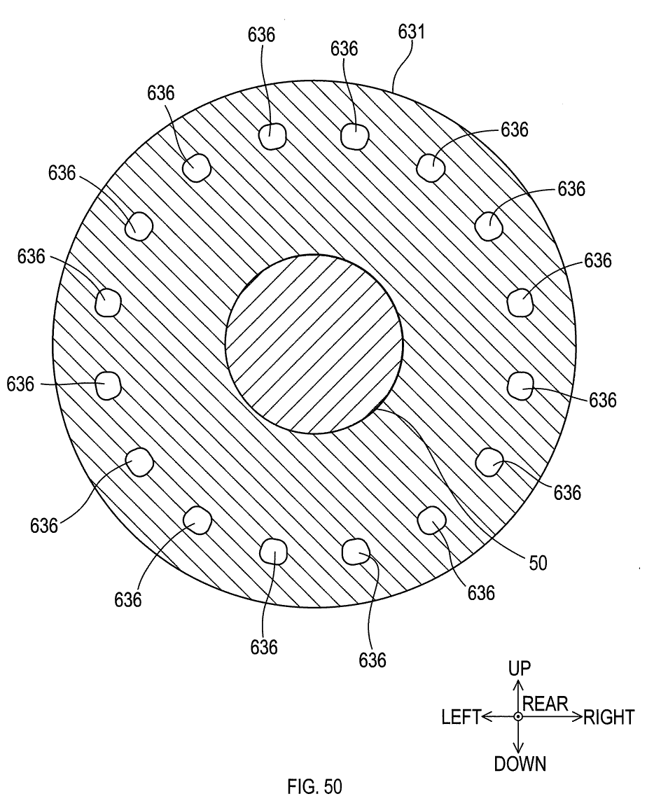

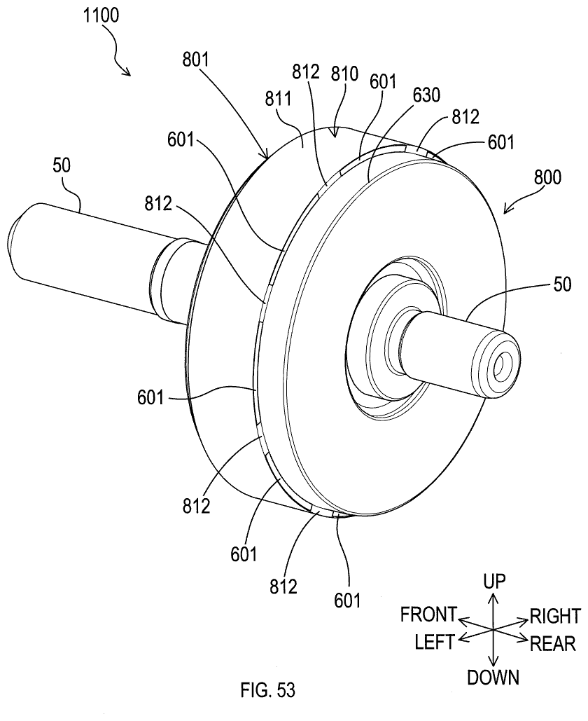

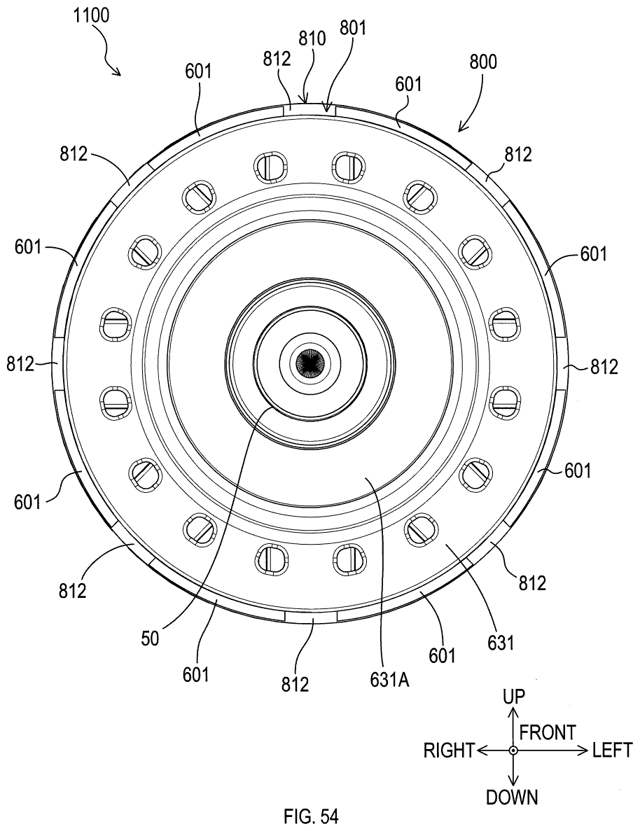

An eighth embodiment will be described with reference to FIG. 33 to FIG. 56. The eighth embodiment provides an example of a rotor with a different configuration. Main differences between a rotor 600 of the eighth embodiment, which is shown in FIG. 33 to FIG. 42, and the rotor 40 of the first embodiment, which is shown in FIG. 3 and other figures, are a configuration of the resin fixing portion and a shape of an inner surface (or inner wall) of the center hole of the rotor core. The same components as those of the first embodiment are denoted by the same reference numerals as those of the first embodiment, and the detailed description is omitted.

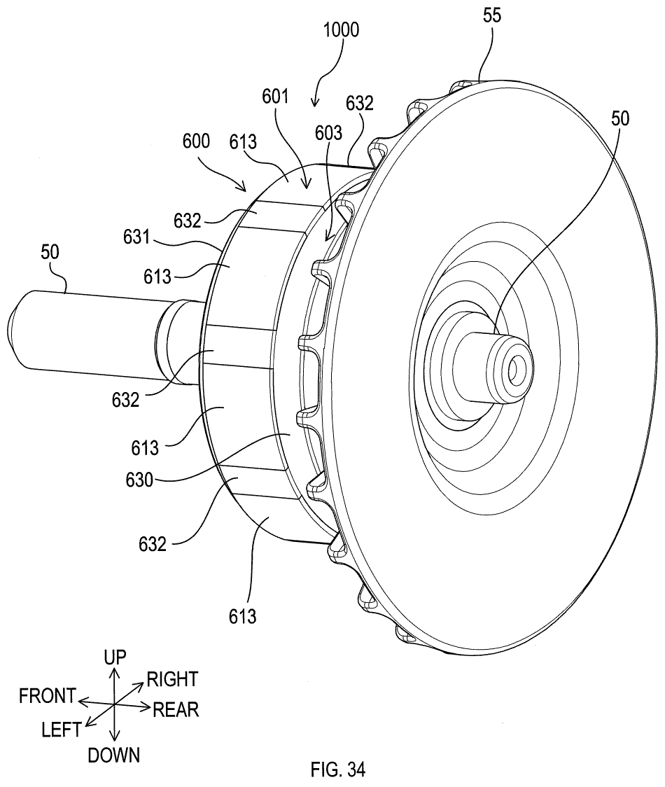

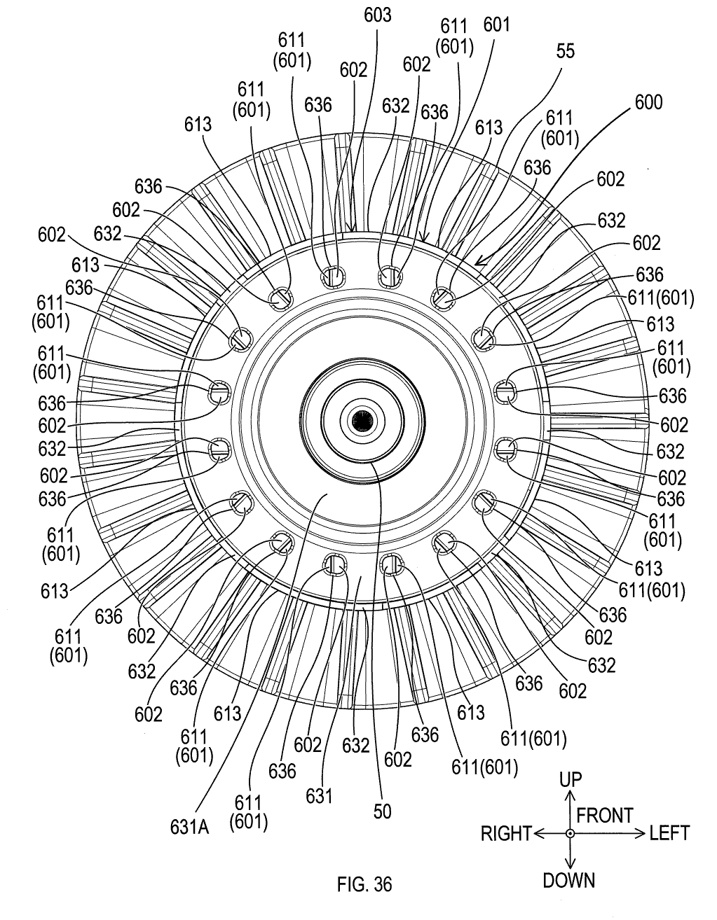

FIG. 33 to FIG. 39 illustrate a rotor assembly 1000. The rotor assembly 1000 includes the rotor 600 and the rotor shaft 50 assembled to the rotor 600. FIG. 33, FIG. 34, and FIG. 36 to FIG. 39 show a state in which the fan 55 is attached to the rotor assembly 1000.

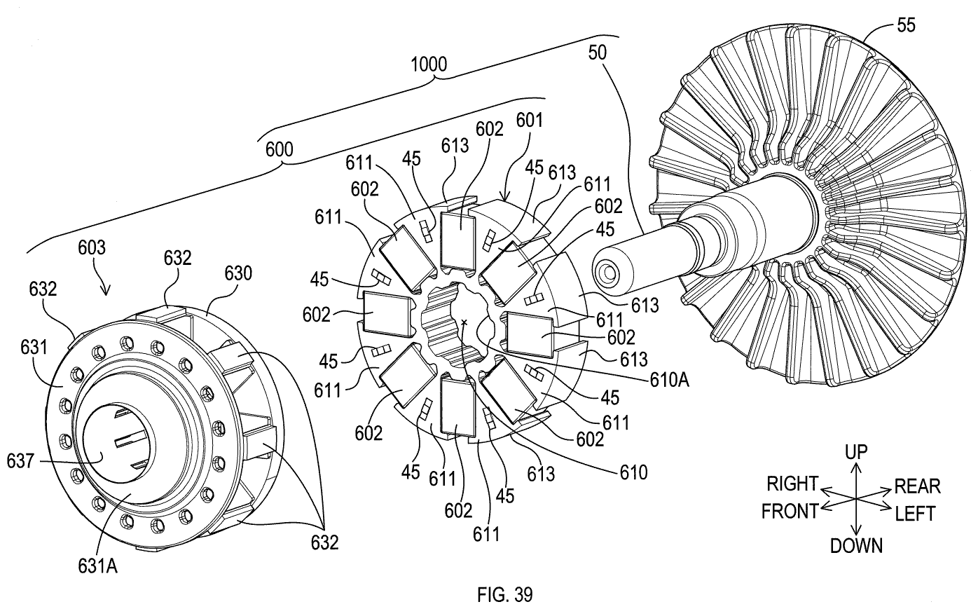

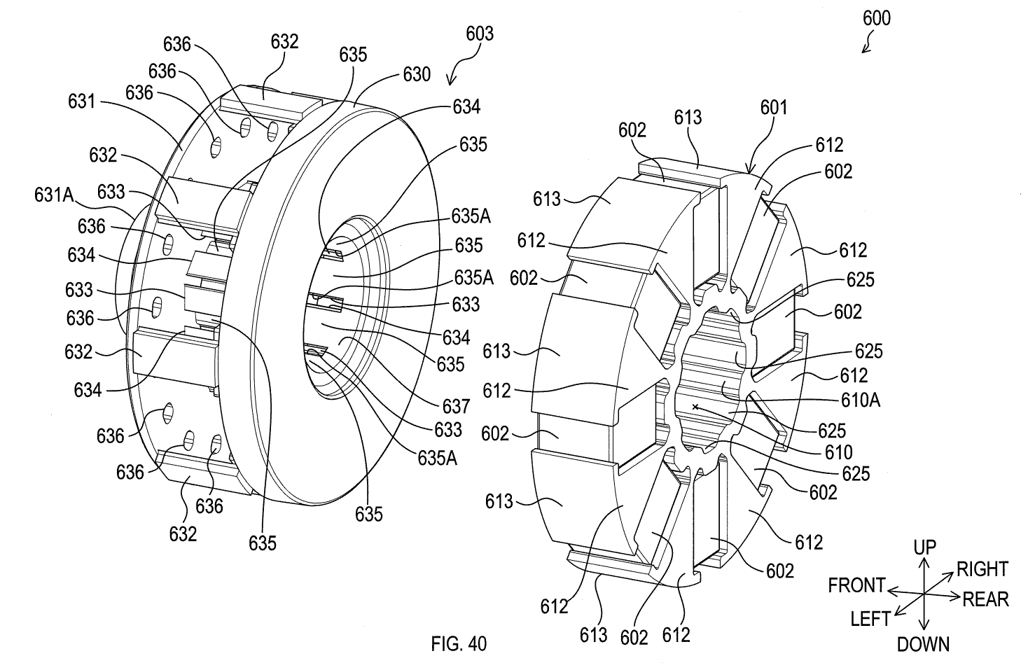

As shown in FIG. 33 to FIG. 42, the rotor 600 includes a rotor core 601. As shown in FIG. 39 and FIG. 40, the rotor core 601 includes a core center hole 610 passing therethrough in the axial direction. The rotor shaft 50 is inserted through the core center hole 610 and fixed to the rotor core 601. The core center hole 610 includes a core inner surface (or inner wall) 610A. In the eighth embodiment, a surface of the rotor shaft 50 is in contact with the core inner surface 610A (however, excluding two or more center through-spaces 625, which will be described below).

The rotor shaft 50 may be press-fitted into the core center hole 610, or may be in contact with the core inner surface 610A with no pressure (or almost no pressure) applied from the core inner surface 610A. Alternatively, an outer surface of the rotor shaft 50 may be spaced apart from the core inner surface 610A. In other words, an outer diameter of the rotor shaft 50 may be smaller than a diameter of the core center hole 610.

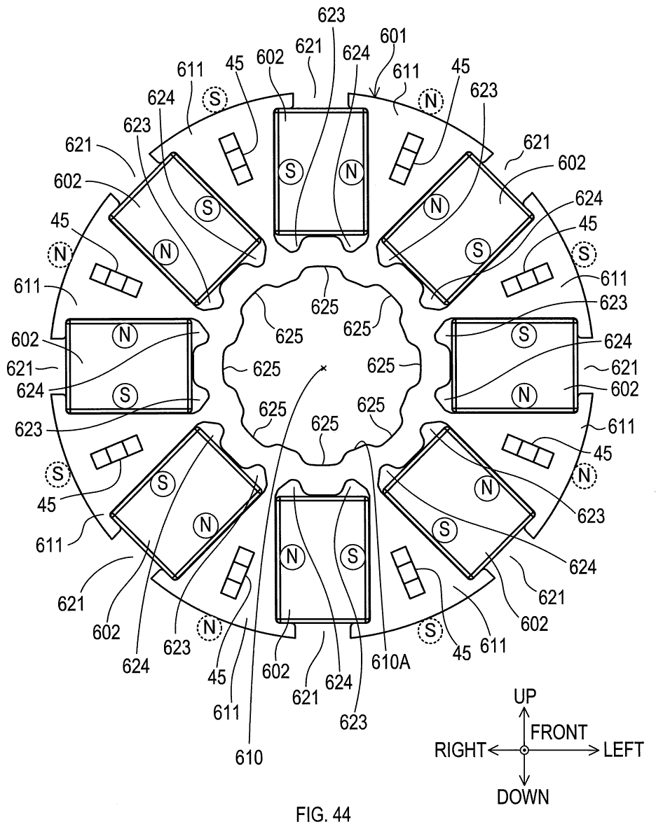

As shown in FIG. 33 to FIG. 37, and FIG. 39 to FIG. 42, the rotor core 601 has an outer-circumferential surface 613. The outer-circumferential surface 613 is formed as if it were notched (or has cutouts) at equal intervals along the circumferential direction. The notched portions (or cutouts) correspond to two or more openings 621 and two or more magnet insertion holes 620 (see FIG. 44 to FIG. 46), which will be described below.

As shown in FIG. 36 and FIG. 39, the rotor core 601 includes a first end face 611. The first end face 611 corresponds to a front end face of two end faces of the rotor core 601 that intersect the axial direction (in the present embodiment, that are perpendicular to the axial direction). As shown in FIG. 40, the rotor core 601 includes a second end face 612. The second end face 612 corresponds to a rear end face of the above-described two end faces of the rotor core 601.

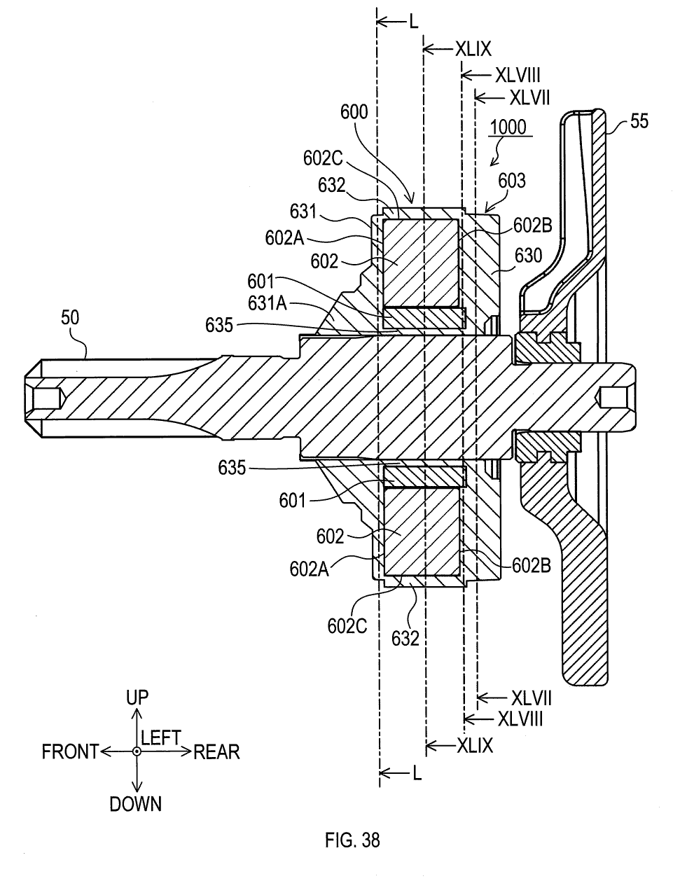

As shown in FIG. 36, and FIG. 38 to FIG. 40, the rotor 600 includes two or more permanent magnets 602. In the eighth embodiment, the permanent magnets 602 are arranged inside the rotor core 601.

Similarly to the permanent magnets 42 of the first embodiment, the permanent magnets 602 are in the form of a sintered magnet. The permanent magnets 602 are arranged at equal intervals in the circumferential direction of the rotor core 601. The permanent magnets 602 each are arranged in a corresponding one of the above-described notches in the outer-circumferential surface 613 of the rotor core 601.

As shown in FIG. 38, the permanent magnets 602 each has a first face 602A, a second face 602B, and a third face 602C. The first face 602A and the second face 602B intersect the axial direction (in the present embodiment, that are perpendicular to the axial direction). The first face 602A faces frontward, the second face 602B faces rearward, and the third face 602C faces radially outward.

As shown in FIG. 33 to FIG. 42, the rotor 600 includes a resin fixing portion 603. The resin fixing portion 603 fixes the permanent magnets 602, the rotor core 601, and the rotor shaft 50 integrally with each other. In the eighth embodiment, the rotor core 601, the permanent magnets 602, and the rotor shaft 50 are integrated via molding by the resin fixing portion 603. In other words, the rotor assembly 1000 is a single component that is integrally formed by insert molding, which will be described below.

The resin fixing portion 603 includes a first-end-face fixing part 631. One of the major differences from the resin fixing portion 43 of the first embodiment is that the resin fixing portion 603 includes the first-end-face fixing part 631. The first-end-face fixing part 631 covers the rotor core 601 and the permanent magnets 602 from front sides thereof.

The first-end-face fixing part 631 has a disc shape as a whole. However, the first-end-face fixing part 631 includes a central conical portion 631A near the center thereof. The central conical portion 631A has a conical (or truncated-cone like) shape. The rotor shaft 50 passes through the central conical portion 631A.

The first-end-face fixing part 631 includes two or more end-face through holes 636 arranged along the circumferential direction. The end-face through holes 636 pass through the first-end-face fixing part 631 in its front-rear direction. Thus, in the example shown in FIG. 36, the first end face 611 of the rotor core 601 and the respective permanent magnets 602 (specifically, the first face 602A; see FIG. 38) are partially exposed frontward through the end-face through holes 636.

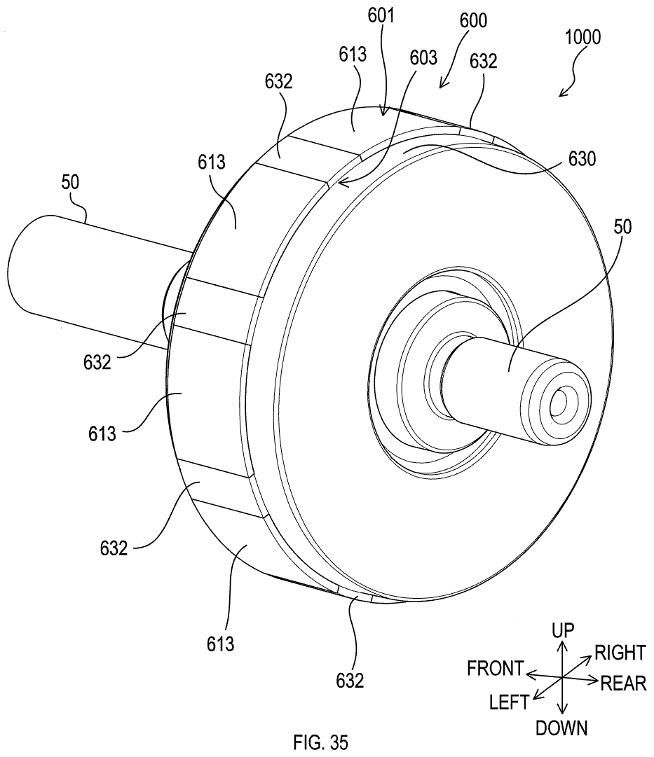

The resin fixing portion 603 includes a second-end-face fixing part 630. The second-end-face fixing part 630 covers rotor core 601 and two or more permanent magnets 602 covers from their rear sides. As shown in FIG. 35 and FIG. 38, in the eighth embodiment, the second face 602B (see FIG. 38) of each of the permanent magnets 602 is at least partially covered (in the eighth embodiment, completely) with the second-end-face fixing part 630. Also, as shown in FIG. 35, the second-end-face fixing part 630 covers almost the entirety of the second end face 612 of the rotor core 601.

As shown in FIG. 39 to FIG. 43, the resin fixing portion 603 includes a resin center hole 637. The resin center hole 637 passes through the resin fixing portion 603 in the axial direction. The center axis of the resin center hole 637 coincides with the rotational axis AX. The rotor shaft 50 passes through the resin center hole 637.

As shown in FIG. 40 to FIG. 42, the resin fixing portion 603 includes two or more inner holes 635A on an inner surface (or inner wall) of the resin center hole 637.

As shown in FIG. 33 to FIG. 43, the resin fixing portion 603 includes two or more outer-circumference fixing parts 632. The outer-circumference fixing parts 632 are connected to (i) the first-end-face fixing part 631 at front end sides of the outer-circumference fixing parts 632, and (ii) the second-end-face fixing part 630 at rear end sides of the outer-circumference fixing parts 632. The outer-circumference fixing parts 632 cover the above-described notched locations (i.e., the openings 621) in the outer-circumferential surface 613 of the rotor core 601.

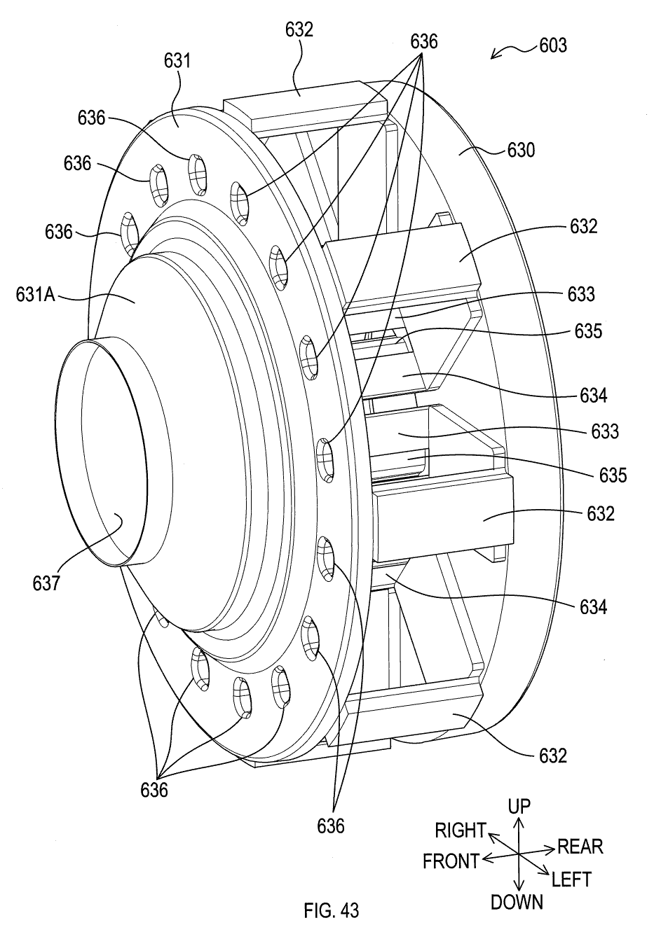

The resin fixing portion 603 includes additional fixing parts. Specifically, the resin fixing portion 603 of the eighth embodiment includes two or more first intermediate-fixing parts 633, two or more second intermediate-fixing parts 634, and two or more center-fixing parts 635, as shown in part in FIG. 40 and FIG. 43.

The first-end-face fixing part 631 is connected to the second-end-face fixing part 630 via the first intermediate-fixing parts 633, the second intermediate-fixing parts 634, and the center-fixing parts 635. Details of these fixing parts will be described below. In the resin center hole 637, the inner holes 635A and the center-fixing parts 635 are alternately arranged along the circumferential direction.

The rotor shaft 50 is fixed to the rotor core 601 (and thus, the rotor 600) while being inserted through the core center hole 610 of the rotor core 601 and the resin center hole 637 of the resin fixing portion 603.

The rotor shaft 50 may be, for example, press-fitted into the rotor core 601 and thereby fixed to the rotor core 601. Alternatively, the rotor shaft 50 may be simply in contact with the core inner surface 610A without being press-fitted into the rotor core 601. Alternatively, for example, the rotor shaft 50 may be spaced apart from the core inner surface 610A without being in contact with the core inner surface 610A.

### 2-8-2. Detailed Configuration of Rotor

A configuration of the rotor 600 will be described in more detail, with reference mainly to FIG. 44 to FIG. 50, and as necessary, with reference to FIG. 33 to FIG. 43.

As described above, the rotor 600 includes the rotor core 601, the permanent magnets 602, and the resin fixing portion 603. As shown in FIG. 44, the rotor 600 in the present embodiment includes eight magnetic poles along its outer circumference. In order for the rotor 600 to have the eight magnetic poles, the permanent magnets 602 in the present embodiment include eight permanent magnets 602.

Similarly to the first embodiment shown in FIG. 16 and FIG. 17, the rotor core 601 includes two or more core sheets (not shown) that are laminated in the axial direction. The present embodiment is similar to the first embodiment in the material of each core sheet, in that the protrusion 45 is formed on the first face of each core sheet, and the recess (not shown) formed in the second face of each core sheet. Also, similarly to the first embodiment, the protrusion 45 of one of the two core sheets axially facing each other is fitted into the recess of the other of the two core sheets.

The resin fixing portion 603 contains resin. The resin fixing portion 603 may have the same material as the resin fixing portion 43 of the first embodiment, or may have a different material from that of the resin fixing portion 43 of the first embodiment.

Each of the permanent magnets 602 has a substantially rectangular parallelepiped shape. The permanent magnets 602 extend along the radial direction. In other words, similarly to in the permanent magnets 42 of the first embodiment, the permanent magnets 602 are arranged in the form of spoke (in other words, radially).

As shown in FIG. 44, similarly to the permanent magnets 42 of the first embodiment, the permanent magnets 602 are arranged such that like poles thereof face each other along the circumferential direction. Accordingly, similarly to the first embodiment, the north pole and the south pole are alternately arranged along the circumferential direction on the outer-circumferential surface 613 of the rotor core 601.

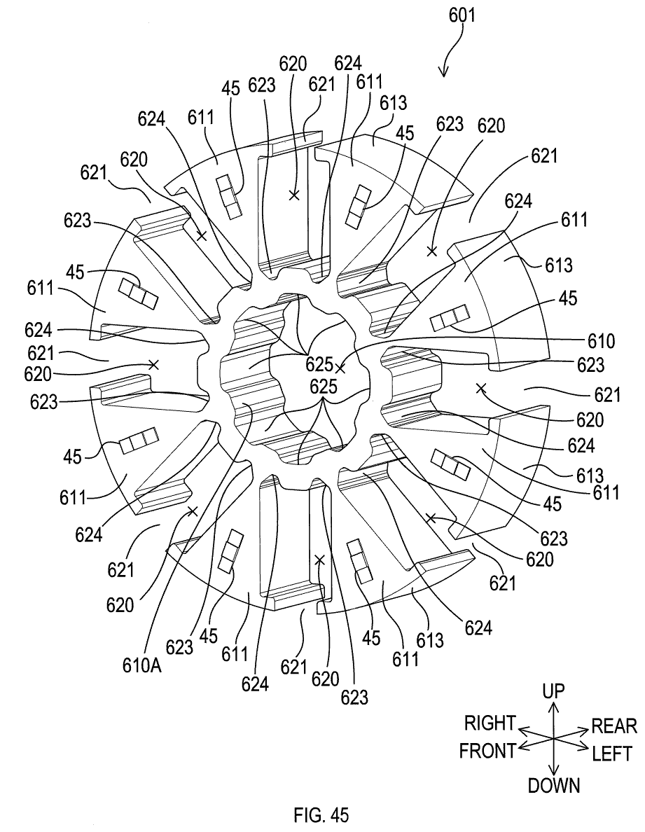

As shown in FIG. 44 to FIG. 46, the rotor core 601 includes the above-described core center hole 610. In addition, the rotor core 601 includes the above-described first end face 611 (FIG. 36, FIG. 39, and FIG. 44 to FIG. 46), the above-described second end face 612 (FIG. 40), and the above-described outer-circumferential surface 613 (FIG. 33 to FIG. 37, FIG. 39 to FIG. 42, and FIG. 45).

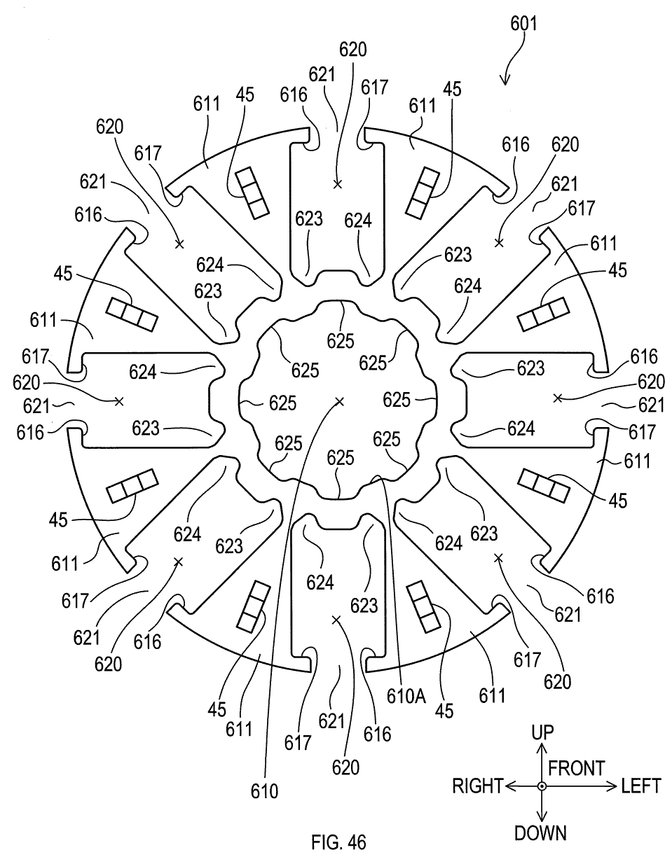

As shown in FIG. 45 and FIG. 46, the rotor core 601 includes the magnet insertion holes 620. The magnet insertion holes 620 are spaced apart from each other (in the present embodiment, at equal intervals) along the circumferential direction. The magnet insertion holes 620 of the eighth embodiment are composed of eight magnet insertion holes 620. The permanent magnets 602 are inserted into the respective magnet insertion holes 620.

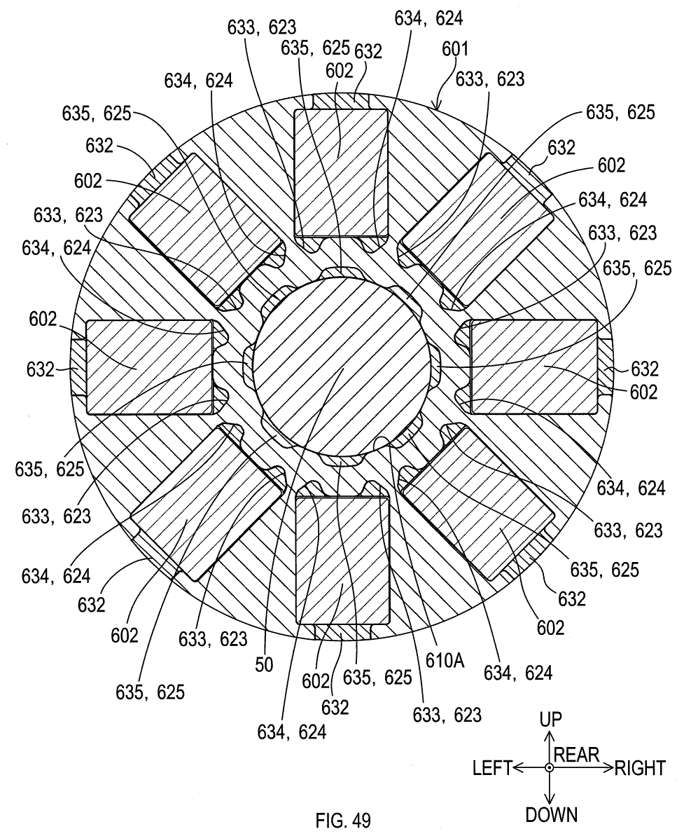

FIG. 36 to FIG. 42, FIG. 44, and FIG. 49 show a state in which the permanent magnets 602 are inserted into the respective magnet insertion holes 620. In the eighth embodiment, at least a portion (in the eighth embodiment, the entirety) of each first face 602A and at least a portion (in the eighth embodiment, the entirety) of the first end face 611 of the rotor core 601 are coplanar.

In contrast, as shown in FIG. 38 to FIG. 40 and FIG. 48, each of the second faces 602B is positioned forward of the second end face 612 of the rotor core 601. In other words, each magnet insertion hole 620 of the rotor core 601 is not fully filled with a corresponding permanent magnet 602 and has a space in which the permanent magnet 602 is not present. This space is to be filled with a portion of the second-end-face fixing part 630.

As shown in FIG. 44 to FIG. 46, the rotor core 601 includes the above-described openings 621. The openings 621 are spaced apart from each other on the outer-circumferential surface 613 of the rotor core 601 along the circumferential direction. In other words, as described above, the outer-circumferential surface 613 of the rotor core 601 is formed as if it were notched (or has cutouts) along the circumferential direction at specific intervals, and the notched locations correspond to the openings 621.

The openings 621 each are continuous with a corresponding one of the magnet insertion holes 620. This allows each magnet insertion hole 620 to be exposed in the radial direction through the corresponding opening 621. However, in the eighth embodiment, the openings 621 are closed up by the resin fixing portion 603 (specifically, by the respective outer-circumference fixing parts 632), similarly to the first embodiment.

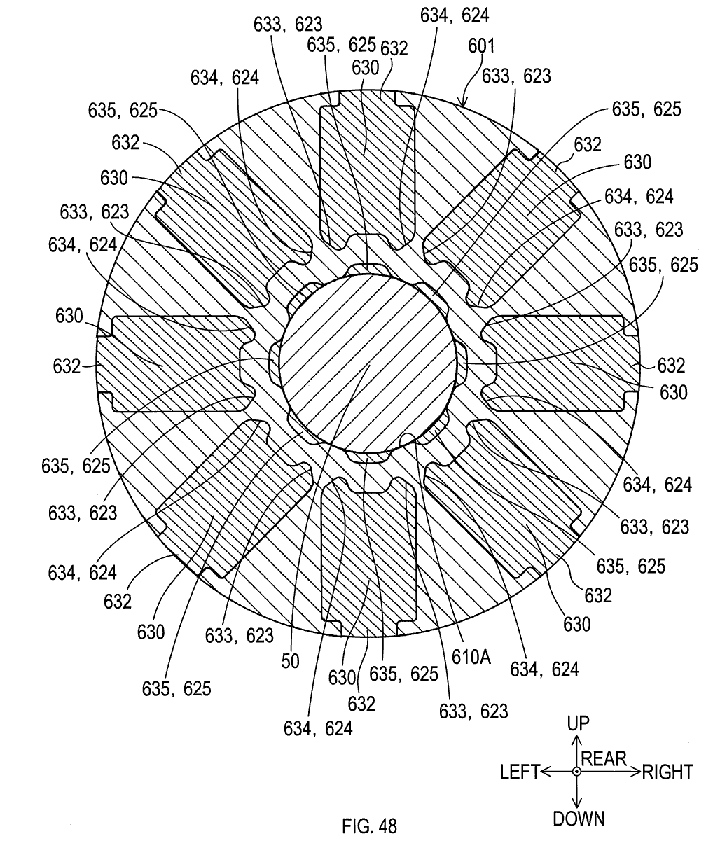

The magnet insertion holes 620 each include a first intermediate through-space 623 and a second intermediate through-space 624. The first intermediate through-space (or a first cavity) 623 and the second intermediate through-space (or a second cavity) 624 have the same configurations as (or similar configurations to) those of the first intermediate through-space 421 and the second intermediate through-space 422 of the first embodiment, respectively. Similarly to the first embodiment, the first intermediate through-space 623 and the second intermediate through-space 624 are filled with resin in a molding process for the resin fixing portion 603. Accordingly, as shown in FIG. 48 and FIG. 49, a first intermediate-fixing part 633 is formed in the first intermediate through-space 623, and a second intermediate-fixing part 634 is formed in the second intermediate through-space 624. Each of the openings 621 also functions as a cavity. In other words, in the process of forming the resin fixing portion 603, the openings 621 are also filled with resin, thereby forming the outer-circumference fixing parts 632.

As shown in FIG. 44 to FIG. 46, in the eighth embodiment, at least one cavity is formed on the core inner surface 610A of the rotor core 601. Specifically, in the eighth embodiment, eight recesses 625 are provided, simply as one example. Each of the eight recesses 625 is to be filled with resin as described below. Thus, hereinafter, each of the eight recesses 625 is referred to as a center through-space (or a center cavity) 625. Since the eight center through-spaces 625 are also filled with resin in the process of forming the resin fixing portion 603, as shown in FIG. 48 and FIG. 49, center-fixing parts 635 are formed in the respective center through-spaces 625.

In the magnet insertion holes 620, at least the first intermediate through-spaces 623, the second intermediate through-spaces 624, and the openings 621 are filled with liquid resin and cured (or hardened), and the resin is adhered to and bonded to the inner surfaces of the magnet insertion holes 620 and the permanent magnets 602. Accordingly, each of the permanent magnets 602 is more firmly fixed to, and integrally with, the corresponding magnet insertion hole 620 by the resin fixing portion 603, and thus is more firmly fixed to and integrally with the rotor core 601.

In particular, as shown in FIG. 46 with reference numerals, the rotor core 601 includes two or more first restrictors 616 and two or more second restrictors 617, similarly to the first embodiment. A pair of a first restrictor 616 and a second restrictor 617 forms a single opening 621. This restricts each of the permanent magnets 602 from radially moving through a corresponding one of the magnet insertion holes 620 (and thus, from being removed from the rotor core 601).

As also shown in FIG. 43 to FIG. 50 in addition to FIG. 33 to FIG. 42, the resin fixing portion 603 includes the first-end-face fixing part 631, the second-end-face fixing part 630, the first intermediate-fixing parts 633, the second intermediate-fixing parts 634, the center-fixing parts 635, and the outer-circumference fixing parts 632.

In particular, as shown in FIG. 48 and FIG. 49, the first intermediate-fixing parts 633 are formed by curing the resin filled in the first intermediate through-spaces 623. The second intermediate-fixing parts 634 are formed by curing the resin filled in the second intermediate through-spaces 624. The outer-circumference fixing parts 632 are formed by curing the resin filled in the openings 621.

The first intermediate-fixing parts 633 may be provided in any number. The second intermediate-fixing parts 634 may be provided in any number. The center-fixing parts 635 may be provided in any number. The outer-circumference fixing parts 632 may be provided in any number. The resin fixing portion 603 may omit at least one of the first-end-face fixing part 631, the second-end-face fixing part 630, the first intermediate-fixing parts 633, the second intermediate-fixing parts 634, the center-fixing parts 635, or the outer-circumference fixing parts 632.

### 2-8-3. Integrally Forming of Rotor Assembly

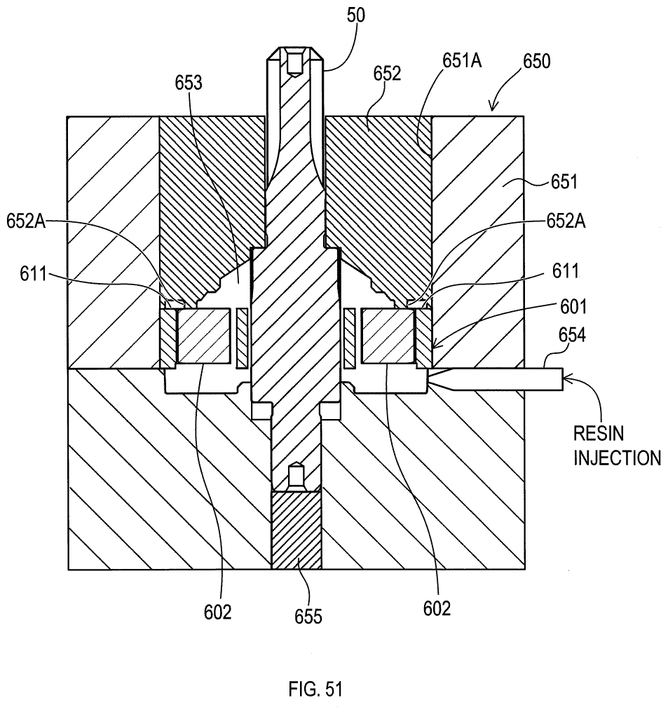

The rotor assembly 1000 may be integrally formed in any manner. In the eighth embodiment, the rotor assembly 1000 is integrally formed by, for example, insert molding. Simply as one example, the rotor assembly 1000 may be integrally formed using a molding device 650 shown in FIG. 51.

The molding device 650 includes a lower mold 651 and an upper mold 652.

The lower mold 651 has a mold fitting hole 651A formed on its upper surface. The upper mold 652 can be inserted into the mold fitting hole 651A. The lower mold 651 includes a resin injection port 654 on its side surface. The resin injection port 654 is provided for injecting resin from outside the lower mold 651 into the mold fitting hole 651A.

When the rotor assembly 1000 is formed, first, as shown in FIG. 51, the rotor core 601, the permanent magnets 602, and the rotor shaft 50 are each set in a specific position in the mold fitting hole 651A. The rotor shaft 50 is supported from its lower surface by a support portion 655 inserted into the lower mold 651. The support portion 655 is movable in up-down directions using, for example, a hydraulic mechanism (not shown). A relative position of the rotor shaft 50 with respect to the rotor core 601 in the axial direction can be adjusted with the support portion 655. The permanent magnets 602 each are arranged in a corresponding one of the magnet insertion holes 620 in the rotor core 601.

Next, the upper mold 652 is inserted into the mold fitting hole 651A. The upper mold 652 includes a shaft insertion hole passing therethrough in the up-down directions. The upper mold 652 is inserted into the mold fitting hole 651A while the rotor shaft 50 passes through the shaft insertion hole. It should be noted that the upper mold 652 may be first set, followed by the rotor shaft 50.

The upper mold 652 is inserted into a specific set position. FIG. 51 shows a state in which the upper mold 652 is inserted to be in the set position. Insertion of the upper mold 652 to be in the set position causes a lower end of the upper mold 652 to come into contact with the first end face 611 of the rotor core 601, and this configuration restricts further insertion of the upper mold 652.

The upper mold 652 includes, at its lower end, two or more pressing protrusions 652A. The pressing protrusions 652A are arranged in an annular manner along the circumferential direction. When the upper mold 652 is inserted to be in the set position, the lower ends of the pressing protrusions 652A come into contact with the respective permanent magnets 602. This inhibits or prevents the permanent magnets 602 from being ejected beyond the first end face 611 of the rotor core 601 due to pressure from the resin, during molding. In other words, the pressing protrusions 652A are provided to maintain outer surfaces of the permanent magnets 602 to be aligned with the first end face 611 of the rotor core 601.

When the upper mold 652 is inserted to be in the set position, a cavity 653 (i.e., a space where no physical object is present) is formed in the mold fitting hole 651A.

Next, melted resin is injected into the cavity 653 from the resin injection port 654. The resin fills most or the entirety of the cavity 653. Accordingly, the resin also fills the first intermediate through-spaces 623, the second intermediate through-spaces 624, and the center through-spaces 625.

After the resin fills the cavity 653 in this way, the resin is cured. Accordingly, the molding of the rotor assembly 1000 is completed. The resin filled in the cavity 653 is cured, thereby forming the resin fixing portion 603. Such integral molding causes the rotor core 601, the permanent magnets 602, and the rotor shaft 50 to be firmly fixed to each other in close contact via the resin fixing portion 603. The end-face through holes 636 in the resin fixing portion 603 are formed by the pressing protrusions 652A in the upper mold 652.

### 2-8-4. Technical Effects of Eighth Embodiment

In addition to having basically the same effects as those of the first embodiment, the eighth embodiment also has the following technical effects.

Specifically, in the eighth embodiment, the rotor core 601, the permanent magnets 602, and the rotor shaft 50 are integrated via molding with resin. The strength and durability of the entire rotor assembly 1000 can be thus increased.

Also, the resin fixing portion 603 further includes the first-end-face fixing part 631, in addition to the second-end-face fixing part 630 corresponding to the end-face fixing part 430 of the first embodiment. This configuration enables the rotor core 601, the permanent magnets 602, and the resin fixing portion 603 to be more firmly integrated with each other.

### 2-9. Ninth Embodiment

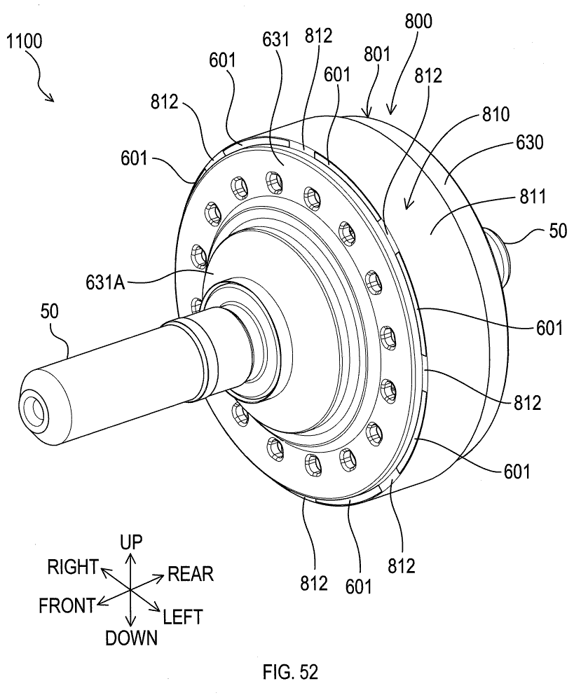

A ninth embodiment provides an example of a rotor assembly with a different configuration. As shown in FIG. 52 to FIG. 54, a rotor assembly 1100 of the ninth embodiment differs in a shape of part of a resin fixing portion, as compared with the rotor assembly 1000 of the eighth embodiment. In FIG. 52 to FIG. 54, the same components as those in the first and eighth embodiments are denoted by the same reference numerals as those in the first and eighth embodiments.

The rotor assembly 1100 of the ninth embodiment includes a rotor 800. Similarly to the eighth embodiment, the rotor 800 includes the rotor core 601 and the permanent magnets 602 (not shown).

The rotor 800 further includes a resin fixing portion 801. The shape of the resin fixing portion 801 is partially different from the resin fixing portion 603 of the eighth embodiment. Specifically, similarly to the eighth embodiment, the resin fixing portion 801 includes the first-end-face fixing part 631, the second-end-face fixing part 630, the first intermediate-fixing parts 633, the second intermediate-fixing parts 634, and the center-fixing parts 635.

The resin fixing portion 801 further includes an annular fixing part 810. The annular fixing part 810 is a different point from the eighth embodiment. The annular fixing part 810 includes an annular cover 811 and two or more core-embedment parts 812. The annular cover 811 is an annular portion that covers an entire outer circumference of the rotor core 601. The core-embedment parts 812 correspond to the outer-circumference fixing parts 632 of the eighth embodiment.

In other words, the resin fixing portion 801 in the ninth embodiment corresponds to the resin fixing portion 603 of the eighth embodiment to which the annular cover 811 is added. The annular cover 811 is also integrally formed as part of the resin fixing portion 801.

The annular cover 811 may be formed with intent using a molding device designed to form the annular cover 811.

In contrast, depending on the manufacturing method or the structure of the molding device, the annular cover 811 may be formed with no intent. In this case, the state in which the annular cover 811 is formed may be maintained with intent. Alternatively, an outer peripheral portion corresponding to the annular cover 811 may be removed using polishing or another method, thereby to embody the rotor assembly 1000 of the eighth embodiment.

### 2-10. Tenth Embodiment

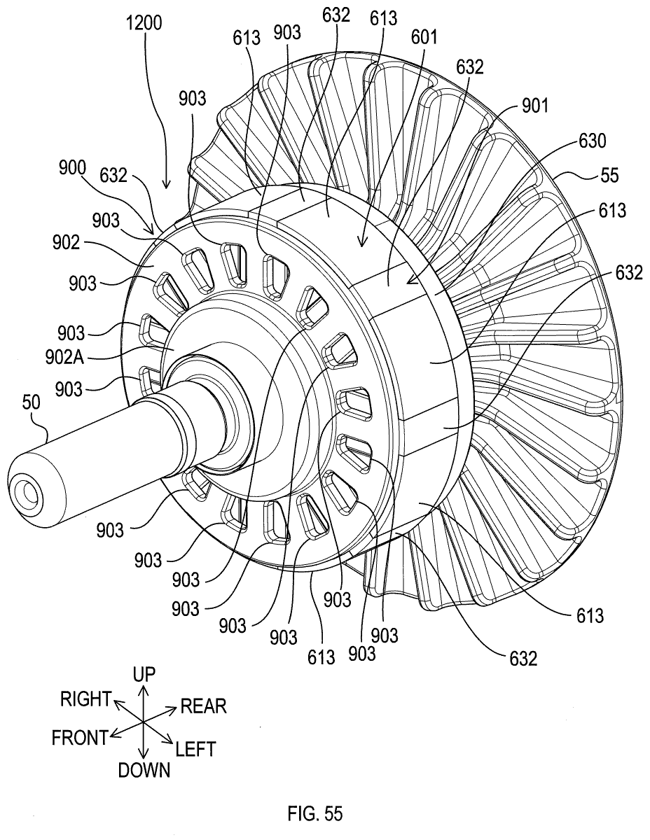

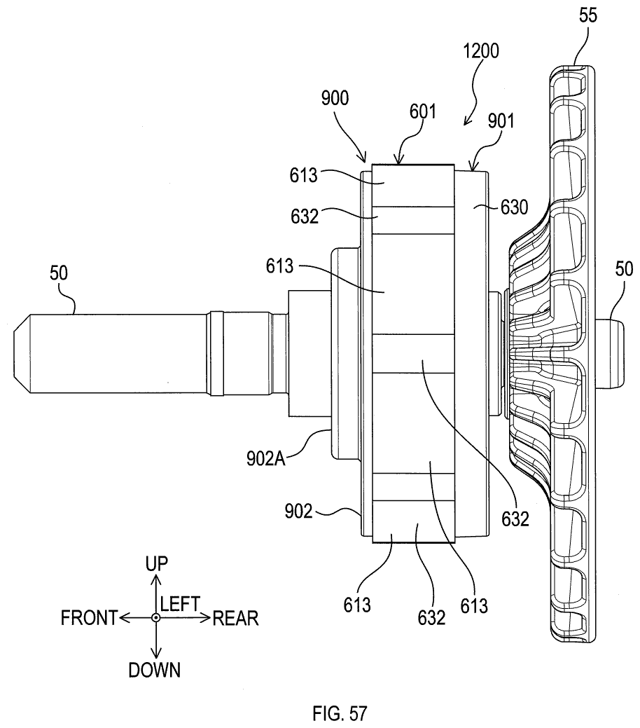

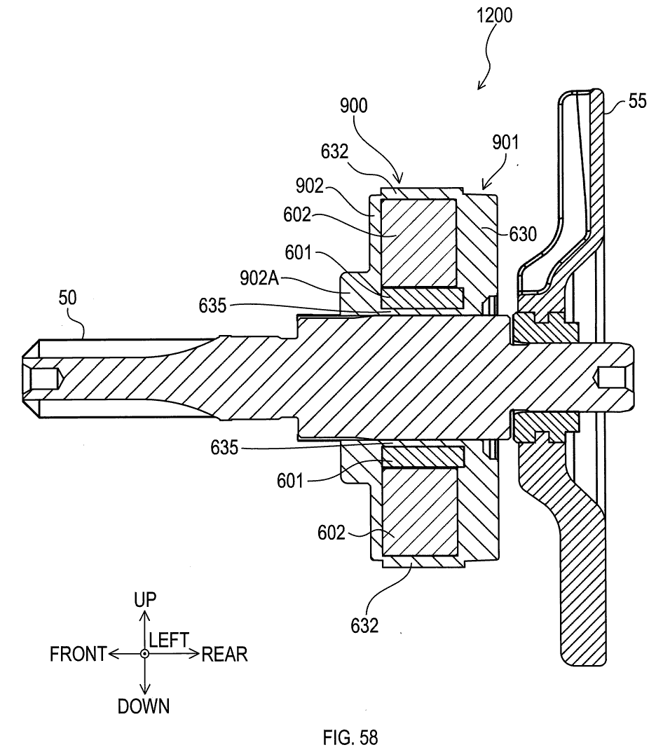

A tenth embodiment provides an example of a rotor assembly. As shown in FIG. 55 to FIG. 58, a rotor assembly 1200 of the tenth embodiment differs in a shape of part of a resin fixing portion, as compared with the rotor assembly 1000 of the eighth embodiment. In FIG. 55 to FIG. 58, the same components as those of the first and eighth embodiments are denoted by the same reference numerals as those in the first and eighth embodiments.

The rotor assembly 1200 of the tenth embodiment includes a rotor 900. Similarly to the eighth embodiment, the rotor 900 includes the rotor core 601 and the permanent magnets 602.

The rotor 900 further includes a resin fixing portion 901. Similarly to the eighth embodiment, the resin fixing portion 901 includes the second-end-face fixing part 630, the outer-circumference fixing parts 632, the first intermediate-fixing parts 633, the second intermediate-fixing parts 634, and the center-fixing parts 635.

The resin fixing portion 901 further includes a first-end-face fixing part 902. The shape of the first-end-face fixing part 902 slightly differs from the shape of the first-end-face fixing part 631 of the resin fixing portion 603 of the eighth embodiment.

Similarly to the first-end-face fixing part 631 of the eighth embodiment, the first-end-face fixing part 902 has a disc shape as a whole and includes, at its center, a central boss 902A. The central boss 902A differs from the central conical portion 631A of the eighth embodiment. The central conical portion 631A of the eighth embodiment has a conical shape (or truncated cone shape). However, the central boss 902A of the tenth embodiment has a columnar shape (specifically, cylindrical shape). Also, the volume of the central boss 902A is smaller than the volume of the central conical portion 631A of the eighth embodiment.

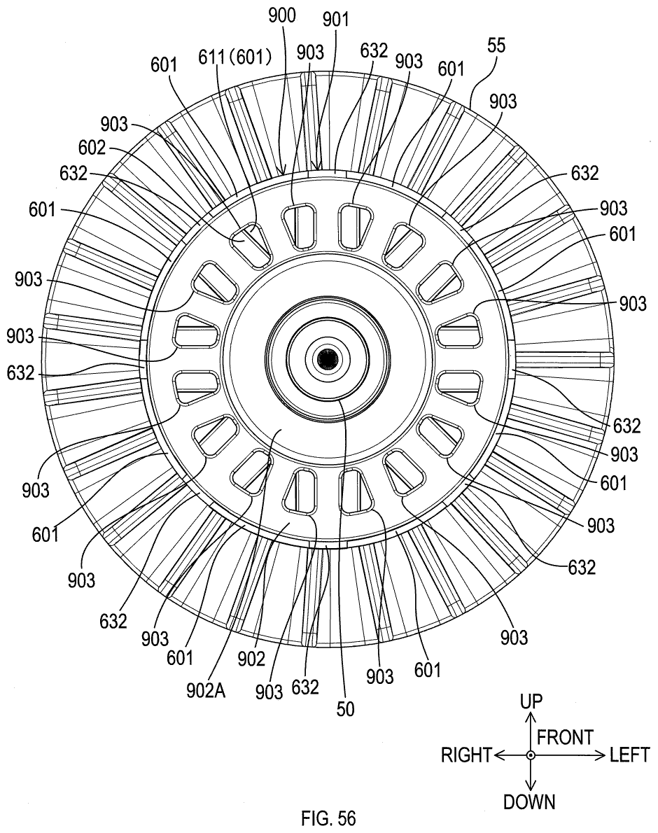

The first-end-face fixing part 902 of the tenth embodiment includes two or more end-face through holes 903, similarly to the eighth embodiment. However, as is clear from comparison between FIG. 56 and FIG. 36, the shape of the end-face through holes 903 of the tenth embodiment differs from that of the end-face through holes 636 of the eighth embodiment.

The resin fixing portion 901 of the tenth embodiment may include, in place of the end-face through holes 903, the end-face through holes 636 of the eighth embodiment. In contrast, the resin fixing portion 603 of the eighth embodiment may include the end-face through holes 903 of the tenth embodiment in place of the end-face through holes 636. In each of the eighth to tenth embodiments, the end-face through holes may have any shape and be provided in any number. In other words, the pressing protrusions 652A of the upper mold 652 may each have any shape and may be provided in any number.

### 2-11. Eleventh Embodiment

In an eleventh embodiment, an example of variations in the shape of a core-facing surface of a rotor shaft, which faces an inner surface (or inner wall) of the rotor core, will be described.

In each of the above-described embodiments, the core-facing surface of the rotor shaft 50 is basically a smooth curved surface. However, the core-facing surface may have a textured pattern. In other words, the core-facing surface may include protrusions, or may include grooves. Depending on the shape of protrusions, when protrusions are provided, a part between two adjacent protrusions may be naturally deemed as a groove. In contrast, depending on the shape of grooves, when grooves are provided, a part between two adjacent grooves may be deemed as a protrusion.

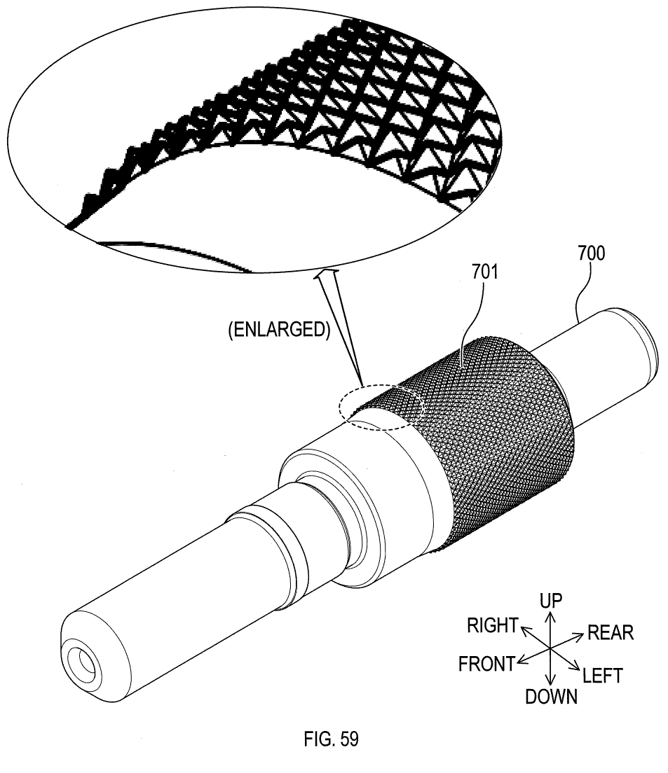

A rotor shaft 700 shown in FIG. 59 includes a core-facing surface 701 having a textured pattern. More specifically, as is particularly clear from FIG. 59, a knurling process has been performed on the core-facing surface 701, thereby forming a knurled pattern. More specifically, a so-called diamond knurling process has been performed in FIG. 59. The core-facing surface 701 may have undergone a knurling process that produces a pattern other than the diamond knurling pattern. Additionally, polishing may be performed on the surface on which the knurling process has been performed. Polishing the surface after the knurling process can inhibit (or eliminate) misalignment between the center axis of the rotor core and the center axis of the rotor shaft.

The core-facing surface 701 undergoes the knurling process in this manner (i.e., has a knurled pattern), and thus resin can fill small spaces radially created by knurling processing. This enables the rotor shaft 700 to be more firmly fixed to the rotor core.

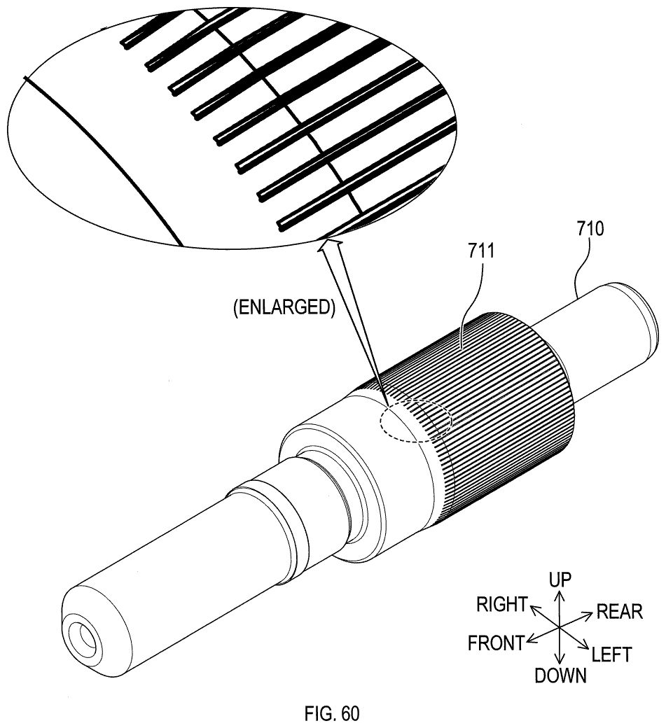

The rotor shaft 710 shown in FIG. 60 includes a core-facing surface 711 having a textured pattern. More specifically, as is particularly clear from FIG. 60, two or more grooves are formed on the core-facing surface 711 along the circumferential direction. Each of the grooves extends in the axial direction. The grooves are formed such that resin can fill the grooves during the integral molding. The thus-formed rotor shaft 710 allows resin to fill the grooves, and thereby the rotor shaft 710 can be more firmly fixed to the rotor core.

The grooves may be formed in any manner. For example, two or more grooves shown in FIG. 60 may be formed by performing a flat knurling process or another similar method, and then by polishing the surface. However, polishing does not have be necessary, and the rotor shaft that has undergone the straight knurling process, for example, may be inserted into the rotor core.

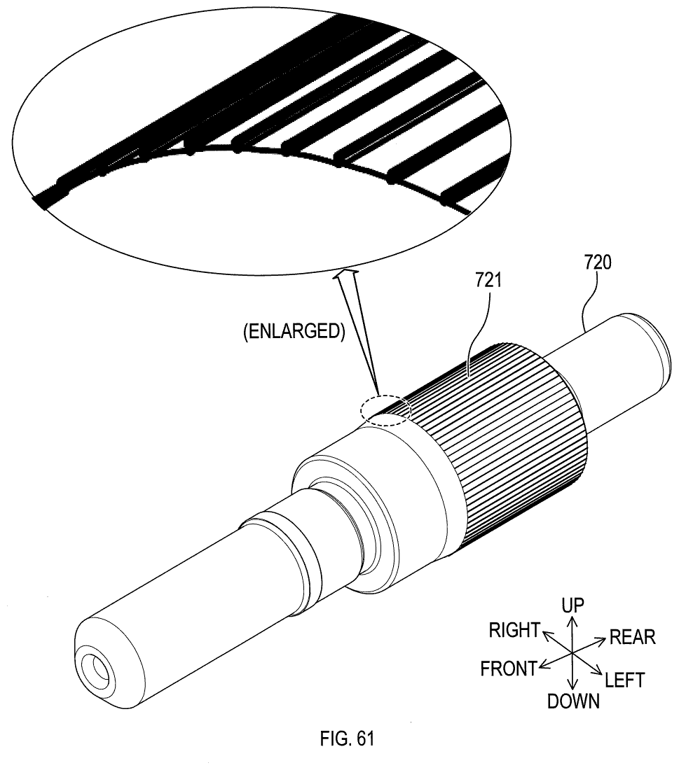

The rotor shaft 720 shown in FIG. 61 includes a core-facing surface 721 having a textured pattern. More specifically, as is particularly clear from FIG. 61, two or more ridges (or ribs) are formed on the core-facing surface 721 along the circumferential direction. Each of the two or more projections extends in the axial direction. The projections are formed such that resin may fill a space between two adjacent projections during the integral molding. Since the thus-formed rotor shaft 720 allows resin to fill a space between two projections, the rotor shaft 720 can be more firmly fixed to the rotor core.

The projections may be very small, to an extent that no resin fills a space therebetween. In other words, the projections may be provided for the purpose of inhibiting the rotor shaft 720 from rotating relative to the rotor core, assuming that the rotor shaft is press-fitted into the rotor core.

The rotor shaft 50 in the first to tenth embodiments and the rotor shafts 700, 710, 720 in the examples shown in FIG. 59 to FIG. 61 may be each combined with a rotor core having its center hole with any shape.

For example, the rotor shafts 50, 700, 710, 720 may each be combined with the rotor core 601 of the eighth embodiment. In this case, the core-facing surface of each of the rotor shafts 50, 700, 710, 720 may be in contact with the core inner surface 610A of the rotor core 601. In this case, the core-facing surface is not simply in contact with the core inner surface 610A but may be in contact with the core inner surface 610A so as to receive pressure from the core inner surface 610A. More specifically, each of the rotor shafts 50, 700, 710, 720 may, for example, be press-fitted into the corresponding core center hole 610, thereby being fixed to the rotor core 601.

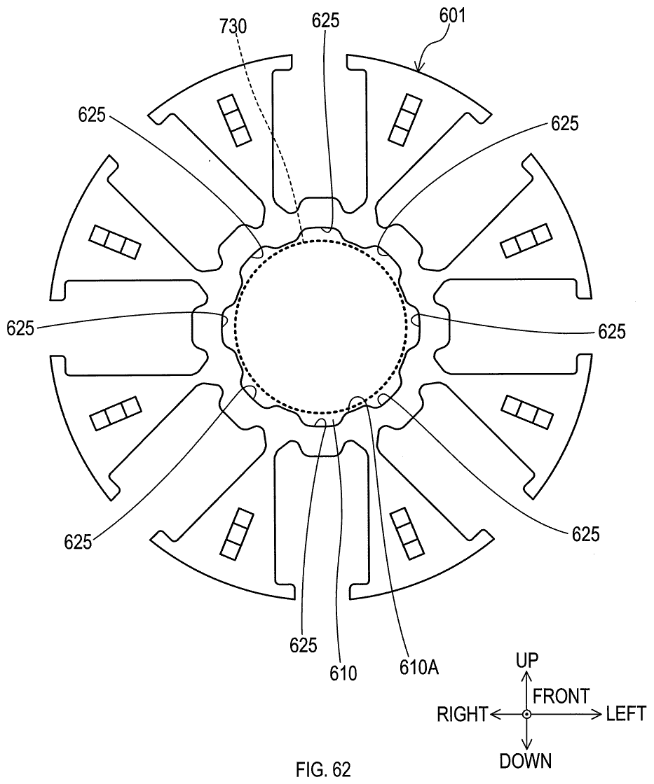

Alternatively, in the example shown in FIG. 62, the rotor shafts 50, 700, 710, 720 may each be arranged within a shaft arrangement area 730 shown in FIG. 62. In other words, the core-facing surfaces of the rotor shafts 50, 700, 710, 720 may each be spaced apart from the core inner surface 610A without being in contact with the core inner surface 610A. In this case, in addition to the center through-spaces 625, a gap between the core inner surface 610A and the rotor shaft is filled with resin.

For example, the rotor shafts 50, 700, 710, 720 may each be used in combination with the rotor core 41 of the first embodiment (see FIG. 7 to FIG. 9). In this case, the core-facing surfaces of the rotor shafts 50, 700, 710, 720 may each be in contact with an inner surface (or inner wall) of the center hole 410 of the rotor core 41. In this case, each of the core-facing surfaces is not simply in contact with the inner surface of the center hole 410 but may be in contact so as to receive pressure from the inner surface. More specifically, the rotor shafts 50, 700, 710, 720 may, for example, each be press-fitted into the center hole 410, thereby being fixed to the rotor core 41.

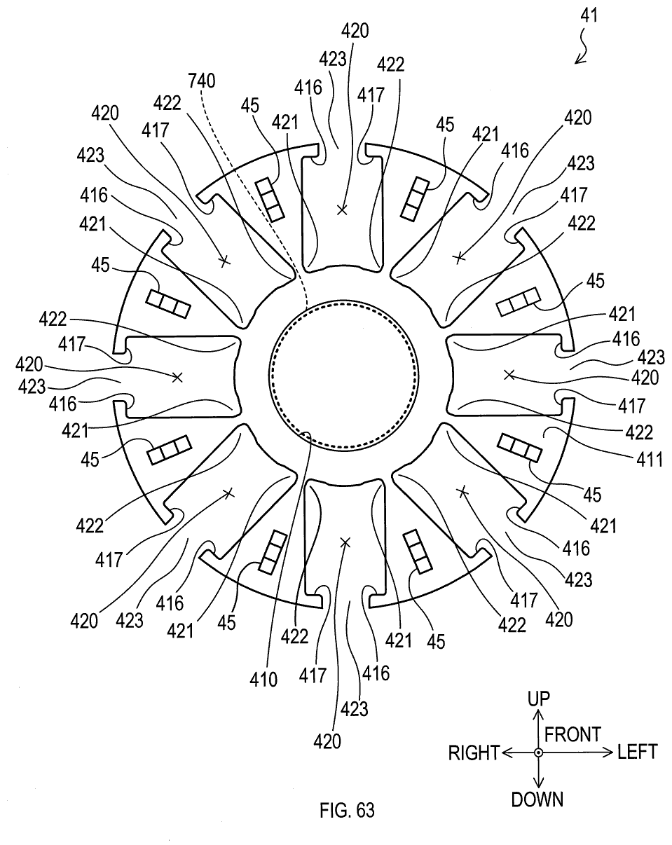

Alternatively, in the example shown in FIG. 63, the rotor shafts 50, 700, 710, 720 may each be arranged within a shaft arrangement area 740 in FIG. 63. In other words, the core-facing surfaces of the rotor shafts 50, 700, 710, 720 may each be spaced apart from the inner surface of the center hole 410 without being in contact with the inner surface. In this case, a gap between the inner surface of the center hole 410 and the rotor shaft is filled with resin.

### 2-12. Other Embodiments

Although the embodiments of the present disclosure are described above, the present disclosure can be implemented in variously modified manners without being limited to the above-described embodiments.

In the first embodiment, the rotor core 41 includes at least three cavities (the first intermediate through-space 421, the second intermediate through-space 422, and the opening 423) formed in one magnet insertion hole 420 (see FIG. 9).

However, any number of the cavities may be provided in one magnet insertion hole 420. For example, in the first embodiment, further one or more cavities may be provided, in addition to the first intermediate through-space 421, the second intermediate through-space 422, and the opening 423. Alternatively, any one of the first intermediate through-space 421, the second intermediate through-space 422, or the opening 423 may be omitted.

In the rotor, the resin fixing portion may be formed in any location and in any manner. In the first embodiment above, the first end face 411 of the rotor core 41 is not covered by the resin fixing portion 43. However, the first end face 411 may be at least partially covered by the resin fixing portion 43. In contrast, the second end face 412 does not have to be covered by the resin fixing portion 43.

The openings 423 of the rotor core 41 do not have to be covered by the resin fixing portion 43. In other words, the third face 42c of the permanent magnet 42 may be exposed radially outward via the opening 423. In contrast, the entire outer circumference of the rotor core 41, including the openings 423, may be covered by the resin fixing portion 43.

Each embodiment above provides an example of the brushless motor with eight magnetic poles and six slots. However, the present disclosure is also applicable to a brushless motor with numbers of magnetic poles other than eight, and/or to brushless motor with numbers of slots other than six.

The electric work machine 1 in the above-described embodiments is in the form of an electric impact driver. However, the electric work machine 1 may take any form other than the electric impact driver. Specifically, the electric work machine 1 may be any of various apparatuses in the form of apparatuses configured to be used at job sites (or work sites) such as building construction, manufacturing, gardening, civil engineering, and other work sites.

The electric work machine 1 may be configured to be driven by receiving AC power from an AC power source in place of or in addition to the battery pack 3.

In addition, the present disclosure is also applicable to an electric work machine to which a tool accessory is non-detachably fixed (or so as to be difficult to detach).

### 2-13. Supplemental Notes

Two or more functions of a single element in the embodiments may be performed by two or more elements, and a single function of a single element may be performed by two or more elements. Two or more functions performed by two or more elements may be performed by a single element, and a single function performed by two or more elements may be performed by a single element. Part of the configuration in the present embodiments may be omitted. At least a part of the configuration in one of the present embodiments may be added to or replace another configuration in the present embodiments.

What is claimed is:

1. An electric work machine, comprising:
a housing;
a brushless motor (i) housed in the housing and (ii) including a stator and a rotor; and
a transmission configured to transmit rotation of the brushless motor to a tool accessory;
the stator including coils,
the rotor including:
a rotor core (i) configured to rotate about a rotational axis, (ii) having a first end face and a second end face that intersect an axial direction along the rotational axis, and (iii) including through-spaces passing through the rotor core in the axial direction,
permanent magnets each (i) having magnetic poles of a north pole and a south pole and (ii) being arranged in the rotor core such that the north pole and the south pole are aligned along a circumferential direction of the rotor core, the permanent magnets being (i) spaced apart from each other in the circumferential direction and (ii) arranged such that like poles thereof face each other along the circumferential direction, and
a resin fixing portion containing resin, the resin fixing portion being in contact with the rotor core and the permanent magnets, thereby to integrally fix the permanent magnets to the rotor core via the resin fixing portion, the resin fixing portion including (i) a first-end-face fixing part or a second-end-face fixing part and (ii) at least one through-fixing part,
the first-end-face fixing part being arranged on the first end face of the rotor core and covering at least a portion of the first end face and at least a first portion of each of the permanent magnets,
the second-end-face fixing part being arranged on the second end face of the rotor core and covering at least a portion of the second end face and at least a second portion of each of the permanent magnets, and
the at least one through-fixing part that fills at least one of the through-spaces and that is continuous with the first-end-face fixing part and/or with the second-end-face fixing part, and
the brushless motor being configured to satisfy Equation (1) below,
$$\frac{R}{{( \frac{Vin}{Ne} )}^{2}} < 433000000 \cdot {Vol}^{- 1.621} \qquad ( 1 )$$
where R is a line-to-line resistance value (mΩ) of the brushless motor based on the coils,
Vin is a rated-voltage value (V) of the brushless motor,
Ne is a rotational speed (krpm) of the brushless motor at a time in which a specific effective back-EMF value, corresponding to a magnitude of a back-EMF generated in the coils, is equal to the rated-voltage value, and
Vol is a volume (mm³) of the stator.

2. The electric work machine according to claim 1, wherein
the resin fixing portion includes the first-end-face fixing part and the second-end-face fixing part, and
the at least one through-fixing part is continuous with the first-end-face fixing part and the second-end-face fixing part.

3. The electric work machine according to claim 1, wherein
the rotor core includes magnet insertion holes (i) that are spaced apart from each other along the circumferential direction, (ii) into each of which a corresponding one of the permanent magnets is inserted, and (iii) each of which includes an intermediate through-space, which is one of the through-spaces, and
the at least one through-fixing part includes intermediate-fixing parts that each fill the corresponding intermediate through-space.

4. The electric work machine according to claim 3, wherein
the rotor core includes:
openings (i) that are spaced apart from each other along the circumferential direction on an outer circumference of the rotor core, (ii) each of which is continuous with a corresponding one of the magnet insertion holes, thereby to cause the magnet insertion holes to be exposed through the rotor core outwardly in a radial direction of the rotor core, and (iii) each of which is one of the through-spaces, and
restrictors each of which (i) forms a corresponding one of the openings, (ii) faces a corresponding one of the permanent magnets along the radial direction, and (iii) is configured to restrict the corresponding one of the permanent magnets from moving in the radial direction, and
the at least one through-fixing part includes outer-circumference fixing parts that each cover a corresponding one of the openings.

5. The electric work machine according to claim 1, wherein
the first-end-face fixing part includes at least one through hole that passes through the first-end-face fixing part in the axial direction, thereby to cause a portion of each permanent magnet and/or a portion of the rotor core to be exposed to an outside of the rotor.

6. The electric work machine according to claim 1, wherein
at least a portion of a first face of each of the permanent magnets and at least a portion of the first end face of the rotor core are coplanar, the first face intersecting the axial direction and facing a same direction as the first end face.

7. The electric work machine according to claim 1, wherein
the second-end-face fixing part covers and is in contact with the at least a portion of the second end face of the rotor core and at least a portion of a second face of each of the permanent magnets, the second face intersecting the axial direction and facing a same direction as the second end face.

8. The electric work machine according to claim 7, wherein
the second face of each of the permanent magnets is located inside or outside of the rotor core relative to the second end face of the rotor core.

9. The electric work machine according to claim 1, wherein
the rotor core includes a core center hole passing through the rotor core in the axial direction, the rotational axis passing through the core center hole,
the electric work machine further includes a rotor shaft passing through the core center hole and that is configured to rotate together with the rotor core, and
the resin fixing portion is in contact with the rotor core, the permanent magnets, and the rotor shaft, thereby to integrally fix the permanent magnets and the rotor shaft to the rotor core via the resin fixing portion.

10. The electric work machine according to claim 9, wherein
the through-spaces include a center through-space, in which the rotor shaft is not present in the core center hole, and
the at least one through-fixing part includes a center-fixing part that fills the center through-space.

11. The electric work machine according to claim 10, wherein
the core center hole has an inner surface,
the inner surface includes a recess corresponding to the center through-space and extending in the axial direction,
at least a portion of the center-fixing part fills the recess.

12. The electric work machine according to claim 9, wherein
a surface of the rotor shaft has a core-facing surface that faces the inner surface of the core center hole and that has a textured surface.

13. The electric work machine according to claim 12, wherein
the textured surface includes a knurled shape.

14. The electric work machine according to claim 1, wherein
the permanent magnets each have a radial length along the radial direction of the rotor core and a circumferential length along the circumferential direction, the radial length being longer than the circumferential length.

15. The electric work machine according to claim 1, wherein
the permanent magnets each include at least a first part and a second part divided along the rotational axis.

16. The electric work machine according to claim 1, wherein
the permanent magnets each include a first magnet segment and a second magnet segment, and
in each of the permanent magnets, the first magnet segment and the second magnet segment are (i) spaced apart from each other along the circumferential direction and (ii) arranged such that opposite poles face each other along the circumferential direction.

17. The electric work machine according to claim 1, wherein
the resin fixing portion contains a thermosetting resin.

18. The electric work machine according to claim 1, further comprising:
a grip configured to be gripped by a user of the electric work machine, and/or
a battery receptacle configured to allow a battery pack including a battery (3A) to be mounted thereon in a detachable manner.
